(19) United States
(12) Patent Application Publication
(10) Pub. No.: US 2023/0281606 A1
(43) Pub. Date: Sep. 7, 2023

(54) Partitioned Address Spaces in Blockchain Wallets

(71) Applicant: Artema Labs, Inc, Los Angeles, CA (US)

(72) Inventors: Bjorn Markus Jakobsson, Portola Valley, CA (US); Keir Finlow-Bates, Eura (FI); Stephen C. Gerber, Austin, TX (US)

(73) Assignee: Artema Labs, Inc, Los Angeles, CA (US)

(21) Appl. No.: 18/176,920

(22) Filed: Mar. 1, 2023

Related U.S. Application Data
(60) Provisional application No. 63/315,143, filed on Mar. 1, 2022.
(60) Provisional application No. 63/318,146, filed on Mar. 9, 2022.
(60) Provisional application No. 63/322,051, filed on Mar. 21, 2022.
(60) Provisional application No. 63/370,365, filed on Aug. 3, 2022.
(60) Provisional application No. 63/371,034, filed on Aug. 10, 2022.
(60) Provisional application No. 63/382,241, filed on Nov. 3, 2022.
(60) Provisional application No. 63/384,737, filed on Nov. 22, 2022.

(51) Int. Cl. G06Q 20/36; G06Q 20/38

(52) U.S. Cl. CPC G06Q 20/3674; G06Q 20/3829; G06Q 2220/00

(57) ABSTRACT

In various embodiments, systems and methods can provide improved security for blockchain wallets by partitioning addresses within the wallet according to roles that those addresses may perform. Addresses can be, in several embodiments, associated with the partitions. Addresses can be associated with partitions according to how the addresses are derived. Addresses can be derived from a master ley and/or an index variable. The index variable can vary according to partition. The master key can be common across the partitions. The partitions can have different access and/or use rights with respect to the digital assets stored in their respective addresses.

### CROSS-REFERENCE TO RELATED APPLICATIONS

The current application claims the benefit of and priority under 35 U.S.C. § 119(e) to U.S. Provisional Patent Application No. 63/315,143 filed Mar. 1, 2022 titled “Wallet with Modular Rights Management,” U.S. Provisional Patent Application No. 63/318,146 filed Mar. 9, 2022 titled “Method and Apparatus for Gamification of Movie Content,” U.S. Provisional Patent Application No. 63/322,051 filed Mar. 21, 2022 titled “Vulnerable Wallet Resource Control,” U.S. Provisional Patent Application No. 63/370,365 filed Aug. 3, 2022 titled “Partitioned Address Spaces in a Single Blockchain Wallet,” U.S. Provisional Patent Application No. 63/371,034 filed Aug. 10, 2022 titled “Distinguishing Between Different Types of Digital Signature Requests,” U.S. Provisional Patent Application No. 63/382,241 filed Nov. 3, 2022 titled “Blockchain Wallet for Adding Wallet Identifying Data to Transactions,” and U.S. Provisional Patent Application No. 63/384,737 filed Nov. 22, 2022 titled “Automated Wallet and Transaction Control,” the disclosures of which are incorporated herein by reference in their entireties.

### FIELD OF THE INVENTION

The present invention generally relates to wallets for blockchain application. The invention further relates to permissions management and wallet security improvements.

### BACKGROUND

Cryptocurrency users and non-fungible token collectors can use a hot wallet that contains a small number of digital assets with a small value, and a cold wallet for storing larger amounts of value. This approach can reduce the risk of a theft draining most or all of their assets. A hot wallet is at a greater risk from hackers and malicious entities because the hot wallet connects more frequently with the Internet and applications and servers thereon. In contrast, a cold wallet should ideally only be connected once, when the assets it holds are transferred out, and then not be used again.

However, cold wallets can suffer from usability problems. For instance, the effort required to move assets to and from cold wallets can involve extra steps and security checks as compared to a hot wallet. A side-effect of this is that cold wallets can sometimes inadvertently morph into hot wallets, and thereby no longer provide the security benefits of a cold wallet. This problem can be exacerbated by transaction details that are virtually unreadable by many users. This can provide an opportunity for bad actors to implement malicious transactions. Users approving such transactions on a cold wallet can be exposing their entire vault to theft.

### SUMMARY OF THE INVENTION

In various embodiments a process can handle transaction permissions in a partitioned wallet. In an embodiment, the process can include receiving a transaction. The transaction including a sending address and a receiving address. Wherein the sending address is associated with a partitioned wallet. The partitioned wallet including a first wallet partition including a first address. The first address derived based on a master key and a first index variable. The partitioned wallet further including a second wallet partition including a second address, the second address derived based on the master key and a second index variable. The process further configured to conditionally restrict the transaction based on the sending address and the receiving address; obtain a ledger entry including the transaction when the transaction is approved; and broadcast a ledger entry including the transaction when the transaction is approved. Wherein the ledger entry is configured to be securely added to a distributed ledger.

In another embodiment, the transaction includes blocking the transaction when the sending address is the second address.

In a further embodiment, the transaction includes blocking the transaction when the sending address is the second address and the receiving address is external to the partitioned wallet.

In still another embodiment, the transaction includes requiring authentication by the first address when the sending address is the second address and the receiving address is external to the partitioned wallet.

In another further embodiment, the transaction includes delaying the transaction by a predetermined amount of time.

In a still further embodiment, the transaction includes blocking the transaction when the sending address has been previously used in a predetermined number of transactions.

In another embodiment again, the transaction includes blocking the transaction when the sending address has been previously used in a predetermined number of transactions during a predefined time period.

In a still yet further embodiment, the transaction when the sending address corresponds to a third wallet partition, such that the transaction is approved when the receiving address corresponds to at least one of the first wallet partition and the second wallet partition, and wherein for each address corresponding to the third wallet partition, the corresponding address is derived based on the master key and on an index variable corresponding to the third wallet partition.

In many embodiments, a user interface for handling transactions including digital assets in a partitioned wallet. In an embodiment, the user interface includes displaying a first wallet partition including a first address and displaying a second wallet partition including a second address; displaying a first set of transaction options when a user selects the first address for inclusion in a transaction as a sending address; and displaying a second set of transaction options when the user selects the second address for inclusion in the transaction as the sending address. Wherein the first address can be identified as belonging to the first wallet partition based on a first index variable. The first index variable and a master key used in deriving the first address and the first index variable corresponding to the first wallet partition. Also, wherein the second address can be identified as belonging to the second wallet partition based on a second index variable. The second index variable and a master key used in deriving the second address and the second index variable corresponding to the second wallet partition.

In another embodiment, the user interface further includes displaying a third set of transaction options when the user selects a third address for inclusion in the transaction as a sending address.

In still another embodiment, the user interface further includes displaying a third wallet partition including a third address.

In a further embodiment, the first set of transaction options allow a recipient address to be an external address.

In a still further embodiment, the second set of transaction options limit a recipient address to being an external address selected from a predefined list of external addresses.

In another embodiment again, the second set of transaction options limit a recipient address to being an address corresponding to the first wallet partition.

In another further embodiment, the first set of transaction options are identified for display based on determining that the first address was derived based on the master key and the first index variable.

In still another further embodiment, the first set of transaction options allows external and internal recipient wallets addresses.

In still another embodiment again, the second set of transaction options can render the second address unavailable when the second address has previously been used as a sending address.

In a number of embodiments, a process can handle transaction permissions in a partitioned wallet. In an embodiment, the process including receiving a transaction. The transaction including a sending address and a receiving address. Wherein the sending address corresponds to a first wallet partition of a wallet. Also, wherein the receiving address does not correspond with the wallet. The process further including receiving an indication of transaction approval from a user. The user associated with a second address corresponding to a second wallet partition of the wallet. The process further including approving the transaction based on the indication of transaction approval; obtaining a ledger entry including the transaction when the transaction is approved; and broadcasting a ledger entry including the transaction when the transaction is approved. Wherein the ledger entry is configured to be securely added to a distributed ledger. Also, wherein the sending address is derived based on a master key and a first index variable. The first index variable corresponding to the first wallet partition. The second address is derived based on the master key and a second index variable. The second index variable corresponding to the second wallet partition.

In another embodiment, the user enters a private key corresponding to the second address.

In a further embodiment, the receiving address is included on a predefined list.

In some embodiments, a process handles transaction permissions in a partitioned wallet. In an embodiment, the process including receiving a transaction. the transaction including a sending address and a receiving address. The process further including approving the transaction when the sending address corresponds to a first wallet partition of a wallet; restricting the transaction when the sending address corresponds to a second wallet partition, such that the transaction is approved when the receiving address is part of a set of approved receiving addresses; obtaining a ledger entry including the transaction when the transaction is approved; and broadcasting a ledger entry including the transaction when the transaction is approved. Wherein the ledger entry is configured to be securely added to a distributed ledger. Also, wherein for each address corresponding to any of the first, and second wallet partitions, the address is generated based on a master key and a selected index variable. The index variable selected in correspondence to the first, and second wallet partitions.

In another embodiment, the set of approved receiving addresses is empty.

In a further embodiment, the set of approved receiving addresses is predefined.

In still another embodiment, the process further including restricting use of a sending address after the sending address has been included in a predetermined number of transactions.

In still a further embodiment, the process further including temporarily restricting use of a sending address after the sending address has been included a predetermined number of transactions.

In another further embodiment, the process further including approving the transaction when the sending address corresponds to the second wallet partition, the receiving address is not included in the set of approved receiving addresses, and an indication of approval has been received from a user possessing access to the first wallet partition.

In another still further embodiment, the process further including restricting the transaction when the sending address corresponds to a third wallet partition, such that the transaction is approved when the receiving address corresponds to at least one of the first wallet partition and the second wallet partition.

In another embodiment again, the process further including restricting the transaction when the sending address corresponds to a third wallet partition, such that the transaction is approved when the receiving address corresponds to at least one of the first wallet partition and the second wallet partition, and wherein for each address corresponding to the third wallet partition, the corresponding address is derived based on the master key and on an index variable corresponding to the third wallet partition.

### BRIEF DESCRIPTION OF THE DRAWINGS

The description and claims will be more fully understood with reference to the following figures and data graphs, which are presented as exemplary embodiments of the invention and should not be construed as a complete recitation of the scope of the invention.

FIG. 1 is a conceptual diagram of an NFT platform in accordance with an embodiment of the invention.

FIG. 2 is a network architecture diagram of an NFT platform in accordance with an embodiment of the invention.

FIG. 3 is a conceptual diagram of a permissioned blockchain in accordance with an embodiment of the invention.

FIG. 4 is a conceptual diagram of a permissionless blockchain in accordance with an embodiment of the invention.

FIGS. 5A-5B are diagrams of a dual blockchain in accordance with a number of embodiments of the invention.

FIG. 6 conceptually illustrates a process followed by a Proof of Work consensus mechanism in accordance with an embodiment of the invention.

FIG. 7 conceptually illustrates a process followed by a Proof of Space consensus mechanism in accordance with an embodiment of the invention.

FIG. 8 illustrates a dual proof consensus mechanism configuration in accordance with an embodiment of the invention.

FIG. 9 illustrates a process followed by a Trusted Execution Environment-based consensus mechanism in accordance with some embodiments of the invention.

FIGS. 10-12 depicts various devices that can be utilized alongside an NFT platform in accordance with various embodiments of the invention.

FIG. 13 depicts a media wallet application configuration in accordance with an embodiment of the invention.

FIGS. 14A-14C depicts user interfaces of various media wallet applications in accordance with a number of embodiments of the invention.

FIG. 15 illustrates an NFT ledger entry corresponding to an NFT identifier.

FIGS. 16A-16B illustrate an NFT arrangement relationship with corresponding physical content in accordance with an embodiment of the invention.

FIG. 17 illustrates a process for establishing a relationship between an NFT and corresponding physical content.

FIG. 18 conceptually illustrates an example partitioned wallet.

FIG. 19 conceptually illustrates an example partitioned wallet with a parent partition and a child partition.

FIG. 20 conceptually illustrates an example partitioned wallet with associated interfaces.

FIG. 21 conceptually illustrates an example of two linked wallets.

FIG. 22 conceptually illustrates an example process that can be performed by a partitioned wallet.

FIG. 23 conceptually illustrates a block diagram of an example computer system.

FIG. 24 conceptually illustrates a wallet with a DRM module.

FIG. 25 conceptually illustrates an example NFT.

FIG. 26 conceptually illustrates viewers at different times and locations receiving different streams of the same film.

FIG. 27 conceptually illustrates a collection of clues including a solution.

FIG. 28 conceptually illustrates an example NFT peeling into a collectible.

FIG. 29 conceptually illustrates an example user's wallet containing NFTs and the potential addition of a new NFT.

FIG. 30 conceptually illustrates an example mobile wallet.

FIG. 31 conceptually illustrates an example typical usage scenario.

FIG. 32 conceptually illustrates an example illustrative implementation.

FIG. 33 conceptually illustrates an example implementation.

FIG. 34 conceptually illustrates an example situation involving two types of approval.

FIG. 35 conceptually illustrates an example flowchart of an exemplifying embodiment of a method performed by an entity, such as a wallet or associated with a wallet, for enabling a user, such as an owner of the wallet, to sign a request.

FIG. 36 conceptually illustrates an example block diagram of an exemplifying embodiment of an entity, such as a wallet or associated with a wallet, configured for enabling a user, such as an owner of the wallet, to sign a request.

FIG. 37 conceptually illustrates an example block diagram of a possible embodiment of a data structure representing details concerning a blockchain wallet.

FIG. 38 conceptually illustrates an example flow chart illustrating a method embodying a use of a version string lookup table and associated wallet capabilities for accepting or rejecting a transaction by a watchful bridge.

FIG. 39 conceptually illustrates an example method for ensuring a user has agreed to an end user license agreement (EULA) pertaining to a blockchain transaction.

FIGS. 40a and 40b conceptually illustrate an example flowchart illustrating an exemplifying embodiment of a method performed by a smart contract for accepting or rejecting a transaction.

FIG. 41 conceptually illustrates an example block diagram of an exemplifying embodiment of a smart contract and/or a wallet configured for accepting or rejecting a transaction.

FIG. 42 conceptually illustrates an example flowchart illustrating an exemplifying embodiment of a method performed by a wallet for accepting or rejecting a transaction.

FIG. 43 conceptually illustrates an example flowchart illustrating an exemplifying embodiment of a method performed by a first wallet or an entity associated with the first wallet for handling transactions of digital assets of the first wallet.

FIG. 44 conceptually illustrates an example block diagram of an exemplifying embodiment of a first wallet or an entity associated with the first wallet configured for handling transactions of digital assets of the first wallet.

FIG. 45 conceptually illustrates an example of a transaction in which transfer rights of a digital asset is moved from a first wallet to a second wallet.

FIG. 46 conceptually illustrates an event-driven release of private keys.

FIG. 47 is a block diagram illustrating components and processes for enabling a function within a smart contract after a predetermined time on presentation of a signed voucher.

FIG. 48 is a block diagram illustrating components and processes for enabling a function within a smart contract after a predetermined time on presentation of a preimage to a previously released hash output.

### DETAILED DESCRIPTION

In various embodiments, systems and methods can provide improved security for blockchain wallets by partitioning addresses within the wallet according to roles that those addresses may perform. The wallet can be divided into two or more partitions. Addresses can be, in several embodiments, associated with the partitions. Addresses can be associated with partitions according to how the addresses are derived. Addresses can be derived from a master ley and/or an index variable. The index variable can vary according to partition. The master key can be common across the partitions. The partitions can have different access and/or use rights with respect to the digital assets stored in their respective addresses. For example, a first partition (e.g., a “hot” partition) can permit unrestricted transactions. A second partition (e.g., a “warm” partition) can be limited to transacting with a list of possible recipients. A third partition (e.g., a “cold” partition) can be limited to transacting only with addresses in the same wallet (e.g., in another partition). Partitioned wallets can be used in conjunction with various hardware and/or user combinations. In some embodiments, a first partition of a wallet can correspond to a first user, and a second partition can correspond to a second user. In several embodiments, a first user can have the ability to approve of transactions made by a second user.

In accordance with many embodiments of the invention, a wallet can include multiple blockchain addresses that are labeled with different roles in the wallet. Roles can include “hot”, “warm” and/or “cold” addresses. A wallet can enforce which actions may and may not be performed using addresses within the wallet, based on the addresses' role label. In several embodiments, an address labeled as “hot” can be usable for any blockchain transaction; an address labeled as “warm” may only be usable for receiving and sending assets to addresses known to be within the wallet; and/or an address labeled “cold” may act as a “warm” address with a further limitation that assets held by the address may only be sent to other “cold” addresses or “warm” addresses. In several embodiments, a “cold” address can be restricted to only being allowed to conduct a single transaction. The single transaction can be the transmission of all assets controlled by the “cold” address to other “warm” and/or “cold” addresses. After the single transaction, the “cold” address can be labeled as “frozen” and can be prevented from being further used.

### Non-Fungible Token (NFT) Platforms

Turning now to the drawings, systems and methods for implementing blockchain-based Non-Fungible Token (NFT) platforms in accordance with various embodiments of the invention are illustrated. In several embodiments, blockchain-based NFT platforms are platforms which enable content creators to issue, mint, and transfer Non-Fungible Tokens (NFTs) directed to content including, but not limited to, rich media content.

In a number of embodiments, content creators can issue NFTs to users within the NFT platform. NFTs can be created around a large range of real-world media content and intellectual property. Movie studios can mint digital collectibles for their movies, characters, notable scenes and/or notable objects. Record labels can mint digital collectibles for artists, bands, albums and/or songs. Similarly, official digital trading cards can be made from likeness of celebrities, cartoon characters and/or gaming avatars.

NFTs minted using NFT platforms in accordance with various embodiments of the invention can have multifunctional programmable use cases including rewards, private access to premium content and experiences, as discounts toward the purchase of goods, among many other value-added use cases.

In many embodiments, each NFT can have a set of attributes that define its unique properties. NFTs may therefore be classified based on which attributes are emphasized. Possible classifications may address, but are not limited to: NFTs as identifying entities, NFTs output by other NFTs, NFTs as content creation assets, and NFTs as evaluating entities. NFTs can be interpreted differently by various platforms in order to create platform-specific user experiences. The metadata associated with an NFT may also include digital media assets such as (but not limited to) images, videos about the specific NFT, and the context in which it was created (studio, film, band, company song etc.).

In many embodiments, NFT storage may be facilitated through mechanisms for the transfer of payment from users to one or more service providers. Through these mechanisms, a payment system for NFT maintenance can allow for incremental payment and ongoing asset protection. NFT storage may be additionally self-regulated through willing participants disclosing unsatisfactory NFT management in exchange for rewards.

In many embodiments, the NFT platform can include media wallet applications that enable users to securely store NFTs and/or other tokens on their devices. Furthermore, media wallets (also referred to as “digital wallets”) can enable users to obtain NFTs that prove purchase of rights to access a particular piece of media content on one platform and use the NFT to gain access to the purchased content on another platform. The consumption of such content may be governed by content classification directed to visual user interface systems.

In several embodiments, users can download and install media wallet applications to store NFTs on the same computing devices used to consume streamed and/or downloaded content. Media wallet applications and NFTs can disseminate data concerning media consumption on the computing devices on which the media wallet applications are installed and/or based upon observations indicative of media consumption independently of the device. Media consumption data may include, but is not limited to, data reporting the occurrence of NFT transactions, data reporting the occurrence of NFT event interactions data reporting the content of NFT transactions, data reporting the content of media wallet interactions, and/or data reporting the occurrence of media wallet interactions.

While various aspects of NFT platforms, NFTs, media wallets, blockchain configurations, reporting structures, and maintenance systems are discussed above, NFT platforms and different components that can be utilized within NFT platforms in accordance with various embodiments of the invention are discussed further below.

### NFT Platforms

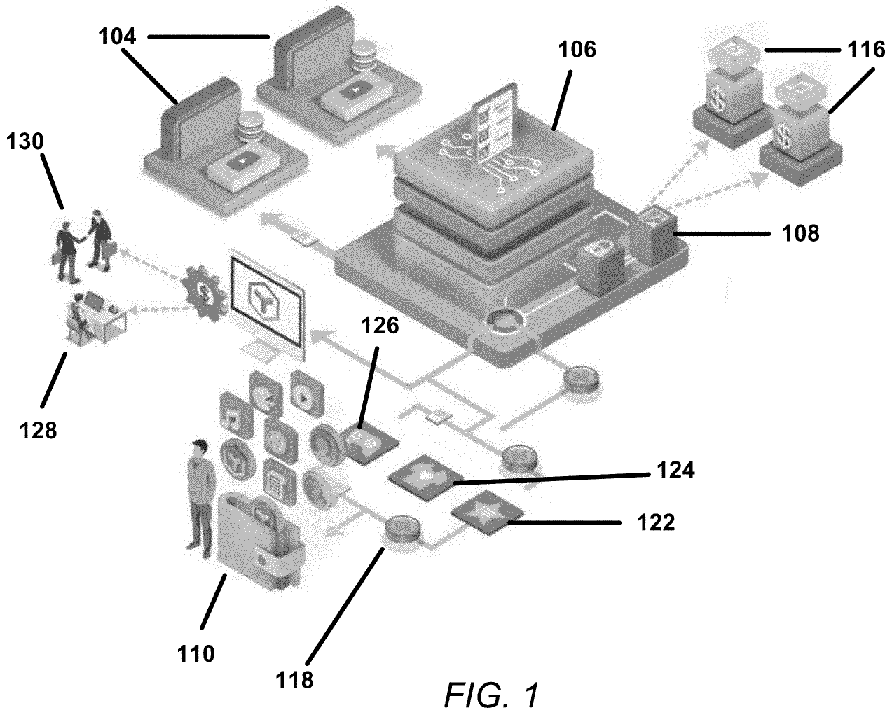

An NFT platform in accordance with an embodiment of the invention is illustrated in FIG. 1. The NFT platform 100 utilizes one or more immutable ledgers (e.g. one or more blockchains) to enable a number of verified content creators 104 to access an NFT registry service to mint NFTs 106 in a variety of forms including (but not limited to) celebrity NFTs 122, character NFTs from games 126, NFTs that are redeemable within games 126, NFTs that contain and/or enable access to collectibles 124, and NFTs that have evolutionary capabilities representative of the change from one NFT state to another NFT state.

Issuance of NFTs 106 via the NFT platform 100 enables verification of the authenticity of NFTs independently of the content creator 104 by confirming that transactions written to one or more of the immutable ledgers are consistent with the smart contracts 108 underlying the NFTs.

As is discussed further below, content creators 104 can provide the NFTs 106 to users to reward and/or incentivize engagement with particular pieces of content and/or other user behavior including (but not limited to) the sharing of user personal information (e.g. contact information or user ID information on particular services), demographic information, and/or media consumption data with the content creator and/or other entities. In addition, the smart contracts 108 underlying the NFTs can cause payments of residual royalties 116 when users engage in specific transactions involving NFTs (e.g. transfer of ownership of the NFT).

In a number of embodiments, users utilize media wallet applications 110 on their devices to store NFTs 106 distributed using the NFT platform 100. Users can use media wallet applications 110 to obtain and/or transfer NFTs 106. In facilitating the retention or transfer of NFTs 106, media wallet applications may utilize wallet user interfaces that engage in transactional restrictions through either uniform or personalized settings. Media wallet applications 110 in accordance with some embodiments may incorporate NFT filtering systems to avoid unrequested NFT assignment. Methods for increased wallet privacy may also operate through multiple associated wallets with varying capabilities. As can readily be appreciated, NFTs 106 that are implemented using smart contracts 108 having interfaces that comply with open standards are not limited to being stored within media wallets and can be stored in any of a variety of wallet applications as appropriate to the requirements of a given application. Furthermore, a number of embodiments of the invention support movement of NFTs 106 between different immutable ledgers. Processes for moving NFTs between multiple immutable ledgers in accordance with various embodiments of the invention are discussed further below.

In several embodiments, content creators 104 can incentivize users to grant access to media consumption data using offers including (but not limited to) offers of fungible tokens 118 and/or NFTs 106. In this way, the ability of the content creators to mint NFTs enables consumers to engage directly with the content creators and can be utilized to incentivize users to share with content creators' data concerning user interactions with additional content. The permissions granted by individual users may enable the content creators 104 to directly access data written to an immutable ledger. In many embodiments, the permissions granted by individual users enable authorized computing systems to access data within an immutable ledger and content creators 104 can query the authorized computing systems to obtain aggregated information. Numerous other example functions for content creators 104 are possible, some of which are discussed below.

NFT blockchains in accordance with various embodiments of the invention enable issuance of NFTs by verified users. In many embodiments, the verified users can be content creators that are vetted by an administrator of networks that may be responsible for deploying and maintaining the NFT blockchain. Once the NFTs are minted, users can obtain and conduct transactions with the NFTs. In several embodiments, the NFTs may be redeemable for items or services in the real world such as (but not limited to) admission to movie screenings, concerts, and/or merchandise.

As illustrated in FIG. 1, users can install the media wallet application 110 onto their devices and use the media wallet application 110 to purchase fungible tokens. The media wallet application could also be provided by a browser, or by a dedicated hardware unit executing instructions provided by a wallet manufacturer. The different types of wallets may have slightly different security profiles and may offer different features, but would all be able to be used to initiate the change of ownership of tokens, such as NFTs. In many embodiments, the fungible tokens can be fully converted into fiat currency and/or other cryptocurrency. In several embodiments, the fungible tokens are implemented using split blockchain models in which the fungible tokens can be issued to multiple blockchains (e.g. Ethereum). As can readily be appreciated, the fungible tokens and/or NFTs utilized within an NFT platform in accordance with various embodiments of the invention are largely dependent upon the requirements of a given application.

In several embodiments, the media wallet application is capable of accessing multiple blockchains by deriving accounts from each of the various immutable ledgers used within an NFT platform. For each of these blockchains, the media wallet application can automatically provide simplified views whereby fungible tokens and NFTs across multiple accounts and/or multiple blockchains can be rendered as single user profiles and/or wallets. In many embodiments, the single view can be achieved using deep-indexing of the relevant blockchains and API services that can rapidly provide information to media wallet applications in response to user interactions. In certain embodiments, the accounts across the multiple blockchains can be derived using BIP32 deterministic wallet key. In other embodiments, any of a variety of techniques can be utilized by the media wallet application to access one or more immutable ledgers as appropriate to the requirements of a given application.

NFTs can be purchased by way of exchanges 130 and/or from other users 128. In addition, content creators can directly issue NFTs to the media wallets of specific users (e.g. by way of push download or AirDrop). In many embodiments, the NFTs are digital collectibles such as celebrity NFTs 122, character NFTs from games 126, NFTs that are redeemable within games 126, and/or NFTs that contain and/or enable access to collectibles 124. It should be appreciated that a variety of NFTs are described throughout the discussion of the various embodiments described herein and can be utilized in any NFT platform and/or with any media wallet application.

While the NFTs are shown as static in the illustrated embodiment, content creators can utilize users' ownership of NFTs to engage in additional interactions with the user. In this way, the relationship between users and particular pieces of content and/or particular content creators can evolve over time around interactions driven by NFTs. In a number of embodiments, collection of NFTs can be gamified to enable unlocking of additional NFTs. In addition, leaderboards can be established with respect to particular content and/or franchises based upon users' aggregation of NFTs. As is discussed further below, NFTs and/or fungible tokens can also be utilized by content creators to incentivize users to share data.

NFTs minted in accordance with several embodiments of the invention may incorporate a series of instances of digital content elements in order to represent the evolution of the digital content over time. Each one of these digital elements can have multiple numbered copies, just like a lithograph, and each such version can have a serial number associated with it, and/or digital signatures authenticating its validity. The digital signature can associate the corresponding image to an identity, such as the identity of the artist. The evolution of digital content may correspond to the transition from one representation to another representation. This evolution may be triggered by the artist, by an event associated with the owner of the artwork, by an external event measured by platforms associated with the content, and/or by specific combinations or sequences of event triggers. Some such NFTs may also have corresponding series of physical embodiments. These may be physical and numbered images that are identical to the digital instances described above. They may also be physical representations of another type, e.g., clay figures or statues, whereas the digital representations may be drawings. The physical embodiments may further be of different aspects that relate to the digital series. Evolution in compliance with some embodiments may also be used to spawn additional content, for example, one NFT directly creating one or more secondary NFTs.

When the user wishes to purchase an NFT using fungible tokens, media wallet applications can request authentication of the NFT directly based upon the public key of the content creator and/or indirectly based upon transaction records within the NFT blockchain. As discussed above, minted NFTs can be signed by content creators and administrators of the NFT blockchain. In addition, users can verify the authenticity of particular NFTs without the assistance of entities that minted the NFT by verifying that the transaction records involving the NFT within the NFT blockchain are consistent with the various royalty payment transactions required to occur in conjunction with transfer of ownership of the NFT by the smart contract underlying the NFT.

Applications and methods in accordance with various embodiments of the invention are not limited to media wallet applications or use within NFT platforms. Accordingly, it should be appreciated that the data collection capabilities of any media wallet application described herein can also be implemented outside the context of an NFT platform and/or in a dedicated application and/or in an application unrelated to the storage of fungible tokens and/or NFTs. Various systems and methods for implementing NFT platforms and media wallet applications in accordance with various embodiments of the invention are discussed further below.

### NFT Platform Network Architectures

NFT platforms in accordance with many embodiments of the invention utilize public blockchains and permissioned blockchains. In several embodiments, the public blockchain is decentralized and universally accessible. Additionally, in a number of embodiments, private/permissioned blockchains are closed systems that are limited to publicly inaccessible transactions. In many embodiments, the permissioned blockchain can be in the form of distributed ledgers, while the blockchain may alternatively be centralized in a single entity.

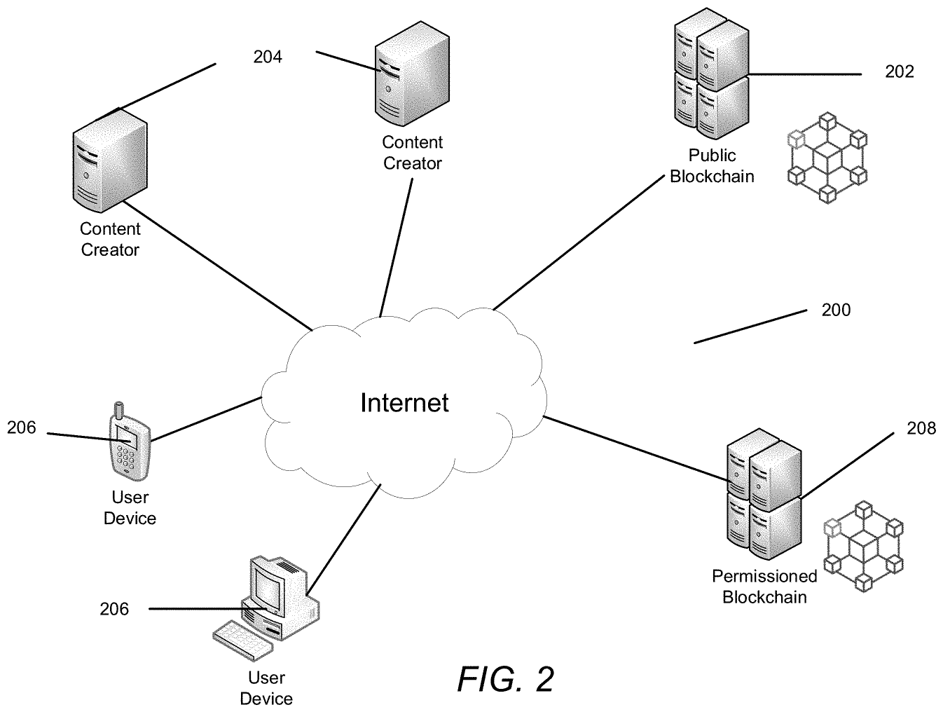

An example of network architecture that can be utilized to implement an NFT platform including a public blockchain and a permissioned blockchain in accordance with several embodiments of the invention is illustrated in FIG. 2. The NFT platform 200 utilizes computer systems implementing a public blockchain 202 such as (but not limited to) Ethereum and Solana. A benefit of supporting interactions with public blockchains 202 is that the NFT platform 200 can support minting of standards based NFTs that can be utilized in an interchangeable manner with NFTs minted by sources outside of the NFT platform on the public blockchain. In this way, the NFT platform 200 and the NFTs minted within the NFT platform are not part of a walled garden, but are instead part of a broader blockchain-based ecosystem. The ability of holders of NFTs minted within the NFT platform 200 to transact via the public blockchain 202 increases the likelihood that individuals acquiring NFTs will become users of the NFT platform. Initial NFTs minted outside the NFT platform can also be developed through later minted NFTs, with the initial NFTs being used to further identify and interact with the user based upon their ownership of both NFTs. Various systems and methods for facilitating the relationships between NFTs, both outside and within the NFT platform are discussed further below.

Users can utilize user devices configured with appropriate applications including (but not limited to) media wallet applications to obtain NFTs. In many embodiments, media wallets are smart device enabled, front-end applications for fans and/or consumers, central to all user activity on an NFT platform. As is discussed in detail below, different embodiments of media wallet applications can provide any of a variety of functionality that can be determined as appropriate to the requirements of a given application. In the illustrated embodiment, the user devices 206 are shown as mobile phones and personal computers. As can readily be appreciated user devices can be implemented using any class of consumer electronics device including (but not limited to) tablet computers, laptop computers, televisions, game consoles, virtual reality headsets, mixed reality headsets, augmented reality headsets, media extenders, and/or set top boxes as appropriate to the requirements of a given application.

In many embodiments, NFT transaction data entries in the permissioned blockchain 208 are encrypted using users' public keys so that the NFT transaction data can be accessed by the media wallet application. In this way, users control access to entries in the permissioned blockchain 208 describing the user's NFT transaction. In several embodiments, users can authorize content creators 204 to access NFT transaction data recorded within the permissioned blockchain 208 using one of a number of appropriate mechanisms including (but not limited to) compound identities where the user is the owner of the data and the user can authorize other entities as guests that can also access the data. As can readily be appreciated, particular content creators' access to the data can be revoked by revoking their status as guests within the compound entity authorized to access the NFT transaction data within the permissioned blockchain 208. In certain embodiments, compound identities are implemented by writing authorized access records to the permissioned blockchain using the user's public key and the public keys of the other members of the compound entity.

When content creators wish to access particular pieces of data stored within the permissioned blockchain 208, they can make a request to a data access service. The data access service may grant access to data stored using the permissioned blockchain 208 when the content creators' public keys correspond to public keys of guests. In a number of embodiments, guests may be defined within a compound identity. The access record for the compound entity may also authorize the compound entity to access the particular piece of data. In this way, the user has complete control over access to their data at any time by admitting or revoking content creators to a compound entity, and/or modifying the access policies defined within the permissioned blockchain 208 for the compound entity. In several embodiments, the permissioned blockchain 208 supports access control lists and users can utilize a media wallet application to modify permissions granted by way of the access control list. In many embodiments, the manner in which access permissions are defined enables different restrictions to be placed on particular pieces of information within a particular NFT transaction data record within the permissioned blockchain 208. As can readily be appreciated, the manner in which NFT platforms and/or immutable ledgers provide fine-grained data access permissions largely depends upon the requirements of a given application.

In many embodiments, storage nodes within the permissioned blockchain 208 do not provide content creators with access to entire NFT transaction histories. Instead, the storage nodes simply provide access to encrypted records. In several embodiments, the hash of the collection of records from the permissioned blockchain is broadcast. Therefore, the record is verifiably immutable and each result includes the hash of the record and the previous/next hashes. As noted above, the use of compound identities and/or access control lists can enable users to grant permission to decrypt certain pieces of information or individual records within the permissioned blockchain. In several embodiments, the access to the data is determined by computer systems that implement permission-based data access services.

In many embodiments, the permissioned blockchain 208 can be implemented using any blockchain technology appropriate to the requirements of a given application. As noted above, the information and processes described herein are not limited to data written to permissioned blockchains 208, and NFT transaction data simply provides an example. Systems and methods in accordance with various embodiments of the invention can be utilized to enable applications to provide fine-grained permission to any of a variety of different types of data stored in an immutable ledger as appropriate to the requirements of a given application in accordance with various embodiments of the invention.

While various implementations of NFT platforms are described above with reference to FIG. 2, NFT platforms can be implemented using any number of immutable and pseudo-immutable ledgers as appropriate to the requirements of specific applications in accordance with various embodiments of the invention. Blockchain databases in accordance with various embodiments of the invention may be managed autonomously using peer-to-peer networks and distributed timestamping servers. In some embodiments, any of a variety of consensus mechanisms may be used by public blockchains, including but not limited to Proof of Space mechanisms, Proof of Work mechanisms, Proof of Stake mechanisms, and hybrid mechanisms.

NFT platforms in accordance with many embodiments of the invention may benefit from the oversight and increased security of private blockchains. As can readily be appreciated, a variety of approaches can be taken to the writing of data to permissioned blockchains and the particular approach is largely determined by the requirements of particular applications. As such, computer systems in accordance with various embodiments of the invention can have the capacity to create verified NFT entries written to permissioned blockchains.

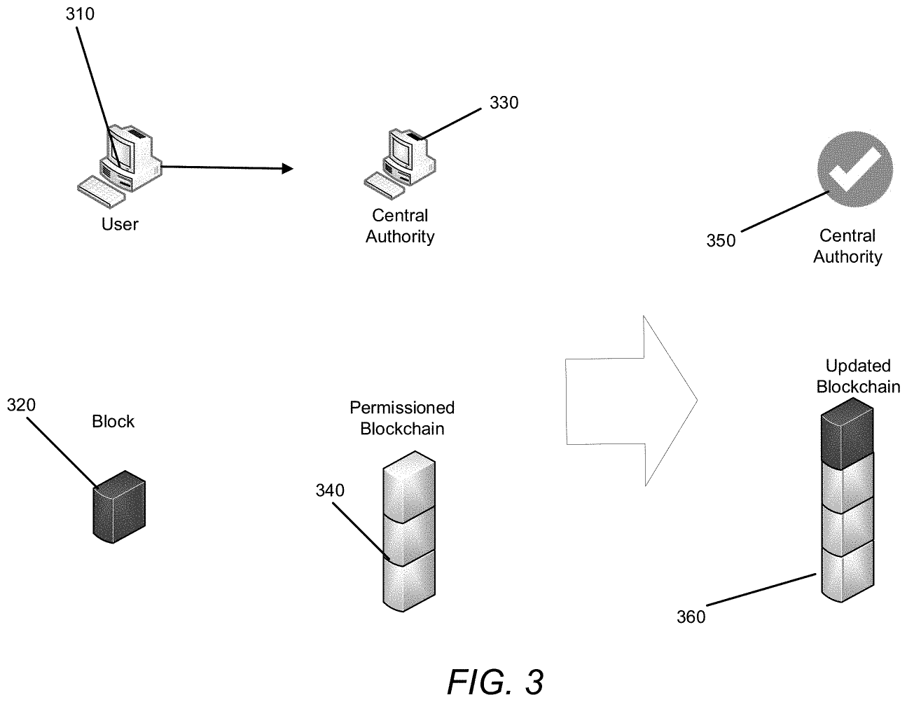

An implementation of permissioned (or private) blockchains in accordance with some embodiments of the invention is illustrated in FIG. 3. Permissioned blockchains 340 can typically function as closed computing systems in which each participant is well defined. In several embodiments, private blockchain networks may require invitations. In a number of embodiments, entries, or blocks 320, to private blockchains can be validated. In some embodiments, the validation may come from central authorities 330. Private blockchains can allow an organization or a consortium of organizations to efficiently exchange information and record transactions. Specifically, in a permissioned blockchain, a preapproved central authority 330 (which should be understood as potentially encompassing multiple distinct authorized authorities) can approve a change to the blockchain. In a number of embodiments, approval may come without the use of a consensus mechanism involving multiple authorities. As such, through a direct request from users 310 to the central authority 330, the determination of whether blocks 320 can be allowed access to the permissioned blockchain 340 can be determined. Blocks 320 needing to be added, eliminated, relocated, and/or prevented from access may be controlled through these means. In doing so the central authority 330 may manage accessing and controlling the network blocks incorporated into the permissioned blockchain 340. Upon the approval 350 of the central authority, the now updated blockchain 360 can reflect the added block 320.

NFT platforms in accordance with many embodiments of the invention may also benefit from the anonymity and accessibility of a public blockchain. Therefore, NFT platforms in accordance with many embodiments of the invention can have the capacity to create verified NFT entries written to a permissioned blockchain.

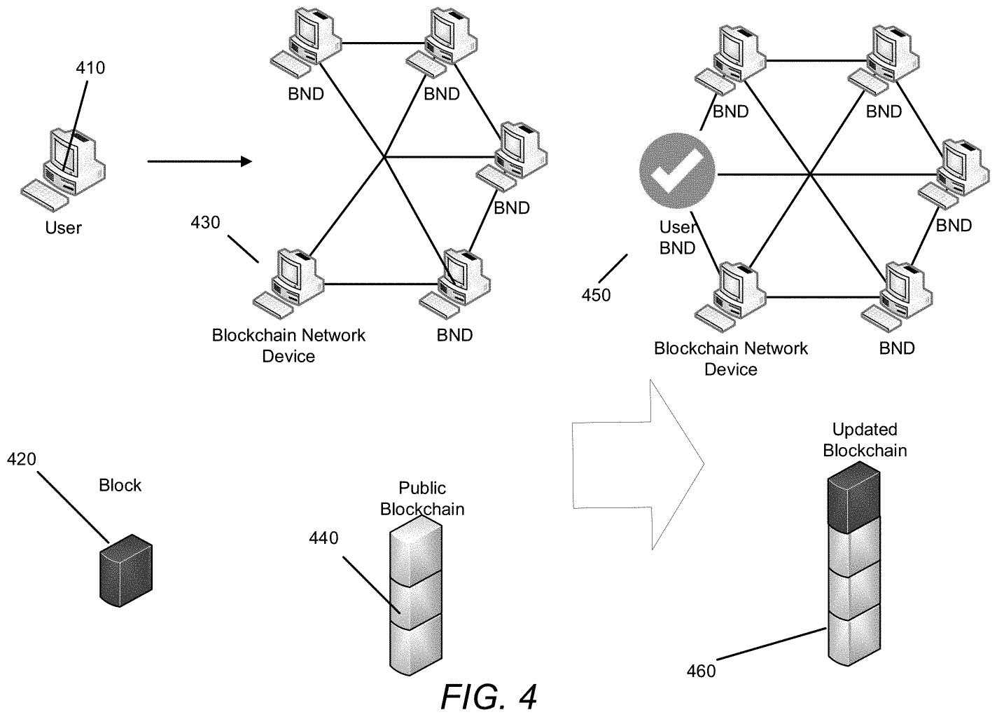

An implementation of a permissionless, decentralized, or public blockchain in accordance with an embodiment of the invention is illustrated in FIG. 4. In a permissionless blockchain, individual users 410 can directly participate in relevant networks and operate as blockchain network devices 430. As blockchain network devices 430, parties would have the capacity to participate in changes to the blockchain and participate in transaction verifications (via the mining mechanism). Transactions are broadcast over the computer network and data quality is maintained by massive database replication and computational trust. Despite being decentralized, an updated blockchain 460 cannot remove entries, even if anonymously made, making it immutable. In many decentralized blockchains, many blockchain network devices 430, in the decentralized system may have copies of the blockchain, allowing the ability to validate transactions. In many instances, the blockchain network device 430 can personally add transactions, in the form of blocks 420 appended to the public blockchain 440. To do so, the blockchain network device 430 would take steps to allow for the transactions to be validated 450 through various consensus mechanisms (Proof of Work, Proof of Stake, etc.). A number of consensus mechanisms in accordance with various embodiments of the invention are discussed further below.

Additionally, in the context of blockchain configurations, the term smart contract is often used to refer to software programs that run on blockchains. While a standard legal contract outlines the terms of a relationship (usually one enforceable by law), a smart contract enforces a set of rules using self-executing code within NFT platforms. As such, smart contracts may have the means to automatically enforce specific programmatic rules through platforms. Smart contracts are often developed as high-level programming abstractions that can be compiled down to bytecode. Said bytecode may be deployed to blockchains for execution by computer systems using any number of mechanisms deployed in conjunction with the blockchain. In many instances, smart contracts execute by leveraging the code of other smart contracts in a manner similar to calling upon a software library.

A number of existing decentralized blockchain technologies intentionally exclude or prevent rich media assets from existing within the blockchain, because they would need to address content that is not static (e.g., images, videos, music files). Therefore, NFT platforms in accordance with many embodiments of the invention may address this with blockchain mechanisms, that preclude general changes but account for updated content.

NFT platforms in accordance with many embodiments of the invention can therefore incorporate decentralized storage pseudo-immutable dual blockchains. In some embodiments, two or more blockchains may be interconnected such that traditional blockchain consensus algorithms support a first blockchain serving as an index to a second, or more, blockchains serving to contain and protect resources, such as the rich media content associated with NFTs.

In storing rich media using blockchain, several components may be utilized by an entity (“miner”) adding transactions to said blockchain. References, such as URLs, may be stored in the blockchain to identify assets. Multiple URLs may also be stored when the asset is separated into pieces. An alternative or complementary option may be the use of APIs to return either the asset or a URL for the asset. In accordance with many embodiments of the invention, references can be stored by adding a ledger entry incorporating the reference enabling the entry to be timestamped. In doing so, the URL, which typically accounts for domain names, can be resolved to IP addresses. However, when only files of certain types are located on particular resources, or where small portions of individual assets are stored at different locations, users may require methods to locate assets stored on highly-splintered decentralized storage systems. To do so, systems may identify at least primary asset destinations and update those primary asset destinations as necessary when storage resources change. The mechanisms used to identify primary asset destinations may take a variety of forms including, but not limited to, smart contracts.

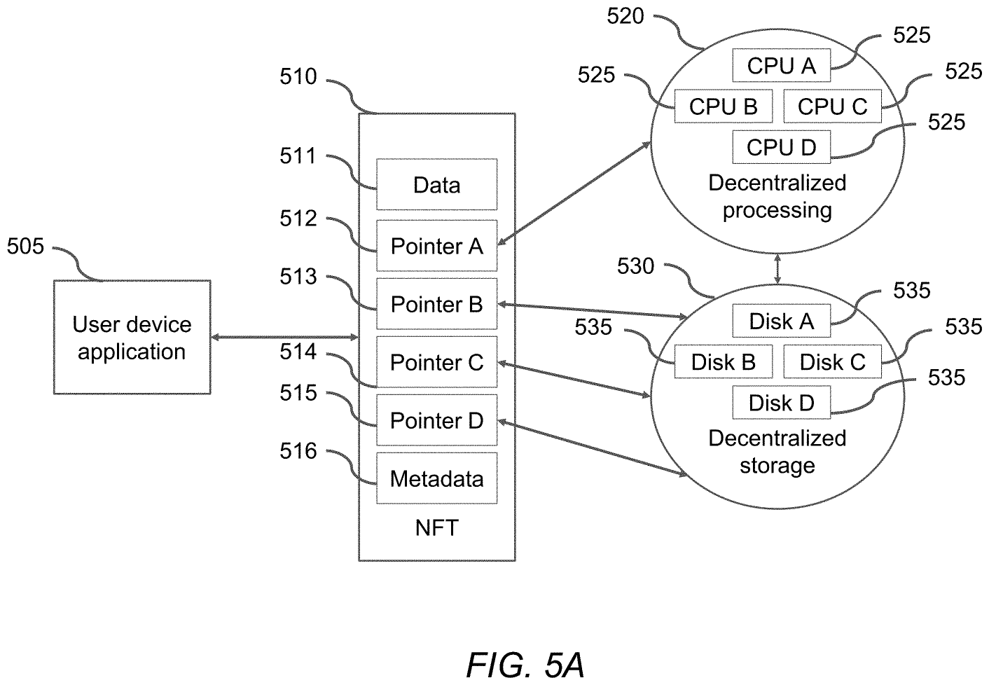

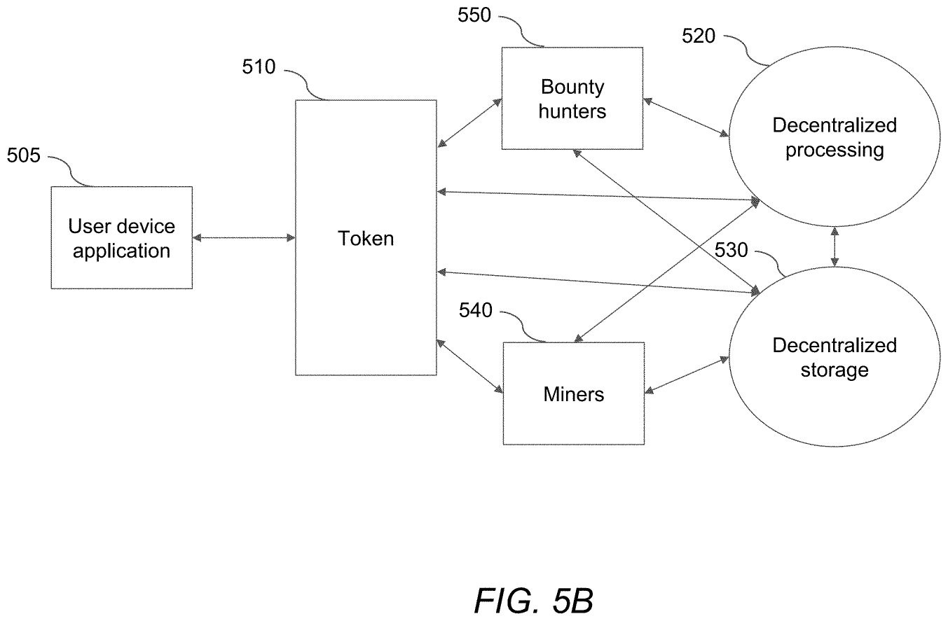

A dual blockchain, including decentralized processing 520 and decentralized storage 530 blockchains, in accordance with some embodiments of the invention is illustrated in FIG. 5A. Application running on devices 505, may interact with or make a request related to NFTs 510 interacting with such a blockchain. An NFT 510 in accordance with several embodiments of the invention may include many values including generalized data 511 (e.g. URLs), and pointers such as pointer A 512, pointer B 513, pointer C 514, and pointer D 515. In accordance with many embodiments of the invention, the generalized data 511 may be used to access corresponding rich media through the NFT 510. The NFT 510 may additionally have associated metadata 516.

Pointers within the NFT 510 may direct an inquiry toward a variety of on or off-ledger resources. In some embodiments of the invention, as illustrated FIG. 5A, pointer A 512 can direct the need for processing to the decentralized processing network 520. Processing systems are illustrated as CPU A, CPU B, CPU C, and CPU D 525. The CPUs 525 may be personal computers, server computers, mobile devices, edge IoT devices, etc. Pointer A may select one or more processors at random to perform the execution of a given smart contract. The code may be secure or nonsecure and the CPU may be a trusted execution environment (TEE), depending upon the needs of the request. In the example reflected in FIG. 5A, pointer B 513, pointer C 514, and pointer D 515 all point to a decentralized storage network 530 including remote off-ledger resources including storage systems illustrated as Disks A, B, C, and D 535.

The decentralized storage system may co-mingle with the decentralized processing system as the individual storage systems utilize CPU resources and connectivity to perform their function. From a functional perspective, the two decentralized systems may also be separate. Pointer B 513 may point to one or more decentralized storage networks 530 for the purposes of maintaining an off-chain log file of token activity and requests. Pointer C 514 may point to executable code within one or more decentralized storage networks 530. And Pointer D 515 may point to rights management data, security keys, and/or configuration data within one or more decentralized storage networks 530.

Dual blockchains may additionally incorporate methods for detection of abuse, essentially operating as a “bounty hunter” 550. FIG. 5B illustrates the inclusion of bounty hunters 550 within dual blockchain structures implemented in accordance with an embodiment of the invention. Bounty hunters 550 allow NFTs 510, which can point to networks that may include decentralized processing 520 and/or storage networks 530, to be monitored. The bounty hunter's 550 objective may be to locate incorrectly listed or missing data and executable code within the NFT 510 or associated networks. Additionally, the miner 540 can have the capacity to perform all necessary minting processes or any process within the architecture that involves a consensus mechanism.

Bounty hunters 550 may also choose to verify each step of a computation, and if they find an error, submit evidence of this in return for some reward. This can have the effect of invalidating the incorrect ledger entry and, potentially based on policies, all subsequent ledger entries. Such evidence can be submitted in a manner that is associated with a public key, in which the bounty hunter 550 proves knowledge of the error, thereby assigning value (namely the bounty) with the public key.

Assertions made by bounty hunters 550 may be provided directly to miners 540 by broadcasting the assertion. Assertions may be broadcast in a manner including, but not limited to posting it to a bulletin board. In some embodiments of the invention, assertions may be posted to ledgers of blockchains, for instance, the blockchain on which the miners 540 operate. If the evidence in question has not been submitted before, this can automatically invalidate the ledger entry that is proven wrong and provide the bounty hunter 550 with some benefit.

Applications and methods in accordance with various embodiments of the invention are not limited to use within NFT platforms. Accordingly, it should be appreciated that the capabilities of any blockchain configuration described herein can also be implemented outside the context of an NFT platform network architecture unrelated to the storage of fungible tokens and/or NFTs. A variety of components, mechanisms, and blockchain configurations that can be utilized within NFT platforms are discussed further below. Moreover, any of the blockchain configurations described herein with reference to FIGS. 3-5B (including permissioned, permissionless, and/or hybrid mechanisms) can be utilized within any of the networks implemented within the NFT platforms described above.

### NFT Platform Consensus Mechanisms

NFT platforms in accordance with many embodiments of the invention can depend on consensus mechanisms to achieve agreement on network state, through proof resolution, to validate transactions. In accordance with many embodiments of the invention, Proof of Work (PoW) mechanisms may be used as a means of demonstrating non-trivial allocations of processing power. Proof of Space (PoS) mechanisms may be used as a means of demonstrating non-trivial allocations of memory or disk space. As a third possible approach, Proof of Stake mechanisms may be used as a means of demonstrating non-trivial allocations of fungible tokens and/or NFTs as a form of collateral. Numerous consensus mechanisms are possible in accordance with various embodiments of the invention, some of which are expounded on below.

Traditional mining schemes, such as Bitcoin, are based on Proof of Work, based on performing the aforementioned large computational tasks. The cost of such tasks may not only be computational effort, but also energy expenditure, a significant environmental concern. To address this problem, mining methods operating in accordance with many embodiments of the invention may instead operate using Proof of Space mechanisms to accomplish network consensus, wherein the distinguishing factor can be memory rather than processing power. Specifically, Proof of Space mechanisms can perform this through network optimization challenges. In several embodiments the network optimization challenge may be selected from any of a number of different challenges appropriate to the requirements of specific applications including graph pebbling. In some embodiments, graph pebbling may refer to a resource allocation game played on discrete mathematics graphs, ending with a labeled graph disclosing how a player might get at least one pebble to every vertex of the graph.

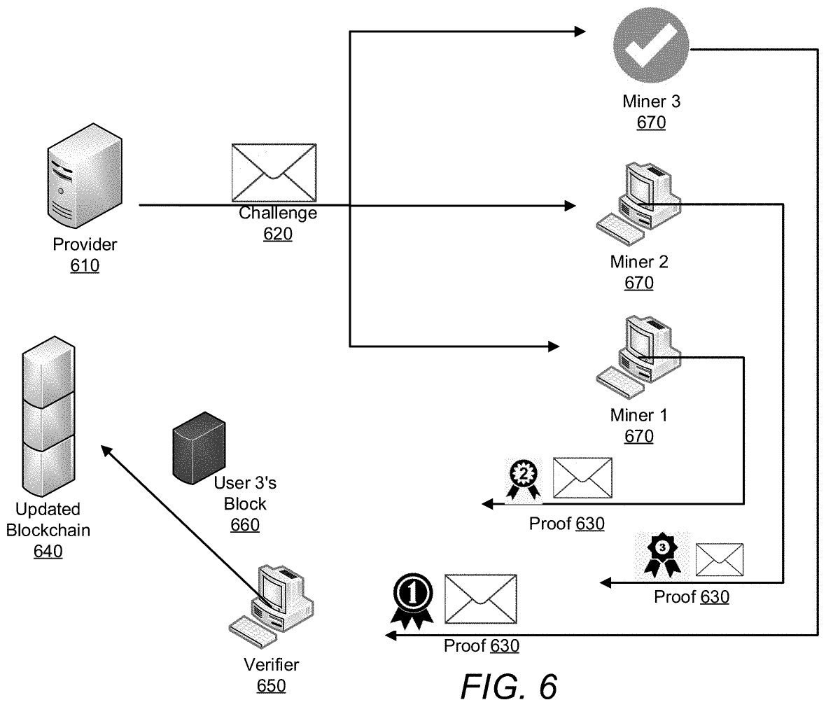

An example of Proof of Work consensus mechanisms that may be implemented in decentralized blockchains, in accordance with a number of embodiments of the invention, is conceptually illustrated in FIG. 6. The example disclosed in this figure is a challenge-response authentication, a protocol classification in which one party presents a complex problem (“challenge”) 610 and another party must broadcast a valid answer (“proof”) 620 to have clearance to add a block to the decentralized ledger that makes up the blockchain 630. As a number of miners may be competing to have this ability, there may be a need for determining factors for the addition to be added first, which in this case is processing power. Once an output is produced, verifiers 640 in the network can verify the proof, something which typically requires much less processing power, to determine the first device that would have the right to add the winning block 650 to the blockchain 630. As such, under a Proof of Work consensus mechanism, each miner involved can have a success probability proportional to the computational effort expended.

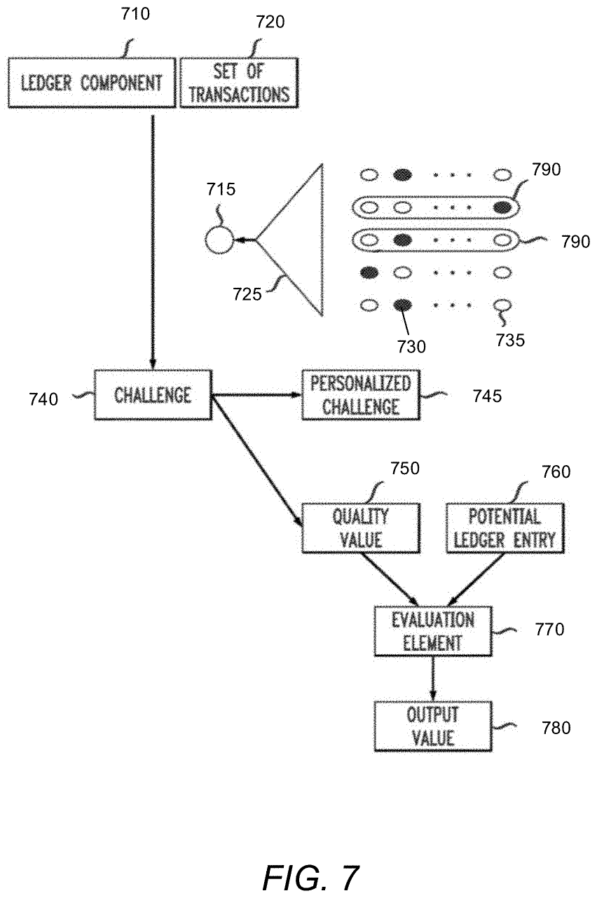

An example of Proof of Space implementations on devices in accordance with some embodiments of the invention is conceptually illustrated in FIG. 7. The implementation includes a ledger component 710, a set of transactions 720, and a challenge 740 computed from a portion of the ledger component 710. A representation 715 of a miner's state may also be recorded in the ledger component 710 and be publicly available.

In some embodiments, the material stored on the memory of the device includes a collection of nodes 730, 735, where nodes that depend on other nodes have values that are functions of the values of the associated nodes on which they depend. For example, functions may be one-way functions, such as cryptographic hash functions. In several embodiments the cryptographic hash function may be selected from any of a number of different cryptographic hash functions appropriate to the requirements of specific applications including (but not limited to) the SHA1 cryptographic hash function. In such an example, one node in the network may be a function of three other nodes. Moreover, the node may be computed by concatenating the values associated with these three nodes and applying the cryptographic hash function, assigning the result of the computation to the node depending on these three parent nodes. In this example, the nodes are arranged in rows, where two rows 790 are shown. The nodes are stored by the miner, and can be used to compute values at a setup time. This can be done using Merkle tree hash-based data structures 725, or another structure such as a compression function and/or a hash function.

Challenges 740 may be processed by the miner to obtain personalized challenges 745, made to the device according to the miner's storage capacity. The personalized challenge 745 can be the same or have a negligible change, but could also undergo an adjustment to account for the storage space accessible by the miner, as represented by the nodes the miner stores. For example, when the miner does not have a large amount of storage available or designated for use with the Proof of Space system, a personalized challenge 745 may adjust challenges 740 to take this into consideration, thereby making a personalized challenge 745 suitable for the miner's memory configuration.

In some embodiments, the personalized challenge 745 can indicate a selection of nodes 730, denoted in FIG. 7 by filled-in circles. In the FIG. 7 example specifically, the personalized challenge corresponds to one node per row. The collection of nodes selected as a result of computing the personalized challenge 745 can correspond to a valid potential ledger entry 760. However, here a quality value 750 (also referred to herein as a qualifying function value) can also be computed from the challenge 740, or from other public information that is preferably not under the control of any one miner.

A miner may perform matching evaluations 770 to determine whether the set of selected nodes 730 matches the quality value 750. This process can take into consideration what the memory constraints of the miner are, causing the evaluation 770 to succeed with a greater frequency for larger memory configurations than for smaller memory configurations. This can simultaneously level the playing field to make the likelihood of the evaluation 770 succeeding roughly proportional to the size of the memory used to store the nodes used by the miner. In some embodiments, non-proportional relationships may be created by modifying the function used to compute the quality value 750. When the evaluation 770 results in success, then the output value 780 may be used to confirm the suitability of the memory configuration and validate the corresponding transaction.

In many embodiments, nodes 730 and 735 can also correspond to public keys. The miner may submit valid ledger entries, corresponding to a challenge-response pair including one of these nodes. In that case, public key values can become associated with the obtained NFT. As such, miners can use a corresponding secret/private key to sign transaction requests, such as purchases. Additionally, any type of digital signature can be used in this context, such as RSA signatures, Merkle signatures, DSS signatures, etc. Further, the nodes 730 and 735 may correspond to different public keys or to the same public key, the latter preferably augmented with a counter and/or other location indicator such as a matrix position indicator, as described above. Location indicators in accordance with many embodiments of the invention may be applied to point to locations within a given ledger. In accordance with some embodiments of the invention, numerous Proof of Space consensus configurations are possible, some of which are discussed below.

Hybrid methods of evaluating Proof of Space problems can also be implemented in accordance with many embodiments of the invention. In many embodiments, hybrid methods can be utilized that conceptually correspond to modifications of Proof of Space protocols in which extra effort is expanded to increase the probability of success, or to compress the amount of space that may be applied to the challenge. Both come at a cost of computational effort, thereby allowing miners to improve their odds of winning by spending greater computational effort. Accordingly, in many embodiments of the invention dual proof-based systems may be used to reduce said computational effort. Such systems may be applied to Proof of Work and Proof of Space schemes, as well as to any other type of mining-based scheme.

When utilizing dual proofs in accordance with various embodiments of the invention, the constituent proofs may have varying structures. For example, one may be based on Proof of Work, another on Proof of Space, and a third may be a system that relies on a trusted organization for controlling the operation, as opposed to relying on mining for the closing of ledgers. Yet other proof structures can be combined in this way. The result of the combination will inherit properties of its components. In many embodiments, the hybrid mechanism may incorporate a first and a second consensus mechanism. In several embodiments, the hybrid mechanism includes a first, a second, and a third consensus mechanisms. In a number of embodiments, the hybrid mechanism includes more than three consensus mechanisms. Any of these embodiments can utilize consensus mechanisms selected from the group including (but not limited to) Proof of Work, Proof of Space, and Proof of Stake without departing from the scope of the invention. Depending on how each component system is parametrized, different aspects of the inherited properties will dominate over other aspects.

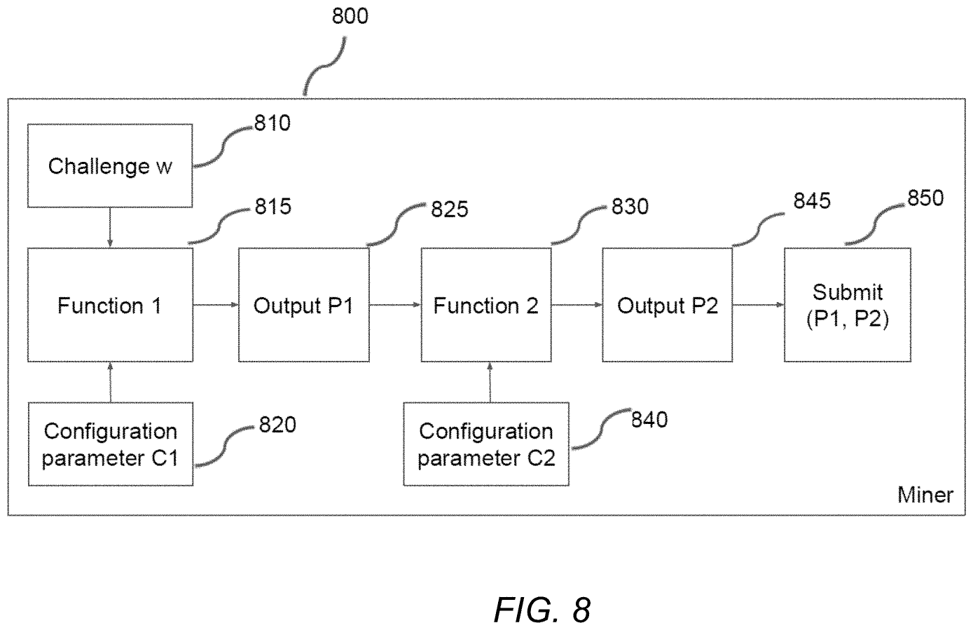

Dual proof configurations in accordance with a number of embodiments of the invention is illustrated in FIG. 8. A proof configuration in accordance with some embodiments of the invention may tend to use the notion of quality functions for tie-breaking among multiple competing correct proofs relative to a given challenge (w) 810. This classification of proof can be described as a qualitative proof, inclusive of proofs of work and proofs of space. In the example reflected in FIG. 8, proofs P1 and P2 are each one of a Proof of Work, Proof of Space, Proof of Stake, and/or any other proof related to a constrained resource, wherein P2 may be of a different type than P1, or may be of the same type.

Systems in accordance with many embodiments of the invention may introduce the notion of a qualifying proof, which, unlike qualitative proofs, are either valid or not valid, using no tie-breaking mechanism. Said systems may include a combination of one or more qualitative proofs and one or more qualifying proofs. For example, it may use one qualitative proof that is combined with one qualifying proof, where the qualifying proof is performed conditional on the successful creation of a qualitative proof. FIG. 8 illustrates challenge w 810, as described above, with a function 1 815, which is a qualitative function, and function 2 830, which is a qualifying function.

To stop miners from expending effort after a certain amount of effort has been spent, thereby reducing the environmental impact of mining, systems in accordance with a number of embodiments of the invention can constrain the search space for the mining effort. This can be done using a configuration parameter that controls the range of random or pseudo-random numbers that can be used in a proof. Upon challenge w 810 being issued to one or more miners 800, it can be input to Function 1 815 along with configuration parameter C1 820. Function 1 815 may output proof P1 825, in this example the qualifying proof to Function 2 830. Function 2 830 is also provided with configuration parameter C2 840 and computes qualifying proof P2 845. The miner 800 can then submit the combination of proofs (P1, P2) 850 to a verifier, in order to validate a ledger associated with challenge w 810. In some embodiments, miner 800 can also submit the proofs (P1, P2) 850 to be accessed by a 3rd-party verifier.

NFT platforms in accordance with many embodiments of the invention may additionally benefit from alternative energy-efficient consensus mechanisms. Therefore, computer systems in accordance with several embodiments of the invention may instead use consensus-based methods alongside or in place of proof-of-space and proof-of-space based mining. In particular, consensus mechanisms based instead on the existence of a Trusted Execution Environment (TEE), such as ARM TrustZone™ or Intel SGX™ may provide assurances exist of integrity by virtue of incorporating private/isolated processing environments.

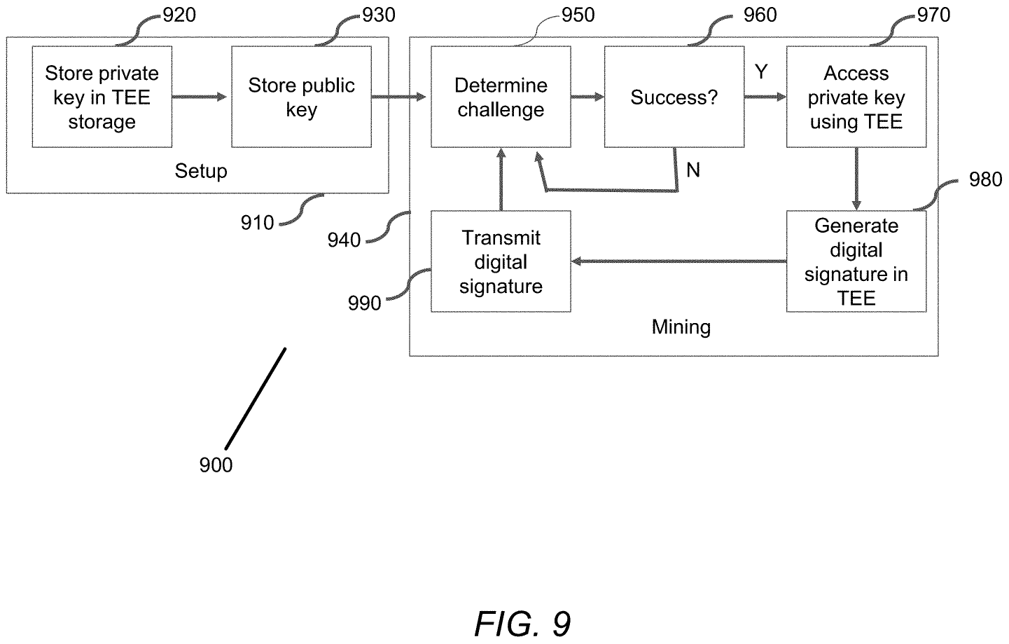

An illustration of sample process 900 undergone by TEE-based consensus mechanisms in accordance with some embodiments of the invention is depicted in FIG. 9. In some such configurations, a setup 910 may be performed by an original equipment manufacturer (OEM) or a party performing configurations of equipment provided by an OEM. Once a private key/public key pair is generated in the secure environment, process 900 may store (920) the private key in TEE storage (i.e. storage associated with the Trusted Execution Environment). While storage may be accessible from the TEE, it can be shielded from applications running outside the TEE. Additionally, processes can store (930) the public key associated with the TEE in any storage associated with the device containing the TEE. Unlike the private key, the public key may also be accessible from applications outside the TEE. In a number of embodiments, the public key may also be certified. Certification may come from OEMs or trusted entities associated with the OEMs, wherein the certificate can be stored with the public key.

In many embodiments of the invention, mining-directed steps can also be influenced by the TEE. In the illustrated embodiment, the process 900 can determine (950) a challenge. For example, this may be by computing a hash of the contents of a ledger. In doing so, process 900 may also determine whether the challenge corresponds to success 960. In some embodiments of the invention, the determination of success may result from some pre-set portion of the challenge matching a pre-set portion of the public key, e.g. the last 20 bits of the two values matching. In several embodiments the success determination mechanism may be selected from any of a number of alternate approaches appropriate to the requirements of specific applications. The matching conditions may also be modified over time. For example, modification may result from an announcement from a trusted party or based on a determination of a number of participants having reached a threshold value.

When the challenge does not correspond to a success 960, process 900 can return to determine (950) a new challenge. In this context, process 900 can determine (950) a new challenge after the ledger contents have been updated and/or a time-based observation is performed. In several embodiments the determination of a new challenge may come from any of a number of approaches appropriate, to the requirements of specific applications, including, but not limited to, the observation of as a second elapsing since the last challenge. If the challenge corresponds to a success 960, then the processing can continue on to access (970) the private key using the TEE.

When the private key is accessed, process can generate (980) a digital signature using the TEE. The digital signature may be on a message that includes the challenge and/or which otherwise references the ledger entry being closed. Process 900 can also transmit (980) the digital signature to other participants implementing the consensus mechanism. In cases where multiple digital signatures are received and found to be valid, a tie-breaking mechanism can be used to evaluate the consensus. For example, one possible tie-breaking mechanism may be to select the winner as the party with the digital signature that represents the smallest numerical value when interpreted as a number. In several embodiments the tie-breaking mechanism may be selected from any of a number of alternate tie-breaking mechanisms appropriate to the requirements of specific applications.

Applications and methods in accordance with various embodiments of the invention are not limited to use within NFT platforms. Accordingly, it should be appreciated that consensus mechanisms described herein can also be implemented outside the context of an NFT platform network architecture unrelated to the storage of fungible tokens and/or NFTs. Moreover, any of the consensus mechanisms described herein with reference to FIGS. 6-9 (including Proof of Work, Proof of Space, Proof of Stake, and/or hybrid mechanisms) can be utilized within any of the blockchains implemented within the NFT platforms described above with reference to FIGS. 3-5B. Various systems and methods for implementing NFT platforms and applications in accordance with numerous embodiments of the invention are discussed further below.

### NFT Platform Constituent Devices and Applications

A variety of computer systems that can be utilized within NFT platforms and systems that utilize NFT blockchains in accordance with various embodiments of the invention are illustrated below. The computer systems in accordance with many embodiments of the invention may implement a processing system 1010, 1120, 1220 using one or more CPUs, GPUs, ASICs, FPGAs, and/or any of a variety of other devices and/or combinations of devices that are typically utilized to perform digital computations. As can readily be appreciated each of these computer systems can be implemented using one or more of any of a variety of classes of computing devices including (but not limited to) mobile phone handsets, tablet computers, laptop computers, personal computers, gaming consoles, televisions, set top boxes and/or other classes of computing device.

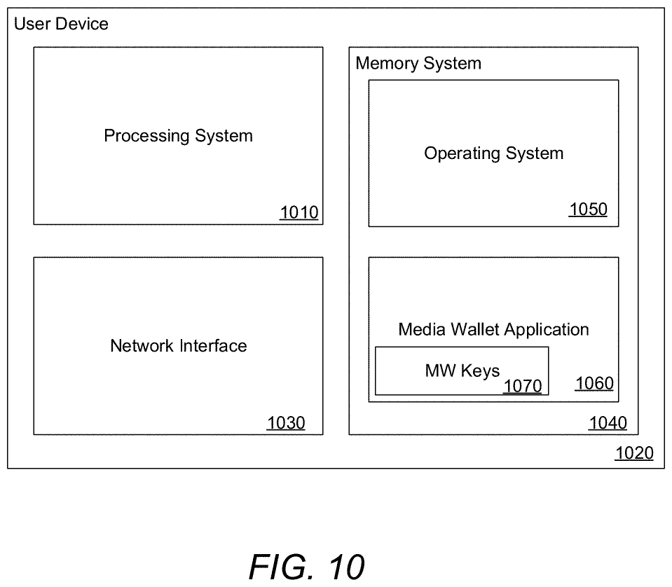

A user device capable of communicating with an NFT platform in accordance with an embodiment of the invention is illustrated in FIG. 10. The memory system 1040 of particular user devices may include an operating system 1050 and media wallet applications 1060. Media wallet applications may include sets of media wallet (MW) keys 1070 that can include public key/private key pairs. The set of MW keys may be used by the media wallet application to perform a variety of actions including, but not limited to, encrypting and signing data. In many embodiments, the media wallet application enables the user device to obtain and conduct transactions with respect to NFTs by communicating with an NFT blockchain via the network interface 1030. In some embodiments, the media wallet applications are capable of enabling the purchase of NFTs using fungible tokens via at least one distributed exchange. User devices may implement some or all of the various functions described above with reference to media wallet applications as appropriate to the requirements of a given application in accordance with various embodiments of the invention.

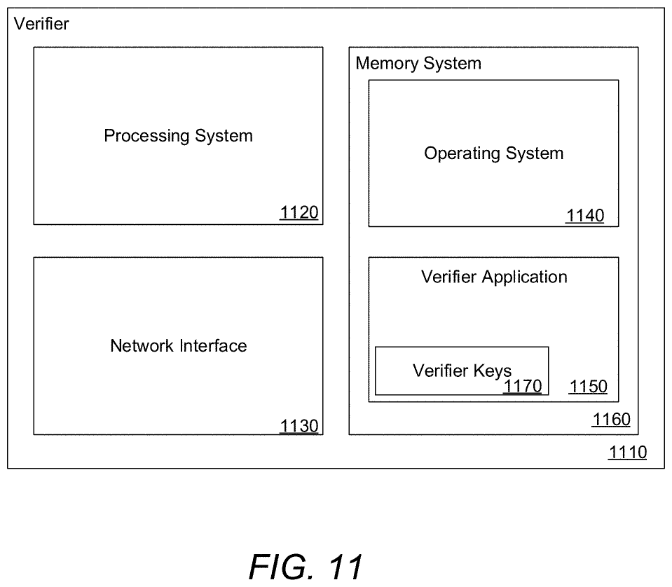

A verifier 1110 capable of verifying blockchain transactions in an NFT platform in accordance with many embodiments of the invention is illustrated in FIG. 11. The memory system 1160 of the verifier computer system includes an operating system 1140 and a verifier application 1150 that enables the verifier 1110 computer system to access a decentralized blockchain in accordance with various embodiments of the invention. Accordingly, the verifier application 1150 may utilize a set of verifier keys 1170 to affirm blockchain entries. When blockchain entries can be verified, the verifier application 1150 may transmit blocks to the corresponding blockchains. The verifier application 1150 can also implement some or all of the various functions described above with reference to verifiers as appropriate to the requirements of a given application in accordance with various embodiments of the invention.

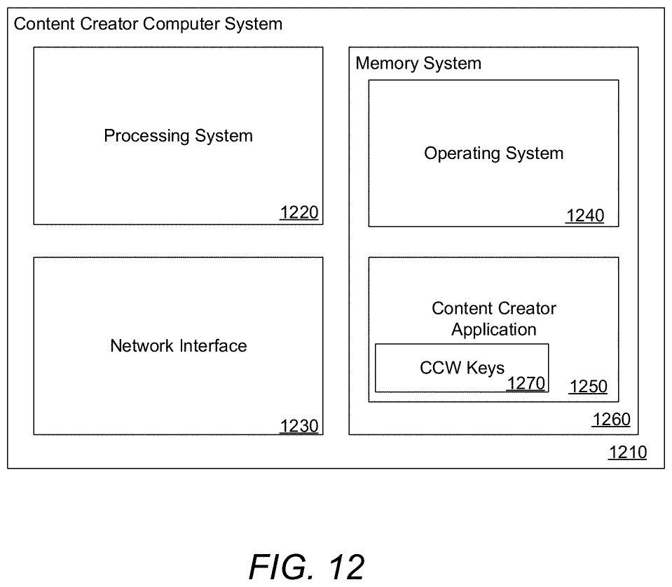

A content creator system 1210 capable of disseminating content in an NFT platform in accordance with an embodiment of the invention is illustrated in FIG. 12. The memory system 1260 of the content creator computer system may include an operating system 1240 and a content creator application 1250. The content creator application 1250 may enable the content creator computer system to mint NFTs by writing smart contracts to blockchains via the network interface 1230. The content creator application can include sets of content creator wallet (CCW) keys 1270 that can include a public key/private key pairs. Content creator applications may use these keys to sign NFTs minted by the content creator application. The content creator application can also implement some or all of the various functions described above with reference to content creators as appropriate to the requirements of a given application in accordance with various embodiments of the invention.

Computer systems in accordance with many embodiments of the invention incorporate digital wallets (herein also referred to as “wallets” or “media wallets”) for NFT and/or fungible token storage. In several embodiments, the digital wallet may securely store rich media NFTs and/or other tokens. Additionally, in some embodiments, the digital wallet may display user interface through which user instructions concerning data access permissions can be received.

In a number of embodiments of the invention, digital wallets may be used to store at least one type of token-directed content. Example content types may include, but are not limited to crypto currencies of one or more sorts; non-fungible tokens; and user profile data.

Example user profile data may incorporate logs of user actions. In accordance with some embodiments of the invention, example anonymized user profile data may include redacted, encrypted, and/or otherwise obfuscated user data. User profile data in accordance with some embodiments may include, but are not limited to, information related to classifications of interests, determinations of a post-advertisement purchases, and/or characterizations of wallet contents.

Media wallets, when storing content, may store direct references to content. Media wallets may also reference content through keys to decrypt and/or access the content. Media wallets may use such keys to additionally access metadata associated with the content. Example metadata may include, but is not limited to, classifications of content. In a number of embodiments, the classification metadata may govern access rights of other parties related to the content.

Access governance rights may include, but are not limited to, whether a party can indicate their relationship with the wallet; whether they can read summary data associated with the content; whether they have access to peruse the content; whether they can place bids to purchase the content; whether they can borrow the content, and/or whether they are biometrically authenticated.

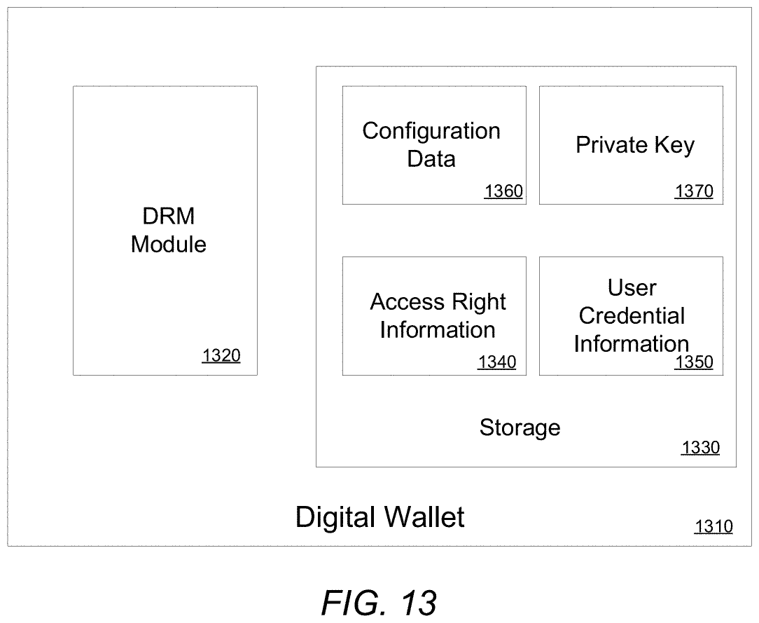

An example of a media wallet 1310 capable of storing rich media NFTs in accordance with an embodiment of the invention is illustrated in FIG. 13. Media wallets 1310 may include a storage component 1330, including access right information 1340, user credential information 1350, token configuration data 1360, and/or at least one private key 1370. In accordance with many embodiments of the invention, a private key 1370 may be used to perform a plurality of actions on resources, including but not limited to decrypting NFT and/or fungible token content. Media wallets may also correspond to a public key, referred to as a wallet address. An action performed by private keys 1370 may be used to prove access rights to digital rights management modules. Additionally, private keys 1370 may be applied to initiating ownership transfers and granting NFT and/or fungible token access to alternate wallets. In accordance with some embodiments, access right information 1340 may include lists of elements that the wallet 1310 has access to. Access right information 1340 may also express the type of access provided to the wallet. Sample types of access include, but are not limited to, the right to transfer NFT and/or fungible ownership, the right to play rich media associated with a given NFT, and the right to use an NFT and/or fungible token. Different rights may be governed by different cryptographic keys. Additionally, the access right information 1340 associated with a given wallet 1310 may utilize user credential information 1350 from the party providing access.

In accordance with many embodiments of the invention, third parties initiating actions corresponding to requesting access to a given NFT may require user credential information 1350 of the party providing access to be verified. User credential information 1350 may be taken from the group including, but not limited to, a digital signature, hashed passwords, PINs, and biometric credentials. User credential information 1350 may be stored in a manner accessible only to approved devices. In accordance with some embodiments of the invention, user credential information 1350 may be encrypted using a decryption key held by trusted hardware, such as a trusted execution environment. Upon verification, user credential information 1350 may be used to authenticate wallet access.

Available access rights may be determined by digital rights management (DRM) modules 1320 of wallets 1310. In the context of rich media, encryption may be used to secure content. As such, DRM systems may refer to technologies that control the distribution and use of keys required to decrypt and access content. DRM systems in accordance with many embodiments of the invention may require a trusted execution zone. Additionally, said systems may require one or more keys (typically a certificate containing a public key/private key pair) that can be used to communicate with and register with DRM servers. DRM modules 1320 in some embodiments may also use one or more keys to communicate with a DRM server. In several embodiments, the DRM modules 1320 may include code used for performing sensitive transactions for wallets including, but not limited to, content access. In accordance with a number of embodiments of the invention, the DRM module 1320 may execute in a Trusted Execution Environment. In a number of embodiments, the DRM may be facilitated by an Operating System (OS) that enables separation of processes and processing storage from other processes and their processing storage.

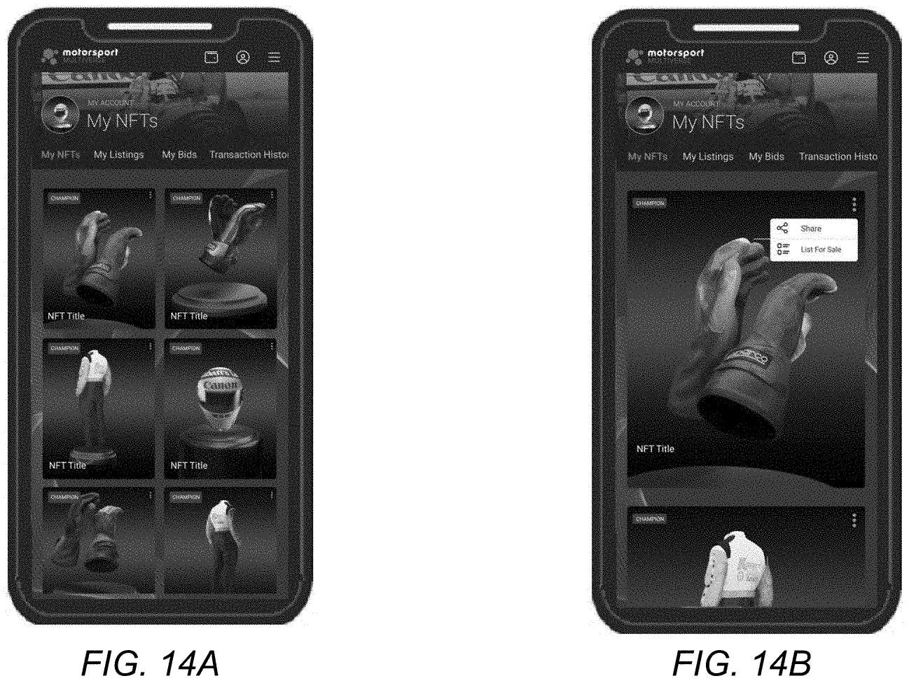

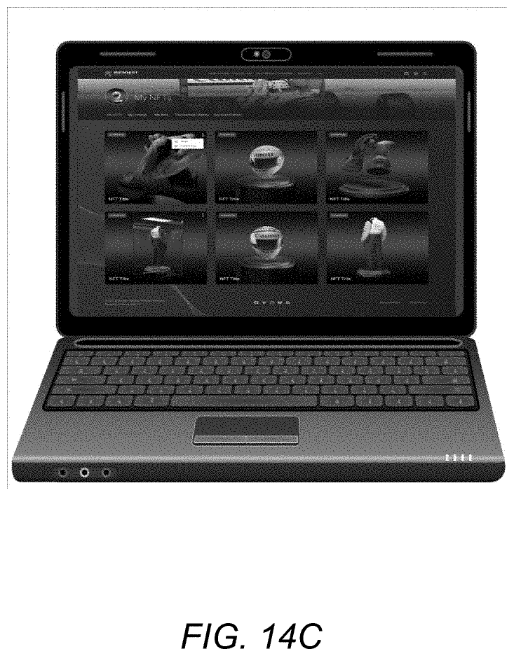

Operation of media wallet applications implemented in accordance with some embodiments of the invention is conceptually illustrated by way of the user interfaces shown in FIGS. 14A-14C. In many embodiments, media wallet applications can refer to applications that are installed upon user devices such as (but not limited to) mobile phones and tablet computers running the iOS, Android and/or similar operating systems. Launching media wallet applications can provide a number of user interface contexts. In many embodiments, transitions between these user interface contexts can be initiated in response to gestures including (but not limited to) swipe gestures received via a touch user interface. As can readily be appreciated, the specific manner in which user interfaces operate through media wallet applications is largely dependent upon the user input capabilities of the underlying user device. In several embodiments, a first user interface context is a dashboard (see, FIGS. 14A, 14C) that can include a gallery view of NFTs owned by the user. In several embodiments, the NFT listings can be organized into category index cards. Category index cards may include, but are not limited to digital merchandise/collectibles, special event access/digital tickets, fan leaderboards. In certain embodiments, a second user interface context (see, for example, FIG. 14B) may display individual NFTs. In a number of embodiments, each NFT can be main-staged in said display with its status and relevant information shown. Users can swipe through each collectible and interacting with the user interface can launch a collectible user interface enabling greater interaction with a particular collectible in a manner that can be determined based upon the smart contract underlying the NFT.

A participant of an NFT platform may use a digital wallet to classify wallet content, including NFTs, fungible tokens, content that is not expressed as tokens such as content that has not yet been minted but for which the wallet can initiate minting, and other non-token content, including executable content, webpages, configuration data, history files and logs. This classification may be performed using a visual user interface. Users interface may enable users to create a visual partition of a space. In some embodiments of the invention, a visual partition may in turn be partitioned into sub-partitions. In some embodiments, a partition of content may separate wallet content into content that is not visible to the outside world (“invisible partition”), and content that is visible at least to some extent by the outside world (“visible partition”). Some of the wallet content may require the wallet use to have an access code such as a password or a biometric credential to access, view the existence of, or perform transactions on. A visible partition may be subdivided into two or more partitions, where the first one corresponds to content that can be seen by anybody, the second partition corresponds to content that can be seen by members of a first group, and/or the third partition corresponds to content that can be seen by members of a second group.

For example, the first group may be users with which the user has created a bond, and invited to be able to see content. The second group may be users who have a membership and/or ownership that may not be controlled by the user. An example membership may be users who own non-fungible tokens (NFTs) from a particular content creator. Content elements, through icons representing the elements, may be relocated into various partitions of the space representing the user wallet. By doing so, content elements may be associated with access rights governed by rules and policies of the given partition.

One additional type of visibility may be partial visibility. Partial visibility can correspond to a capability to access metadata associated with an item, such as an NFT and/or a quantity of crypto funds, but not carry the capacity to read the content, lend it out, or transfer ownership of it. As applied to a video NFT, an observer to a partition with partial visibility may not be able to render the video being encoded in the NFT but see a still image of it and a description indicating its source.

Similarly, a party may have access to a first anonymized profile which states that the user associated with the wallet is associated with a given demographic. The party with this access may also be able to determine that a second anonymized profile including additional data is available for purchase. This second anonymized profile may be kept in a sub-partition to which only people who pay a fee have access, thereby expressing a form of membership. Alternatively, only users that have agreed to share usage logs, aspects of usage logs or parts thereof may be allowed to access a given sub-partition. By agreeing to share usage log information with the wallet including the sub-partition, this wallet learns of the profiles of users accessing various forms of content, allowing the wallet to customize content, including by incorporating advertisements, and to determine what content to acquire to attract users of certain demographics.

Another type of membership may be held by advertisers who have sent promotional content to the user. These advertisers may be allowed to access a partition that stores advertisement data. Such advertisement data may be encoded in the form of anonymized profiles. In a number of embodiments, a given sub-partition may be accessible only to the advertiser to whom the advertisement data pertains. Elements describing advertisement data may be automatically placed in their associated partitions, after permission has been given by the user. This partition may either be visible to the user. Visibility may also depend on a direct request to see “system partitions.” A first partition may correspond to material associated with a first set of public keys, a second partition to material associated with a second set of public keys not overlapping with the first set of public keys, wherein such material may include tokens such as crypto coins and NFTs. A third partition may correspond to usage data associated with the wallet user, and a fourth partition may correspond to demographic data and/or preference data associated with the wallet user. Yet other partitions may correspond to classifications of content, e.g., child-friendly vs. adult; classifications of whether associated items are for sale or not, etc.

The placing of content in a given partition may be performed by a drag-and-drop action performed on a visual interface. By selecting items and clusters and performing a drag-and-drop to another partition and/or to a sub-partition, the visual interface may allow movement including, but not limited to, one item, a cluster of items, and a multiplicity of items and clusters of items. The selection of items can be performed using a lasso approach in which items and partitions are circled as they are displayed. The selection of items may also be performed by alternative methods for selecting multiple items in a visual interface, as will be appreciated by a person of skill in the art.

Some content classifications may be automated in part or full. For example, when user place ten artifacts, such as NFTs describing in-game capabilities, in a particular partition, they may be asked if additional content that are also in-game capabilities should be automatically placed in the same partition as they are acquired and associated with the wallet. When “yes” is selected, then this placement may be automated in the future. When “yes, but confirm for each NFT” is selected, then users can be asked, for each automatically classified element, to confirm its placement. Before the user confirms, the element may remain in a queue that corresponds to not being visible to the outside world. When users decline given classifications, they may be asked whether alternative classifications should be automatically performed for such elements onwards. In some embodiments, the selection of alternative classifications may be based on manual user classification taking place subsequent to the refusal.

Automatic classification of elements may be used to perform associations with partitions and/or folders. The automatic classification may be based on machine learning (ML) techniques considering characteristics including, but not limited to, usage behaviors exhibited by the user relative to the content to be classified, labels associated with the content, usage statistics; and/or manual user classifications of related content.

Multiple views of wallets may also be accessible. One such view can correspond to the classifications described above, which indicates the actions and interactions others can perform relative to elements. Another view may correspond to a classification of content based on use, type, and/or users-specified criterion. For example, all game NFTs may be displayed in one collection view. The collection view may further subdivide the game NFTs into associations with different games or collections of games. Another collection may show all audio content, clustered based on genre. users-specified classification may be whether the content is for purposes of personal use, investment, or both. A content element may show up in multiple views. users can search the contents of his or her wallet by using search terms that result in potential matches.

Alternatively, the collection of content can be navigated based the described views of particular wallets, allowing access to content. Once a content element has been located, the content may be interacted with. For example, located content elements may be rendered. One view may be switched to another after a specific item is found. For example, this may occur through locating an item based on its genre and after the item is found, switching to the partitioned view described above. In some embodiments, wallet content may be rendered using two or more views in a simultaneous manner. They may also select items using one view.

Media wallet applications in accordance with various embodiments of the invention are not limited to use within NFT platforms. Accordingly, it should be appreciated that applications described herein can also be implemented outside the context of an NFT platform network architecture unrelated to the storage of fungible tokens and/or NFTs. Moreover, any of the computer systems described herein with reference to FIGS. 10-14C can be utilized within any of the NFT platforms described above.

### NFT Platform NFT Interactions

NFT platforms in accordance with many embodiments of the invention may incorporate a wide variety of rich media NFT configurations. The term “Rich Media Non-Fungible Tokens” can be used to refer to blockchain-based cryptographic tokens created with respect to a specific piece of rich media content and which incorporate programmatically defined digital rights management. In some embodiments of the invention, each NFT may have a unique serial number and be associated with a smart contract defining an interface that enables the NFT to be managed, owned and/or traded.

Under a rich media blockchain in accordance with many embodiments of the invention, a wide variety of NFT configurations may be implemented. Some NFTs may be referred to as anchored NFTs (or anchored tokens), used to tie some element, such as a physical entity, to an identifier. Of this classification, one sub-category may be used to tie users' real-world identities and/or identifiers to a system identifier, such as a public key. In this disclosure, this type of NFT applied to identifying users, may be called a social NFT, identity NFT, identity token, and a social token. In accordance with many embodiments of the invention, an individual's personally identifiable characteristics may be contained, maintained, and managed throughout their lifetime so as to connect new information and/or NFTs to the individual's identity. A social NFT's information may include, but are not limited to, personally identifiable characteristics such as name, place and date of birth, and/or biometrics.

An example social NFT may assign a DNA print to a newborn's identity. In accordance with a number of embodiments of the invention, this first social NFT might then be used in the assignment process of a social security number NFT from the federal government. In some embodiments, the first social NFT may then be associated with some rights and capabilities, which may be expressed in other NFTs. Additional rights and capabilities may also be directly encoded in a policy of the social security number NFT.

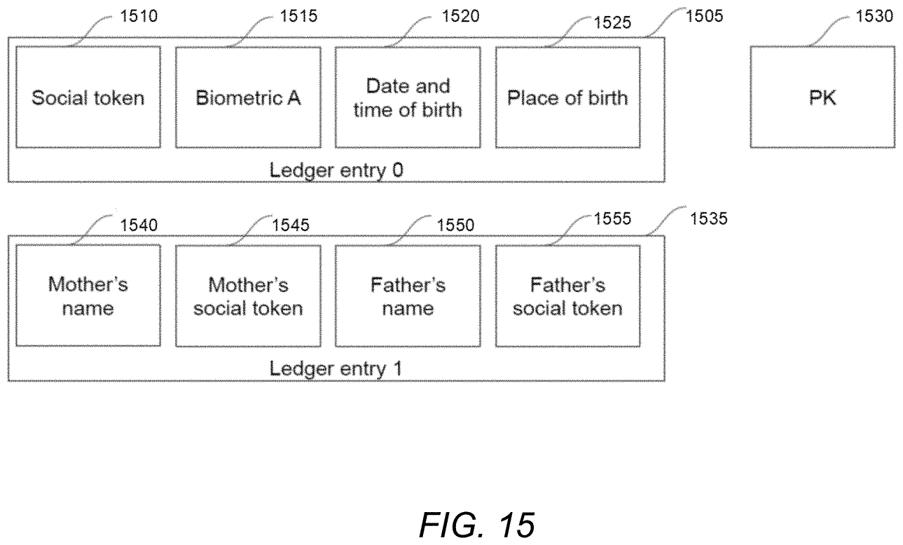

A social NFT may exist on a personalized branch of a centralized and/or decentralized blockchain. Ledger entries related to an individual's social NFT in accordance with several embodiments of the invention are depicted in FIG. 15. Ledger entries of this type may be used to build an immutable identity foundation whereby biometrics, birth and parental information are associated with an NFT. As such, this information may also be protected with encryption using a private key 1530. The initial entry in a ledger, “ledger entry 0” 1505, may represent a social token 1510 assignment to an individual with a biometric “A” 1515. In this embodiment, the biometric may include but is not limited to a footprint, a DNA print, and a fingerprint. The greater record may also include the individual's date and time of birth 1520 and place of birth 1525. A subsequent ledger entry 1 1535 may append parental information including but not limited to mothers' name 1540, mother's social token 1545, father's name 1550, and father's social token 1555.

In a number of embodiments, the various components that make up a social NFT may vary from situation to situation. In a number of embodiments, biometrics and/or parental information may be unavailable in a given situation and/or period of time. Other information including, but not limited to, race, gender, and governmental number assignments such as social security numbers, may be desirable to include in the ledger. In a blockchain, future NFT creation may create a life-long ledger record of an individual's public and private activities. In accordance with some embodiments, the record may be associated with information including, but not limited to, identity, purchases, health and medical records, access NFTs, family records such as future offspring, marriages, familial history, photographs, videos, tax filings, and/or patent filings. The management and/or maintenance of an individual's biometrics throughout the individual's life may be immutably connected to the first social NFT given the use of a decentralized blockchain ledger.

In some embodiments, a certifying third party may generate an NFT associated with certain rights upon the occurrence of a specific event. In one such embodiment, the DMV may be the certifying party and generate an NFT associated with the right to drive a car upon issuing a traditional driver's license. In another embodiment, the certifying third party may be a bank that verifies a person's identity papers and generates an NFT in response to a successful verification. In a third embodiment, the certifying party may be a car manufacturer, who generates an NFT and associates it with the purchase and/or lease of a car.

In many embodiments, a rule may specify what types of policies the certifying party may associate with the NFT. Additionally, a non-certified entity may also generate an NFT and assert its validity. This may require putting up some form of security. In one example, security may come in the form of a conditional payment associated with the NFT generated by the non-certified entity. In this case, the conditional payment may be exchangeable for funds if abuse can be detected by a bounty hunter and/or some alternate entity. Non-certified entities may also relate to a publicly accessible reputation record describing the non-certified entity's reputability.

Anchored NFTs may additionally be applied to automatic enforcement of programming rules in resource transfers. NFTs of this type may be referred to as promise NFTs. A promise NFT may include an agreement expressed in a machine-readable form and/or in a human-accessible form. In a number of embodiments, the machine-readable and human-readable elements can be generated one from the other. In some embodiments, an agreement in a machine-readable form may include, but is not limited to, a policy and/or an executable script. In some embodiments, an agreement in a human-readable form may include, but is not limited to, a text and/or voice-based statement of the promise.

In some embodiments, regardless of whether the machine-readable and human-readable elements are generated from each other, one can be verified based on the other. Smart contracts including both machine-readable statements and human-accessible statements may also be used outside the implementation of promise NFTs. Moreover, promise NFTs may be used outside actions taken by individual NFTs and/or NFT-owners. In some embodiments, promise NFTs may relate to general conditions, and may be used as part of a marketplace.

In one such example, horse betting may be performed through generating a first promise NFT that offers a payment of $10 if a horse does not win. Payment may occur under the condition that the first promise NFT is matched with a second promise NFT that causes a transfer of funds to a public key specified with the first promise NFT if horse X wins.

A promise NFT may be associated with actions that cause the execution of a policy and/or rule indicated by the promise NFT. In some embodiments of the invention, a promise of paying a charity may be associated with the sharing of an NFT. In this embodiment, the associated promise NFT may identify a situation that satisfies the rule associated with the promise NFT, thereby causing the transfer of funds when the condition is satisfied (as described above). One method of implementation may be embedding in and/or associating a conditional payment with the promise NFT. A conditional payment NFT may induce a contract causing the transfer of funds by performing a match. In some such methods, the match may be between the promise NFT and inputs that identify that the conditions are satisfied, where said input can take the form of another NFT. In a number of embodiments, one or more NFTs may also relate to investment opportunities.

For example, a first NFT may represent a deed to a first building, and a second NFT a deed to a second building. Moreover, the deed represented by the first NFT may indicate that a first party owns the first property. The deed represented by the second NFT may indicate that a second party owns the second property. A third NFT may represent one or more valuations of the first building. The third NFT may in turn be associated with a fourth NFT that may represent credentials of a party performing such a valuation. A fifth NFT may represent one or more valuations of the second building. A sixth may represent the credentials of one of the parties performing a valuation. The fourth and sixth NFTs may be associated with one or more insurance policies, asserting that if the parties performing the valuation are mistaken beyond a specified error tolerance, then the insurer would pay up to a specified amount.

A seventh NFT may then represent a contract that relates to the planned acquisition of the second building by the first party, from the second party, at a specified price. The seventh NFT may make the contract conditional provided a sufficient investment and/or verification by a third party. A third party may evaluate the contract of the seventh NFT, and determine whether the terms are reasonable. After the evaluation, the third party may then verify the other NFTs to ensure that the terms stated in the contract of the seventh NFT agree. If the third party determines that the contract exceeds a threshold in terms of value to risk, as assessed in the seventh NFT, then executable elements of the seventh NFT may cause transfers of funds to an escrow party specified in the contract of the sixth NFT.

Alternatively, the first party may initiate the commitment of funds, conditional on the remaining funds being raised within a specified time interval. The commitment of funds may occur through posting the commitment to a ledger. Committing funds may produce smart contracts that are conditional on other events, namely the payments needed to complete the real estate transaction. The smart contract also may have one or more additional conditions associated with it. For example, an additional condition may be the reversal of the payment if, after a specified amount of time, the other funds have not been raised. Another condition may be related to the satisfactory completion of an inspection and/or additional valuation.

NFTs may also be used to assert ownership of virtual property. Virtual property in this instance may include, but is not limited to, rights associated with an NFT, rights associated with patents, and rights associated with pending patents. In a number of embodiments, the entities involved in property ownership may be engaged in fractional ownership. In some such embodiments, two parties may wish to purchase an expensive work of digital artwork represented by an NFT. The parties can enter into smart contracts to fund and purchase valuable works. After a purchase, an additional NFT may represent each party's contribution to the purchase and equivalent fractional share of ownership.

Another type of NFTs that may relate to anchored NFTs may be called “relative NFTs.” This may refer to NFTs that relate two or more NFTs to each other. Relative NFTs associated with social NFTs may include digital signatures that is verified using a public key of a specific social NFT. In some embodiments, an example of a relative NFT may be an assertion of presence in a specific location, by a person corresponding to the social NFT. This type of relative NFT may also be referred to as a location NFT and a presence NFT. Conversely, a signature verified using a public key embedded in a location NFT may be used as proof that an entity sensed by the location NFT is present. Relative NFTs are derived from other NFTs, namely those they relate to, and therefore may also be referred to as derived NFTs. An anchored NFT may tie to another NFT, which may make it both anchored and relative. An example of such may be called pseudonym NFTs.

Pseudonym NFTs may be a kind of relative NFT acting as a pseudonym identifier associated with a given social NFT. In some embodiments, pseudonym NFTs may, after a limited time and/or a limited number of transactions, be replaced by a newly derived NFTs expressing new pseudonym identifiers. This may disassociate users from a series of recorded events, each one of which may be associated with different pseudonym identifiers. A pseudonym NFT may include an identifier that is accessible to biometric verification NFTs. Biometric verification NFTs may be associated with a TEE and/or DRM which is associated with one or more biometric sensors. Pseudonym NFTs may be output by social NFTs and/or pseudonym NFTs.

Inheritance NFTs may be another form of relative NFTs, that transfers rights associated with a first NFT to a second NFT. For example, computers, represented by an anchored NFT that is related to a physical entity (the hardware), may have access rights to WiFi networks. When computers are replaced with newer models, users may want to maintain all old relationships, for the new computer. For example, users may want to retain WiFi hotspots. For this to be facilitated, a new computer can be represented by an inheritance NFT, inheriting rights from the anchored NFT related to the old computer. An inheritance NFT may acquire some or all pre-existing rights associated with the NFT of the old computer, and associate those with the NFT associated with the new computer.

More generally, multiple inheritance NFTs can be used to selectively transfer rights associated with one NFT to one or more NFTs, where such NFTs may correspond to users, devices, and/or other entities, when such assignments of rights are applicable. Inheritance NFTs can also be used to transfer property. One way to implement the transfer of property can be to create digital signatures using private keys. These private keys may be associated with NFTs associated with the rights. In accordance with a number of embodiments, transfer information may include the assignment of included rights, under what conditions the transfer may happen, and to what NFT(s) the transfer may happen. In this transfer, the assigned NFTs may be represented by identifies unique to these, such as public keys. The digital signature and message may then be in the form of an inheritance NFT, or part of an inheritance NFT. As rights are assigned, they may be transferred away from previous owners to new owners through respective NFTs. Access to financial resources is one such example.

However, sometimes rights may be assigned to new parties without taking the same rights away from the party (i.e., NFT) from which the rights come. One example of this may be the right to listen to a song, when a license to the song is sold by the artist to consumers. However, if the seller sells exclusive rights, this causes the seller not to have the rights anymore.

In accordance with many embodiments of the invention, multiple alternative NFT configurations may be implemented. One classification of NFT may be an employee NFT or employee token. Employee NFTs may be used by entities including, but not limited to, business employees, students, and organization members. Employee NFTs may operate in a manner analogous to key card photo identifications. In a number of embodiments, employee NFTs may reference information including, but not limited to, company information, employee identity information and/or individual identity NFTs.

Additionally, employee NFTs may include associated access NFT information including but not limited to, what portions of a building employees may access, and what computer system employees may utilize. In several embodiments, employee NFTs may incorporate their owner's biometrics, such as a face image. In a number of embodiments, employee NFTs may operate as a form of promise NFT. In some embodiments, employee NFT may include policies or rules of employing organization. In a number of embodiments, the employee NFT may reference a collection of other NFTs.

Another type of NFT may be referred to as the promotional NFT or promotional token. Promotional NFTs may be used to provide verification that promoters provide promotion winners with promised goods. In some embodiments, promotional NFTs may operate through decentralized applications for which access restricted to those using an identity NFT. The use of a smart contract with a promotional NFT may be used to allow for a verifiable release of winnings. These winnings may include, but are not limited to, cryptocurrency, money, and gift card NFTs useful to purchase specified goods. Smart contracts used alongside promotional NFTs may be constructed for winners selected through random number generation.

Another type of NFT may be called the script NFT or script token. Script tokens may incorporate script elements including, but not limited to, story scripts, plotlines, scene details, image elements, avatar models, sound profiles, and voice data for avatars. Script tokens may also utilize rules and policies that describe how script elements are combined. Script tokens may also include rights holder information, including but not limited to, licensing and copyright information. Executable elements of script tokens may include instructions for how to process inputs; how to configure other elements associated with the script tokens; and how to process information from other tokens used in combination with script tokens.

Script tokens may be applied to generate presentations of information. In accordance with some embodiments, these presentations may be developed on devices including but not limited to traditional computers, mobile computers, and virtual reality display devices. Script tokens may be used to provide the content for game avatars, digital assistant avatars, and/or instructor avatars. Script tokens may include audio-visual information describing how input text is presented, along with the input text that provides the material to be presented. It may also include what may be thought of as the personality of the avatar, including how the avatar may react to various types of input from an associated user.

In some embodiments, script NFTs may be applied to govern behavior within an organization. For example, this may be done through digital signatures asserting the provenance of the scripts. Script NFTs may also, in full and/or in part, be generated by freelancers. For example, a text script related to a movie, an interactive experience, a tutorial, and/or other material, may be created by an individual content creator. This information may then be combined with a voice model or avatar model created by an established content producer. The information may then be combined with a background created by additional parties. Various content producers can generate parts of the content, allowing for large-scale content collaboration.

Features of other NFTs can be incorporated in a new NFT using techniques related to inheritance NFTs, and/or by making references to other NFTs. As script NFTs may consist of multiple elements, creators with special skills related to one particular element may generate and combine elements. This may be used to democratize not only the writing of storylines for content, but also outsourcing for content production. For each such element, an identifier establishing the origin or provenance of the element may be included. Policy elements can also be incorporated that identify the conditions under which a given script element may be used. Conditions may be related to, but are not limited to execution environments, trusts, licenses, logging, financial terms for use, and various requirements for the script NFTs. Requirements may concern, but are not limited to, what other types of elements the given element are compatible with, what is allowed to be combined with according the terms of service, and/or local copyright laws that must be obeyed.

Evaluation units may be used with various NFT classifications to collect information on their use. Evaluation units may take a graph representing subsets of existing NFTs and make inferences from the observed graph component. From this, valuable insights into NFT value may be derived. For example, evaluation units may be used to identify NFTs whose popularity is increasing or waning. In that context, popularity may be expressed as, but not limited to, the number of derivations of the NFT that are made; the number of renderings, executions or other uses are made; and the total revenue that is generated to one or more parties based on renderings, executions or other uses.

Evaluation units may make their determination through specific windows of time and/or specific collections of end-users associated with the consumption of NFT data in the NFTs. Evaluation units may limit assessments to specific NFTs (e.g. script NFTs). This may be applied to identify NFTs that are likely to be of interest to various users. In addition, the system may use rule-based approaches to identify NFTs of importance, wherein importance may be ascribed to, but is not limited to, the origination of the NFTs, the use of the NFTs, the velocity of content creation of identified clusters or classes, the actions taken by consumers of NFT, including reuse of NFTs, the lack of reuse of NFTs, and the increased or decreased use of NFTs in selected social networks.

Evaluations may be repurposed through recommendation mechanisms for individual content consumers and/or as content originators. Another example may address the identification of potential combination opportunities, by allowing ranking based on compatibility. Accordingly, content creators such as artists, musicians and programmers can identify how to make their content more desirable to intended target groups.

The generation of evaluations can be supported by methods including, but not limited to machine learning (ML) methods, artificial intelligence (AI) methods, and/or statistical methods. Anomaly detection methods developed to identify fraud can be repurposed to identify outliers. This can be done to flag abuse risks or to improve the evaluation effort.

Multiple competing evaluation units can make competing predictions using alternative and proprietary algorithms. Thus, different evaluation units may be created to identify different types of events to different types of subscribers, monetizing their insights related to the data they access.

In a number of embodiments, evaluation units may be a form of NFTs that derive insights from massive amounts of input data. Input data may correspond, but is not limited to the graph component being analyzed. Such NFTs may be referred to as evaluation unit NFTs.

The minting of NFTs may associate rights with first owners and/or with an optional one or more policies and protection modes. An example policy and/or protection mode directed to financial information may express royalty requirements. An example policy and/or protection mode directed to non-financial requirements may express restrictions on access and/or reproduction. An example policy directed to data collection may express listings of user information that may be collected and disseminated to other participants of the NFT platform.

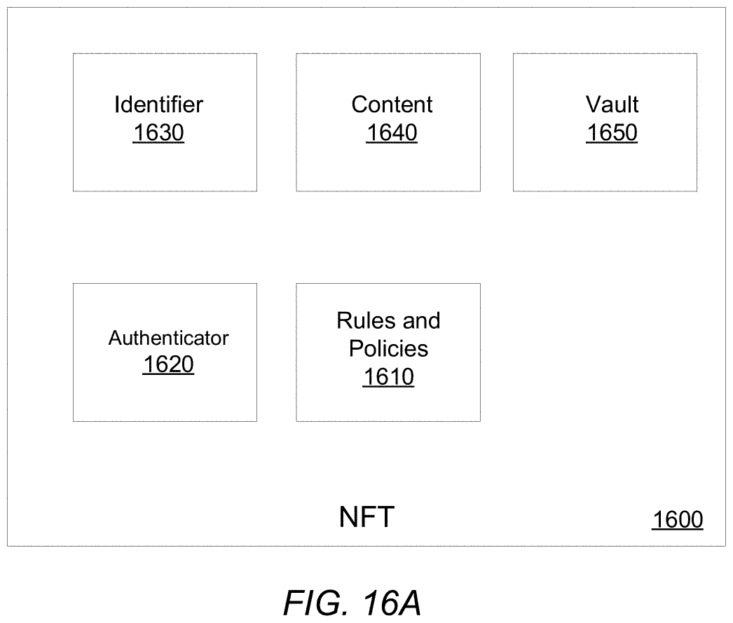

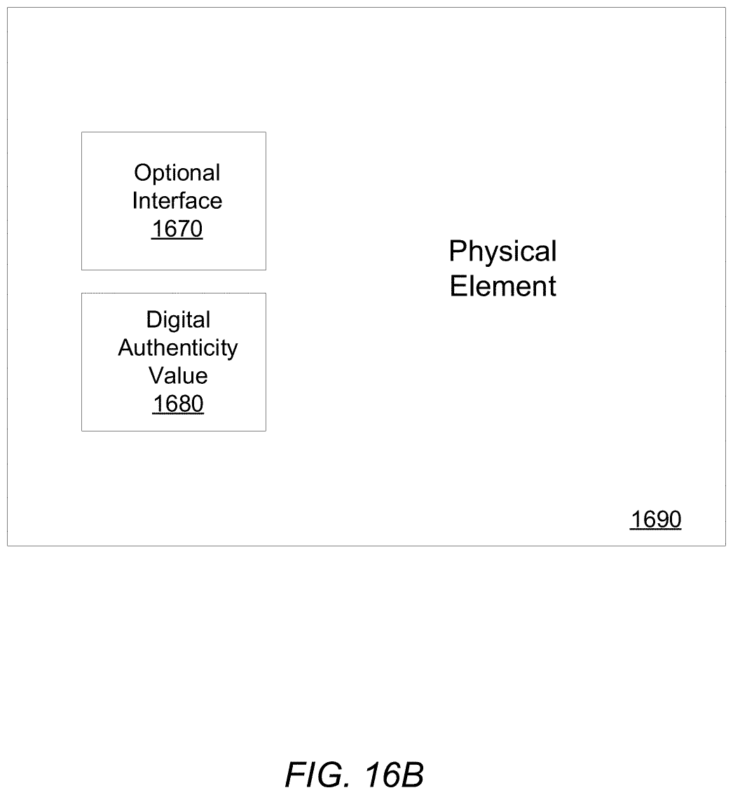

An example NFT which may be associated with specific content in accordance with several embodiments of the invention is illustrated in FIG. 16A. In some embodiments, an NFT 1600 may utilize a vault 1650, which may control access to external data storage areas. Methods of controlling access may include, but are not limited to, user credential information 1350. In accordance with a number of embodiments of the invention, control access may be managed through encrypting content 1640. As such, NFTs 1600 can incorporate content 1640, which may be encrypted, not encrypted, yet otherwise accessible, or encrypted in part. In accordance with some embodiments, an NFT 1600 may be associated with one or more content 1640 elements, which may be contained in or referenced by the NFT. A content 1640 element may include, but is not limited to, an image, an audio file, a script, a biometric user identifier, and/or data derived from an alternative source. An example alternative source may be a hash of biometric information). An NFT 1600 may also include an authenticator 1620 capable of affirming that specific NFTs are valid.

In accordance with many embodiments of the invention, NFTs may include a number of rules and policies 1610. Rules and policies 1610 may include, but are not limited to access rights information 1340. In some embodiments, rules and policies 1610 may also state terms of usage, royalty requirements, and/or transfer restrictions. An NFT 1600 may also include an identifier 1630 to affirm ownership status. In accordance with many embodiments of the invention, ownership status may be expressed by linking the identifier 1630 to an address associated with a blockchain entry.

In accordance with a number of embodiments of the invention, NFTs may represent static creative content. NFTs may also be representative of dynamic creative content, which changes over time. In accordance with many examples of the invention, the content associated with an NFT may be a digital content element.

One example of a digital content element in accordance with some embodiments may be a set of five images of a mouse. In this example, the first image may be an image of the mouse being alive. The second may be an image of the mouse eating poison. The third may be an image of the mouse not feeling well. The fourth image may be of the mouse, dead. The fifth image may be of a decaying mouse.

The user credential information 1350 of an NFT may associate each image to an identity, such as of the artist. In accordance with a number of embodiments of the invention, NFT digital content can correspond to transitions from one representation (e.g., an image of the mouse, being alive) to another representation (e.g., of the mouse eating poison). In this disclosure, digital content transitioning from one representation to another may be referred to as a state change and/or an evolution. In a number of embodiments, an evolution may be triggered by the artist, by an event associated with the owner of the artwork, randomly, and/or by an external event.

When NFTs representing digital content are acquired in accordance with some embodiments of the invention, they may also be associated with the transfer of corresponding physical artwork, and/or the rights to said artwork. The first ownership records for NFTs may correspond to when the NFT was minted, at which time its ownership can be assigned to the content creator. Additionally, in the case of “lazy” minting, rights may be directly assigned to a buyer.

In some embodiments, as a piece of digital content evolves, it may also change its representation. The change in NFTs may also send a signal to an owner after it has evolved. In doing so, a signal may indicate that the owner has the right to acquire the physical content corresponding to the new state of the digital content. Under an earlier example, buying a live mouse artwork, as an NFT, may also carry the corresponding painting, and/or the rights to it. A physical embodiment of an artwork that corresponds to that same NFT may also be able to replace the physical artwork when the digital content of the NFT evolves. For example, should the live mouse artwork NFT change states to a decaying mouse, an exchange may be performed of the corresponding painting for a painting of a decaying mouse.

The validity of one of the elements, such as the physical element, can be governed by conditions related to an item with which it is associated. For example, a physical painting may have a digital authenticity value that attests to the identity of the content creator associated with the physical painting.

An example of a physical element 1690 corresponding to an NFT, in accordance with some embodiments of the invention is illustrated in FIG. 16B. A physical element 1690 may be a physical artwork including, but not limited to, a drawing, a statue, and/or another physical representation of art. In a number of embodiments, physical representations of the content (which may correspond to a series of paintings) may each be embedded with a digital authenticity value (or a validator value) value. In accordance with many embodiments of the invention, a digital authenticity value (DAV) 1680 may be therefore be associated with a physical element 1690 and a digital element. A digital authenticity value may be a value that includes an identifier and a digital signature on the identifier. In some embodiments the identifier may specify information related to the creation of the content. This information may include the name of the artist, the identifier 1630 of the digital element corresponding to the physical content, a serial number, information such as when it was created, and/or a reference to a database in which sales data for the content is maintained. A digital signature element affirming the physical element may be made by the content creator and/or by an authority associating the content with the content creator.

In some embodiments, the digital authenticity value 1680 of the physical element 1690 can be expressed using a visible representation. The visible representation may be an optional physical interface 1670 taken from a group including, but not limited to, a barcode and a quick response (QR) code encoding the digital authenticity value. In some embodiments, the encoded value may also be represented in an authenticity database. Moreover, the physical interface 1670 may be physically associated with the physical element. One example of such may be a QR tag being glued to or printed on the back of a canvas. In some embodiments of the invention, the physical interface 1670 may be possible to physically disassociate from the physical item it is attached to. However, if a DAV 1680 is used to express authenticity of two or more physical items, the authenticity database may detect and block a new entry during the registration of the second of the two physical items. For example, if a very believable forgery is made of a painting the forged painting may not be considered authentic without the QR code associated with the digital element.

In a number of embodiments, the verification of the validity of a physical item, such as a piece of artwork, may be determined by scanning the DAV. In some embodiments, scanning the DAV may be used to determine whether ownership has already been assigned. Using techniques like this, each physical item can be associated with a control that prevents forgeries to be registered as legitimate, and therefore, makes them not valid. In the context of a content creator receiving a physical element from an owner, the content creator can deregister the physical element 1690 by causing its representation to be erased from the authenticity database used to track ownership. Alternatively, in the case of an immutable blockchain record, the ownership blockchain may be appended with new information. Additionally, in instances where the owner returns a physical element, such as a painting, to a content creator in order for the content creator to replace it with an “evolved” version, the owner may be required to transfer the ownership of the initial physical element to the content creator, and/or place the physical element in a stage of being evolved.

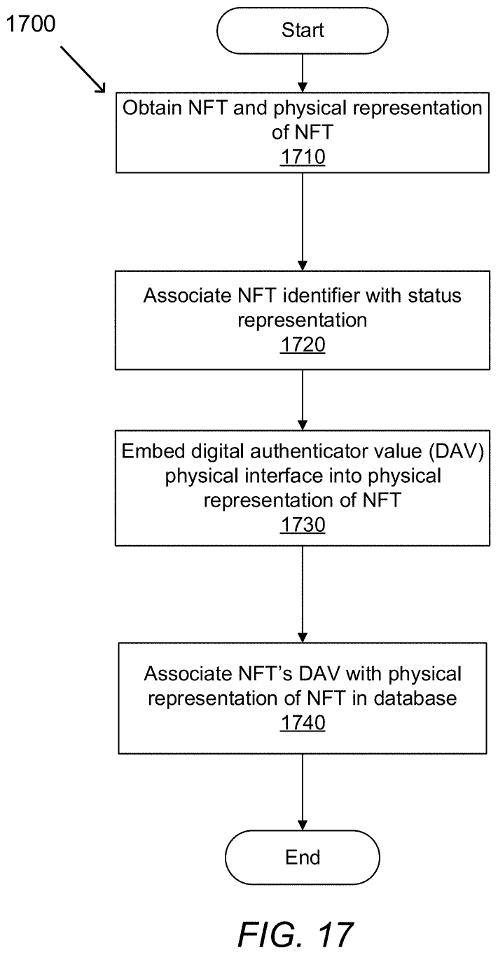

An example of a process for connecting an NFT digital element to physical content in accordance with some embodiments of the invention is illustrated in FIG. 17. Process 1700 may obtain (1710) an NFT and a physical representation of the NFT in connection with an NFT transaction. Under the earlier example, this may be a painting of a living mouse and an NFT of a living mouse. By virtue of establishing ownership of the NFT, the process 1700 may associate (1720) an NFT identifier with a status representation of the NFT. The NFT identifier may specify attributes including, but not limited to, the creator of the mouse painting and NFT (“Artist”), the blockchain the NFT is on (“NFT-Chain”), and an identifying value for the digital element (“no. 0001”). Meanwhile, the status representation may clarify the present state of the NFT (“alive mouse”). Process 1700 may also embed (1730) a DAV physical interface into the physical representation of the NFT. In a number of embodiments of the invention, this may be done by implanting a QR code into the back of the mouse painting. In affirming the connection between the NFT and painting, Process 1700 can associate (1740) the NFT's DAV with the physical representation of the NFT in a database. In some embodiments, the association can be performed through making note of the transaction and clarifying that it encapsulates both the mouse painting and the mouse NFT.

While specific processes are described above with reference to FIGS. 15-17, NFTs can be implemented in any of a number of different ways to enable as appropriate to the requirements of specific applications in accordance with various embodiments of the invention. Additionally, the specific manner in which NFTs can be utilized within NFT platforms in accordance with various embodiments of the invention is largely dependent upon the requirements of a given application.

### Partitioned Address Spaces in a Single Blockchain Wallet

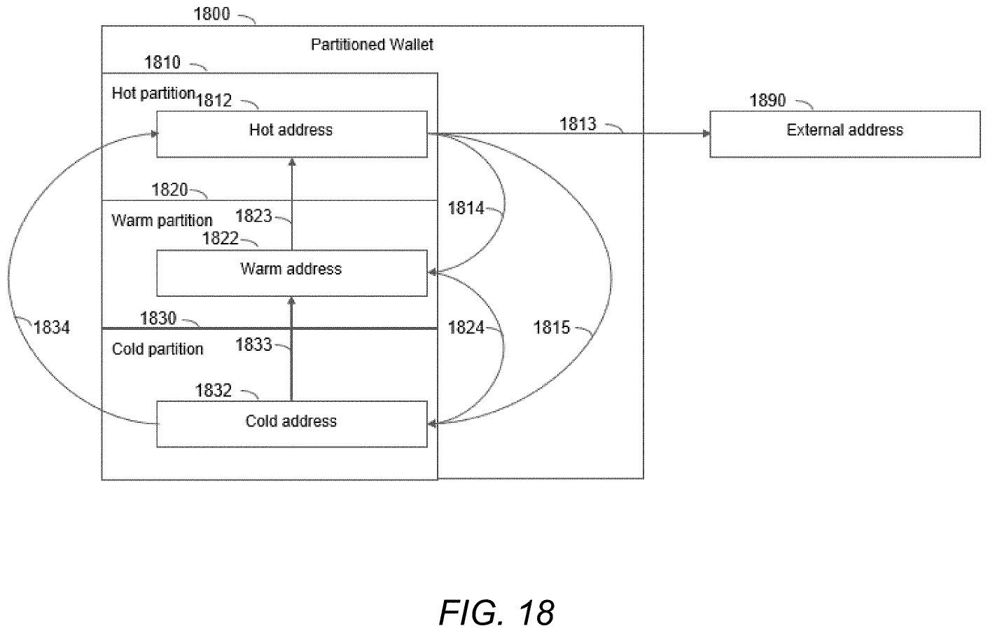

In several embodiments, a wallet can be a partitioned wallet. An example partitioned wallet is conceptually illustrated in FIG. 18. A partitioned wallet 1800 can include three partitions: a hot partition 1810, a warm partition 1820, and/or a cold partition 1830.

The hot partition 1810 can include a hot address 1812. The partitioned wallet 1800 can permit a plurality of transaction types from hot addresses. The partitioned wallet 1800 can permit the hot address 1812 to perform a first transaction 1813 to an external address 1890. The external address 1890 can be outside of the hot partition 1810 and/or outside of the partitioned wallet 1800. The partitioned wallet 1800 can permit the hot address 1812 to perform a second transaction 1814 to a warm address 1822 within the warm partition 1820. The partitioned wallet 1800 can permit the hot address 1812 to perform a third transaction 1815 to a cold address 1832 within the cold partition 1830.

The warm partition 1820 can include the warm address 1822. The partitioned wallet 1800 can permit a plurality of transaction types from the warm address 1822. The partitioned wallet 1800 can permit the warm address 1822 to perform a fourth transaction 1823 to the hot address 1812 within the hot partition 1810. The partitioned wallet 1800 can permit the warm address 1822 to perform a fifth transaction 1824 to the cold address 1832 within the cold partition 1830.

The cold partition 1830 can include a cold address 1832. In some embodiments, a partitioned wallet (e.g., 1800) can be configured to permit only one single cold partition transaction (e.g., 1833) from the cold address (e.g., 1832) to an address in the warm partition (e.g., 1820). In several embodiments, a partitioned wallet (e.g., 1800) can be configured to permit a second single cold partition transaction (e.g., 1834) from a cold address (e.g. 1832) to a hot address (e.g., 1812). The second single cold partition transaction (e.g., 1834) in many embodiments, can require further verification from a partitioned wallet owner and/or can be subject to further restrictions. Further restrictions and/or verifications can include two-factor authentication, a time delay between receiving and acting on the second single cold partition transaction (e.g., 1834), and/or a limit to the number of transactions permitted within a predetermined period of time.

In various embodiments, many types of addresses can be implemented. Various types of address can have combinations of permissions and/or restrictions indicated through a selection of permissions and/or restrictions. The selection, in some embodiment, can be performed automatically by a wallet. The selection can be performed using a set of category labels, and/or on an individual case-by-case basis through selection by a user when each address is created.

In some blockchains it can be impossible to refuse the receiving of digital assets. In some embodiments, a corresponding blockchain wallet as described herein can include a feature by which the blockchain wallet detects that an address has received assets can transfer those assets to another address. In several embodiments, when a “frozen” address has received assets, a wallet can automatically transfer those assets to a currently active “cold” address and/or create a new “cold” address specifically for receiving the asset transfer. A “frozen” address can correspond to a “cold address” that has previously been used to send a transaction. In some embodiments, a wallet can automatically make a transfer from a receiving wallet to a second receiving wallet, this can include generating and submitting relevant transfer transaction information to a blockchain independently of any direct action from a user. In several embodiments, a blockchain wallet can alert a user of the received assets, and/or can offer a user a choice of transferring the assets or keeping them in the “frozen” address.

The use of partitioning, can be used in a variety of embodiments for a variety of reasons. As described above, in some embodiments, a partitioned wallet can limit the extent to which various wallets transact (e.g., to protect resources against theft, including phishing). In several embodiments, a partitioned wallet can be used to enable access control mechanisms to limit the use of content (e.g., a parent limiting the use of content by a child's wallet). In accordance with various embodiments of the invention, a parent user can enable, using a parent user wallet, a child user to access a token (e.g., an NFT and/or a crypto coin) from the child's wallet, and/or can associate ownership rights with the child's wallet. In many embodiments, patent control can be performed while retaining ownership rights in the parent wallet by placing the shared assets in a logical wallet that is accessible from both the child wallet and the parent wallet. A logical wallet can be one that corresponds to a pair of private and public key values that are held both by the parent wallet and the child wallet. In this way, both the parent wallet and the can have enabled access and/or associated ownership rights with assets in a logical wallet.

While specific processes and/or systems for a partitioned wallet are described above, any of a variety of processes and/or systems can be utilized for a partitioned wallet as appropriate to the requirements of specific applications. In certain embodiments, steps may be executed or performed in any order or sequence not limited to the order and sequence shown and described. In a number of embodiments, some of the above steps may be executed or performed substantially simultaneously where appropriate or in parallel to reduce latency and processing times. In some embodiments, one or more of the above steps may be omitted. Although the above embodiments of the invention are described in reference to a partitioned wallet, the techniques disclosed herein may be used in any type of cryptographic systems. The techniques disclosed herein may be used within any of the rich media systems, permissioned blockchains, distributed ledgers, wallets, partitioned wallets, partitioned address spaces, wallets with modular rights managements, gamification of move content, mobile wallet resource control, methods doe distinguishing between different types of digital signature requests, blockchain wallets for adding identifying data to transactions, and/or automated wallet and transaction control as described herein.

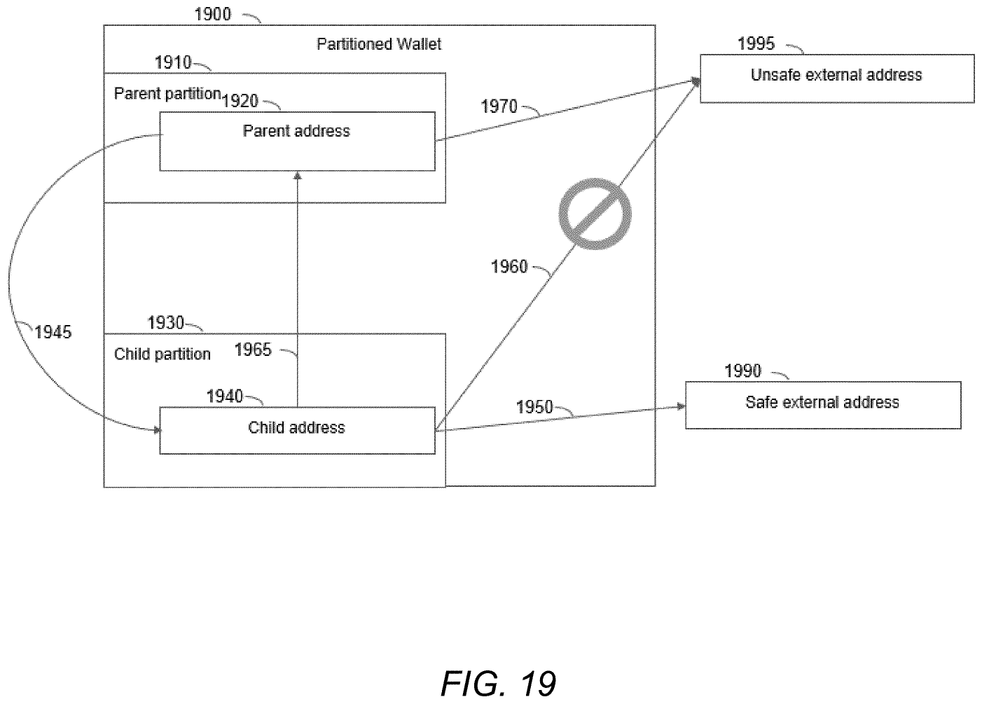

In some embodiments, a child partition can be blocked from accessing external addresses. An example partitioned wallet with a parent partition and a child partition is conceptually illustrated in FIG. 19. A partitioned wallet (1900) can be used by a first address (e.g., a parent and/or guardian, the parent partition) to protect a second address's assets (e.g., a child, the child partition). The partitioned wallet (1900) can include a parent partition (1910) and a child partition (1930). The parent partition (1910) can include a parent address (1920). The child partition may include a child address (1940).

A parent user can submit a transaction 1945 transferring assets from the parent address 1920 to the child address 1940. The child can submit transactions. The transactions submitted by the child can relate to transferred assets. In some embodiments, transactions submitted can be required to be considered safe. In several embodiments, considered safe transactions can include transactions made to addresses and/or smart contracts on an allow list and/or not on a deny list. A transaction 1950 can transfer assets to a safe external address 1990 can be permitted when made by the child without parental supervision. A transaction 1960 transferring assets to an unsafe external address 1995 can be blocked by the partitioned wallet 1900. The child user can submit a transaction 1965 including assets and a request to transfer them to the unsafe address 1995. The parent partition and/or user can determine if the transaction 1965 is safe and/or can complete the transaction 1965 via transaction 1970 on behalf of the child partition and/or user. In various embodiments, the partitioned wallet can grant permission to a child address to transact directly with unsafe external addresses on a case-by-case basis, in response to a notification, in general, and/or in other ways.

Some embodiments can use hierarchically determined wallets to produce addresses corresponding to the different categories (e.g., as discussed herein) through a modification and interpretation of the BIP0032 standard.

In some wallets (e.g., wallets using BIP 0032 and/or a similar standard), given a master key m, an account i, an index j, and a key index k, those wallets can produce a derivation string m/i/j/k. In various embodiments, the index j is used for external (j=0) keychains and/or internal (j=1) keychains. That is, j=0 can be for the generation of new public addresses, and j=1 can be for change addresses and/or other addresses that do not need to be communicated with the outside world (e.g., outside of the wallet). Nevertheless, in several embodiments there can be no recommendation that internal keychains should not subsequently be used as “hot” addresses. In several embodiments, an index j can be used to indicate the role of an address under consideration. In accordance with some embodiments of the invention, j=0 can indicate a “hot” address, j=1 can indicate a “warm” address, and j=2 can indicate a “cold” address. A wallet can permit and/or deny transactions based on an index of a derivation string. A wallet can present and/or not present user interface options based on the index of the derivation string. In several embodiments, when a user has currently selected an address derived using an index j=0, all transaction options can be presented in the user interface as the address is a “hot” address. When the user has currently selected an address derived using an index j=1, the user interface can present only transaction options corresponding to asset transfers from the address to other addresses in the wallet. When the user has currently selected an address derived using an index j=2, the user interface may only present transaction options corresponding to asset transfers from the address to “cold” or “warm” addresses.

While specific processes and/or systems for a partitioned wallet with a parent partition and a child partition are described above, any of a variety of processes and/or systems can be utilized for a partitioned wallet with a parent partition and a child partition as appropriate to the requirements of specific applications. In certain embodiments, steps may be executed or performed in any order or sequence not limited to the order and sequence shown and described. In a number of embodiments, some of the above steps may be executed or performed substantially simultaneously where appropriate or in parallel to reduce latency and processing times. In some embodiments, one or more of the above steps may be omitted. Although the above embodiments of the invention are described in reference to a partitioned wallet with a parent partition and a child partition, the techniques disclosed herein may be used in any type of cryptographic systems. The techniques disclosed herein may be used within any of the rich media systems, permissioned blockchains, distributed ledgers, wallets, partitioned wallets, partitioned address spaces, wallets with modular rights managements, gamification of move content, mobile wallet resource control, methods doe distinguishing between different types of digital signature requests, blockchain wallets for adding identifying data to transactions, and/or automated wallet and transaction control as described herein.

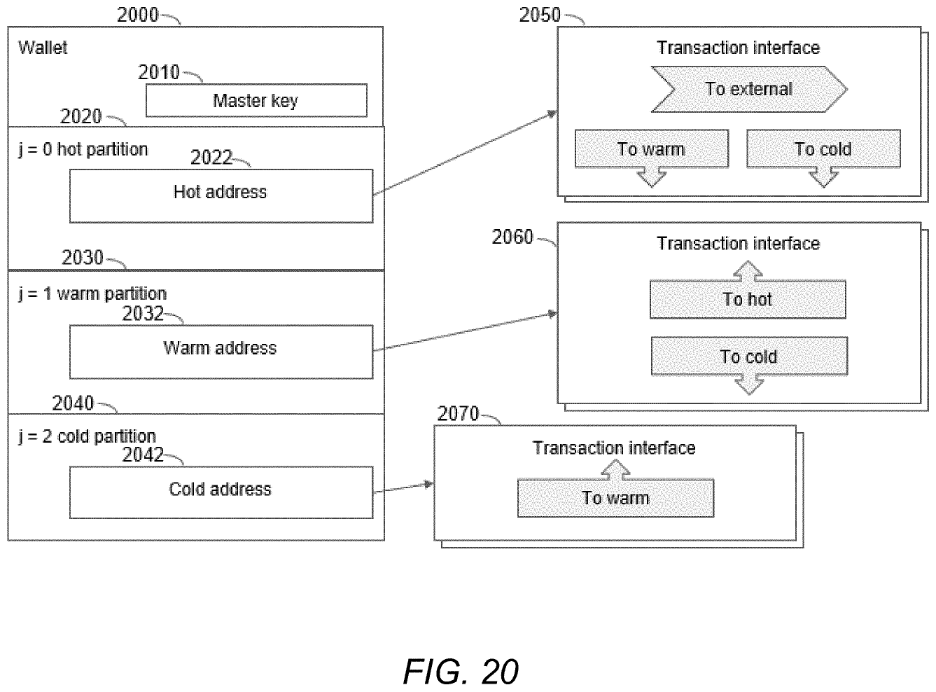

In numerous embodiments, a partitioned wallet can present different interface options depending on a selected address. A partitioned wallet with associated interfaces is conceptually illustrated in FIG. 20. A partitioned wallet 2000 can have associated interfaces 2050, 2060 and 2070. Determining which interface to present can be based on a key derivation scheme (e.g., a BIP 0032 derivation scheme).

The wallet (2000) can derive private and public key pairs using a master key 2010 and an index variable j. In the partitioned wallet 2000 three partitions can be included: a hot address partition 2020 with j=0, a warm address partition 2030 with j=1, and a cold address partition 2040 with j=2. Those skilled in the art will appreciate in the light of this disclosure that any number of partitions may be instantiated as described herein.

When a user selects a hot address 2022 from the hot partition 2020 to construct a transaction, a transaction interface 2050 can be presented to the user. In many embodiments, for a hot address, the transaction interface can include user interface objects for external transactions, and user interface objects internal transactions to warm and/or cold addresses. Where internal and external refer to internal to the wallet and external to the wallet respectively.

When a user selects a warm address 2032 from the warm partition 2030 to construct a transaction, a second transaction interface 2060 can be presented to the user. In a number of embodiments, for a warm address, the transaction interface 2060 can include user interface objects for internal transactions to warm and/or cold addresses.

When a user selects a cold address 2042 from the cold partition 2040 to construct a transaction, a third transaction interface 2070 can be presented to the user. In various embodiment, for a cold address, the transaction interface 2070 can include a user interface object for internal transactions to warm addresses only.

In various embodiments, a user can possess two (or more) devices that implement wallets. A user can have a device A and a device B. A user can have associated wallet A and associated wallet B. Device B can be a mobile device, and the associated wallet B can have a greater exposure risk, e.g., to theft, than the wallet (i.e., wallet A) of device A, which can be a desktop computer.

Tokens, in several embodiments, can be assigned to two different addresses (e.g., address A and address B). Wallet A can correspond to both address A and address B (e.g., wallet A can include what address A and address B, whereas wallet B can only have access to tokens associated with address B). In various embodiments, a user of wallet A can make a token accessible to wallet B by reassigning such a token from address A, which is mapped to wallet A but not wallet B, to address B. This can, externally, look like an ownership transfer whereas it is really a matter of a modification of access rights. In accordance with many embodiments of the invention, to avoid the payment of royalties and/or other fees normally associated with ownership transfers, a user can register ownership of both wallet A and B. Wallets A and B can be registered in a public record created using an anchor, as disclosed in co-pending application Ser. No. 63/322,265 titled “Escrowed Wallet and Transaction Tracking Technology” by Markus Jakobsson and filed on Mar. 22, 2022 which is hereby incorporated by reference. In various embodiments, a wallet application working on behalf of a user can automatically generate a new public key/private key for use for each individual token acquisition, and/or can distribute the public and private keys to the wallets with associated access rights. This wallet application can, in some embodiments, reassign access rights without the transfer of ownership from one to another wallet, e.g., by distributing private keys to wallets who should be given access and requesting the removal of private keys from wallets that no longer should have access rights. Removal of access rights can in several embodiments be performed by a digital rights management (DRM) module associated with said wallets.

While specific processes and/or systems for a partitioned wallet with associated interfaces are described above, any of a variety of processes and/or systems can be utilized for a partitioned wallet with associated interfaces as appropriate to the requirements of specific applications. In certain embodiments, steps may be executed or performed in any order or sequence not limited to the order and sequence shown and described. In a number of embodiments, some of the above steps may be executed or performed substantially simultaneously where appropriate or in parallel to reduce latency and processing times. In some embodiments, one or more of the above steps may be omitted. Although the above embodiments of the invention are described in reference to a partitioned wallet with associated interfaces, the techniques disclosed herein may be used in any type of cryptographic systems. The techniques disclosed herein may be used within any of the rich media systems, permissioned blockchains, distributed ledgers, wallets, partitioned wallets, partitioned address spaces, wallets with modular rights managements, gamification of move content, mobile wallet resource control, methods doe distinguishing between different types of digital signature requests, blockchain wallets for adding identifying data to transactions, and/or automated wallet and transaction control as described herein.

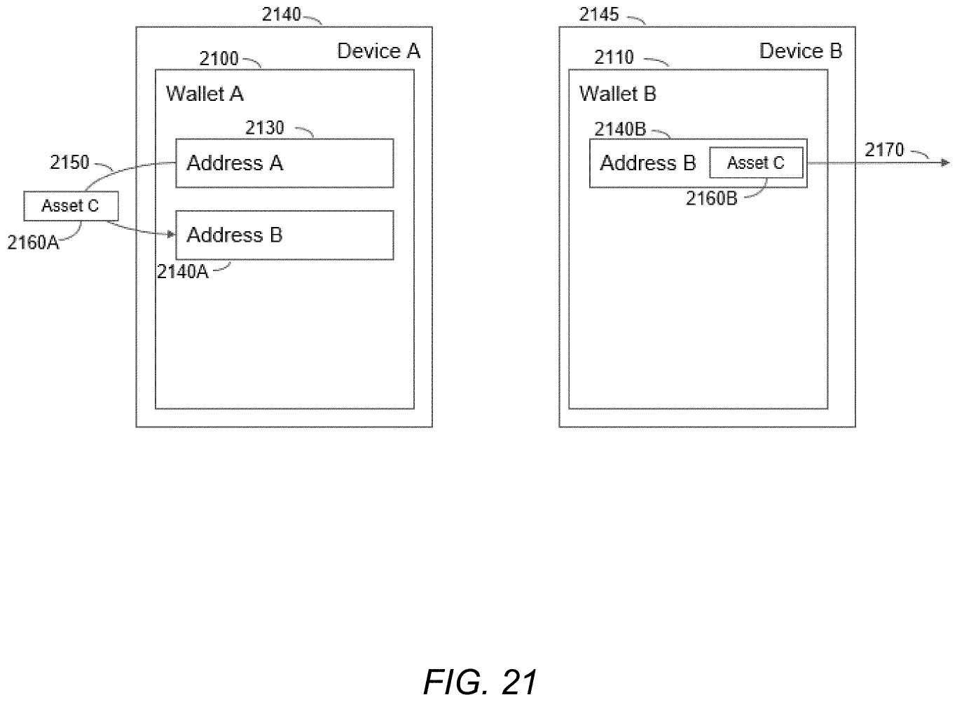

In some embodiments, wallets can be linked. An example of two linked wallets is conceptually illustrated in FIG. 21. A device A 2140 can include a wallet A 2100. The wallet A 2100 can include an address A 2130 and an address B 2140A. A device B 2145 can include a wallet B 2110. The second wallet B 2110 can include second address B 2140B, the private key and public key of which are the same as those of the first address B 2140A. In various embodiments, 2140A and 2140B can be included separate wallets on separate devices, and can both control the same assets on a blockchain.

In accordance with some embodiments of the invention, an asset C 2160A can be transferred from address A 2130 to address B 2140A by a user utilizing device A 2140 and wallet A 2100, as shown by transaction 2150. A second user (e.g., a user the same as the first user, a different user from the first user) can use device B 2105 and wallet B 2110 to construct a transaction 2170 signed by the private key of address B 2160B to transfer asset C 2160B, which is the same asset as asset C 2160A. On transmitting transaction 2170 to the blockchain, asset C 2160A, 2160B can be transferred out from address B 2140A, 2140B.

While specific processes and/or systems for two linked wallets are described above, any of a variety of processes and/or systems can be utilized for two linked wallets as appropriate to the requirements of specific applications. In certain embodiments, steps may be executed or performed in any order or sequence not limited to the order and sequence shown and described. In a number of embodiments, some of the above steps may be executed or performed substantially simultaneously where appropriate or in parallel to reduce latency and processing times. In some embodiments, one or more of the above steps may be omitted. Although the above embodiments of the invention are described in reference to two linked wallets, the techniques disclosed herein may be used in any type of cryptographic systems. The techniques disclosed herein may be used within any of the rich media systems, permissioned blockchains, distributed ledgers, wallets, partitioned wallets, partitioned address spaces, wallets with modular rights managements, gamification of move content, mobile wallet resource control, methods doe distinguishing between different types of digital signature requests, blockchain wallets for adding identifying data to transactions, and/or automated wallet and transaction control as described herein.

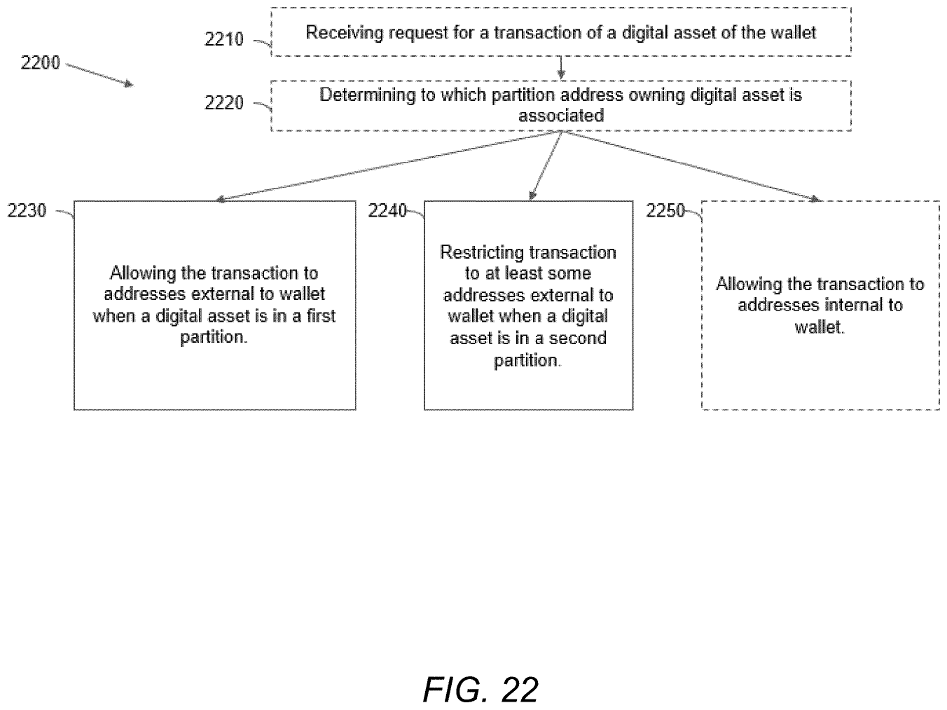

In various embodiments, partitioned wallets can perform processes for handling transactions. An example process that can be performed by a partitioned wallet is conceptually illustrated in FIG. 22. A process 2200 can be performed by a partitioned wallet for handling a transaction of a digital asset of the wallet. The digital asset can be one owned by the wallet meaning the digital asset can be one owned by an address of the wallet. The wallet can include at least two partitions. Partitions can each include one or more addresses owning different digital assets. Each partition can be associated with different transaction requirements, such that different transactions can be allowed with regard to digital assets being owned by addresses in different partitions.

A process 2200 can optionally include receiving (2210) a request for a transaction of a digital asset of the wallet. The process 2200 can optionally determine (2220) to which partition of the wallet the address owning the digital asset is associated. The process 2200 determine can allow (2230) the transaction, and/or restrict (2240) the transaction of the digital asset based on in which partition the address owning the digital asset is included. Allowing the transaction can include allowing the transaction to addresses external to wallet. The transaction can be allowed with regard to digital asset when the digital assets are owned by an address of a wallet in a first partition. In some embodiments, the first partition has less restrictions that a second partition with respect to transferring a digital asset. The process 2200 can optionally allow (2250) an internal transaction (e.g., the transaction with regard to the digital asset is made between an address included in the second partition only to an address included in another partition of the wallet). In several embodiments, restricting a transaction can include restricting a transaction to a set of at least some addresses external to wallet with regard to digital asset when owned by address of wallet included in a second partition of the wallet. In accordance with many embodiments of the invention, processes can allow internal transactions only for those transactions including digital assets that are owned by an address in in the second partition only to address in another partition of wallet.

In several embodiments, a wallet can have a number (e.g., 2, 3, or another number) of partitions. Partitions can be hot partitions, warm partitions and/or cold partitions. In some embodiments, a transaction of a digital asset owned by an address included in a cold partition can be limited to only being allowed when a destination address of the transaction is included in the warm partition.

In many embodiments, a process can allow a transaction to addresses external to the wallet with regard to the digital asset when the digital asset is owned by an address of the wallet included in a first partition (e.g., a hot partition). In several embodiments, a process can restricting the transaction to at least some addresses (e.g., a set of addresses) external to the wallet with regard to the digital asset when the digital asset is owned by an address of the wallet included in a second partition (e.g., a warm partition). In some embodiments, a transaction with regards to a digital asset A can be allowed to any external address without any restriction when the digital asset is owned by an address included in the first partition (e.g., a hot partition), but the transaction may be restricted to specific (external and/or internal) addresses when the digital asset is owned by an address included in the second partition (e.g., a warm partition and/or a cold partition).

While specific processes and/or systems for a process that can be performed by a partitioned wallet. are described above, any of a variety of processes and/or systems can be utilized for a process that can be performed by a partitioned wallet as appropriate to the requirements of specific applications. In certain embodiments, steps may be executed or performed in any order or sequence not limited to the order and sequence shown and described. In a number of embodiments, some of the above steps may be executed or performed substantially simultaneously where appropriate or in parallel to reduce latency and processing times. In some embodiments, one or more of the above steps may be omitted. Although the above embodiments of the invention are described in reference to a process that can be performed by a partitioned wallet, the techniques disclosed herein may be used in any type of cryptographic systems. The techniques disclosed herein may be used within any of the rich media systems, permissioned blockchains, distributed ledgers, wallets, partitioned wallets, partitioned address spaces, wallets with modular rights managements, gamification of move content, mobile wallet resource control, methods doe distinguishing between different types of digital signature requests, blockchain wallets for adding identifying data to transactions, and/or automated wallet and transaction control as described herein.

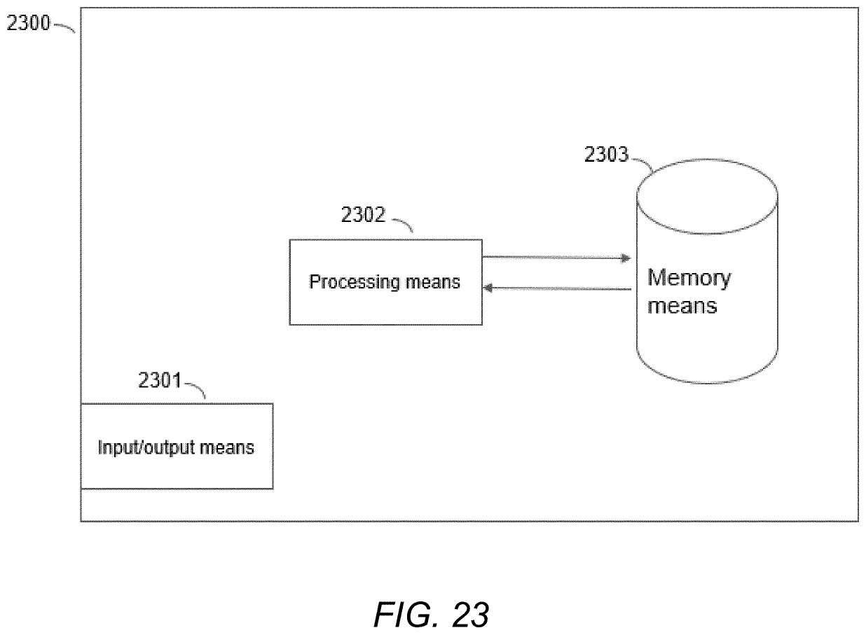

A wallet can include a computer system in a number of embodiments. A block diagram of an example computer system is conceptually illustrated in FIG. 23. A computer system 2300 can be configured for operating a wallet. A computer system can be configured for handling a transaction of a digital asset owned in a wallet. Owning the digital asset can include the digital asset being owned by an address of a wallet. Such a wallet can include at least two partitions, wherein each partition can be associated with different transaction requirements. The computer system 2300 can include input/output means 2301 by means of which the computer system 2300 can receive information, transmit and/or provide information to other units, devices and/or entities. The computer system 2300 can include processing means 2302 and/or memory means 2303. Memory means can include instructions. Instructions can be when executed by the processing means 2302 to perform processes as described herein. In various embodiments a wallet can include executable code that can be executed by a processor and/or stored in memory.

While specific processes and/or systems for a computer system are described above, any of a variety of processes and/or systems can be utilized for a computer system as appropriate to the requirements of specific applications. In certain embodiments, steps may be executed or performed in any order or sequence not limited to the order and sequence shown and described. In a number of embodiments, some of the above steps may be executed or performed substantially simultaneously where appropriate or in parallel to reduce latency and processing times. In some embodiments, one or more of the above steps may be omitted. Although the above embodiments of the invention are described in reference to a computer system, the techniques disclosed herein may be used in any type of cryptographic systems. The techniques disclosed herein may be used within any of the rich media systems, permissioned blockchains, distributed ledgers, wallets, partitioned wallets, partitioned address spaces, wallets with modular rights managements, gamification of move content, mobile wallet resource control, methods doe distinguishing between different types of digital signature requests, blockchain wallets for adding identifying data to transactions, and/or automated wallet and transaction control as described herein.

Wallet with Modular Rights Management

One aspect of this disclosure is an approach to partition a wallet into one portion that stores content and references to content, and one portion that stores scripts and policies that govern the use of the content. The scripts and policies, which we will refer to collectively as rights management objects, interact with the content and content references, potentially via an interface that determines what information, including content and data about content usage, that the rights management objects are allowed to access. The rights management objects may also communicate with external resources to request or report data.

In one embodiment, a first rights management object is created by and maintained by a first entity, such as an employer of the user to whom the wallet belongs or is used by. The first rights management object may control how certain objects are transmitted to other parties, and may control the use of some actions such as copying of data from controlled objects or apply rules associated with controlled objects to any objects generated from controlled objects; such derived objects may also be labeled controlled objects. The first rights management object may be constrained in terms of what information about the user it may access, e.g., it may not be allowed to know about any content that does not correspond to an object that it controls. The interface may monitor what accesses this rights management object can perform, based on policies associated with the first rights management object. We will refer to those policies as the privacy policy associated with the first rights management object.

A second rights management object is created by and maintained by a content delivery organization that wishes to incorporate commercials, or advertisements, into delivered content, where such commercials may be selected or configured based on the preferences and actions of the user of the wallet, but where the user does not want the second rights management object to have free access to all usage information. Instead, the interface may monitor and curate requests for information, e.g., by receiving requests from the second rights management object and responding to these requests if and only if the requests comply with the privacy policy. The requests may be in the form of templates. Templates are disclosed in co-pending application titled “Usage Statistics Tokens and Applications” by Markus Jakobsson and Stephen C. Gerber. Templates may specify one or more criteria, or a formula or script related to such criteria, wherein the interface may determine whether a template is acceptable given the permitted privacy policy associated with the second rights management object, and if so, generate a response, which may correspond to the result of evaluating the script or formula, or the answer matching the stated criteria. In some example use cases, the response to the second rights management object, from the interface, is a selection of a commercial content item or type thereof, where the selected content item will be incorporated with the content to be delivered. The content to be delivered may be stored by the wallet, and may be modified according to the selection, whether by the interface or an associated module, or by the second rights management object. The second rights management object may request to transmit data to an external party, via the interface. This data may be transmitted by the second rights management object to the interface, whether in plaintext or ciphertext, or it may be indicated by the second rights management object to the interface which will then generate the data message to be transmitted to the external party. This data message may, for example, indicate what commercial content was selected; whether the user of the wallet viewed the commercial content, and if so, whether a conversion action was observed. One example conversion action is a click on a hyperlink associated with the commercial content. A second conversion action may comprise initiating a cryptocurrency transaction in relation to the commercial content. In some example use cases, the second rights management object may communicate with the external party without using the interface as an intermediary.

In a third example situation, a third rights management object is a user-installed object with free read-only access to all information in the content partition of the wallet. The third rights management object determines recommendations for the user, e.g., if some content appears not to be aligned with the user's interests and could be sold at a good profit, or whether some much-liked content, as determined by the number of accesses to it by the wallet user, is related to a new content element that the user may wish to acquire. The third rights management token may not have any rights to transmit data to external parties, but may receive feeds of data from one or more such external parties, potentially using the interface as a delivery intermediary, and use the received feeds along with the information about content and usage thereof to determine potential user interests and perform recommendations to the user.

A fourth example rights management object may be created or endorsed by one or more content providers, such as movie studios, This fourth rights management object is associated with a decryption key that may be specific to the wallet on which the object is installed, and where this key is used to decrypt content such as movies after verifying, e.g., using an associated digital signature, that the content has not been manipulated, and after verifying that the content has been licensed to be used by the wallet or an associated rendering device. The verification that a content item has been rendered may be associated with the content, in the form of a digital signature; it may also be determined by accessing an online database that indicates what content has been licensed to what wallets. There is a wide variety of ways in which this verification can be accomplished, as will be understood by a skilled artisan. The fourth rights management object may also verify that the content has not already been used in a way that precludes further use. For example, in one embodiment, content is associated with a counter that indicates how many times the content has been viewed. There may be a maximum number of permitted times, or a specified window of time during which is permissible. Data such as the counter or the time window may be stored in the wallet, e.g., in a space associated with the fourth rights management object. If a user possesses two or more wallets that store the content, such counters and time window data may be synchronized between the wallets, e.g, using the techniques for maintaining state between wallet clones, disclosed in co-pending application titled “Crypto Wallet Improvement Technology” by Markus Jakobsson and Keir Finlow-Bates. Such a synchronization approach works even for settings where the two or more wallets are not generated from the same seed, but wherein one wallet is granted access to content by another wallet; in such cases, the usage data (such as counters and time window data) may be stored in cloud storage locations accessible by all wallets, where such locations are indicated in the configuration data stored in each of the associated wallets.

In other embodiments, the fourth rights management object may verify content use through data stored in association with a non-fungible token owned by an address in the wallet. The token may contain data fields or may point to a separate smart contract that contains data fields storing counters or permitted time periods for usage. Through this, remaining access rights may be independently transferable from one address to another, or even from one wallet to another. Similarly, consistency of state between different instances of the same wallet on different computers may be maintained by each wallet querying the record of the non-fungible token on the blockchain.

The technology disclosed herein is modular as it enables multiple rights management objects to be used by the same wallet, each one of which may be associated with different privacy policies that govern what information the objects may access and in what manners the objects may communicate with the outside world, e.g., in the form of requests transmitted to external parties. The interface entity manages at least some of the control of such accesses, and applies policies to requests in a manner that may differ between the different objects, corresponding to the privacy policies associated with these objects.

A user may install an object on his or her wallet, and may be presented with an explanation of the requested or available privacy policies associated with the object. One object may be associated with multiple selectable privacy policies, where the selection made by the user impacts the functionality of the object. The entity managing an object may indicate the different possible privacy policies, e.g., in the form of one or more matrices of requested types of access. Such available policies may be automatically screened and filtered by the wallet during the installation process, e.g., to only present to the user such options that are aligned with previously made user declarations of the acceptable boundaries for objects. A user may be informed that one or more options were removed, and optionally enabled to override this filtering action to make the options available for selection. Some privacy policies may not be allowed in some jurisdictions, and accordingly, the filtering may not be overridden in such cases. Some objects may state requirements related to the access of other objects. For example, in the case of the first rights management object described above, this may demand that the content that it controls, which may be files related to the enterprise, may not be observed by any other object, or that only some facts may be observed, such as the number of content elements, etc. If a user installs an object such as the first rights management object, this may apply limitations to other objects, whether already installed or not.

In some embodiments, an object may comprise code, either interpreted by the wallet or precompiled and subsequently run, which is downloaded by the wallet and stored. The code may be retrieved from one or more of: a remote computer server, from an InterPlanetary File System file (IPFS), or from a blockchain. In other embodiments, an object may comprise configuration parameters and data, with code for instantiating the object already present in the wallet prior to the decision to install the object. The code for instantiating the object may be present in the wallet from the start, or may be downloaded after the wallet is installed but before configuration parameters and data are downloaded and applied. The configuration parameters and data may be static, that is, determined once and remaining constant thereafter, or they may be dynamically determined using information provided by the wallet during the request for the configuration parameters and data. The information provided by the wallet may comprise some or all of the history of actions taken by the wallet, transactions submitted through the wallet, or data provided to the wallet by the user, time period in which the wallet was active, and/or the presence of other objects in the wallet. In a further enhancement of the embodiment, the wallet may provide the information to a smart contract on a blockchain, with the smart contract issuing a non-fungible token (NFT) to an address in the wallet, with metadata associated with the NFT reflecting the information provided to by the wallet, either directly or processed.

In an example that is provided as an illustrative but non-limiting implementation, a wallet may gather evidence that a user has purchased a subscription to a first series of a television show, and has viewed all episodes of the series one time. This evidence may be submitted by the wallet to a smart contract on a blockchain in a transaction. The smart contract may then subsequently mint an NFT to an address in the wallet. The wallet may then download DRM code from a server on the basis of providing evidence of ownership of the NFT, with the DRM code allowing the wallet to obtain or generate a dynamically generated decryption key for locating, streaming and decrypting supplementary video material concerning the television show without payment, and with the supplementary video material containing advertisements relevant to the user.

A user may also uninstall objects. For example, the user may uninstall the second rights management object. This may then render some content not possible to render, e.g., movies that are governed by the second rights management object. The user may be informed of this, and asked whether such content should be purged or kept. If the user keeps the content, it may in some instances be allowed to be used using other objects, or based on a payment of a fee that enables unlocking of the content for viewing without the need for commercial content to be incorporated. In some situations, if a user uninstalls an object that automatically causes associated files, such as content controlled by that object, to be erased or transmitted to a third party and then erased. This is helpful, for example, in the context of a user uninstalling the first rights management object. Since the presence of that object protects the controlled files associated with the object, the removal of the object requires the removal of the associated controlled files, optionally after backing them up with a service indicated by the first rights management object. In situations where an object has imposed requirements or rules associated with other objects, these requirements or rules may be removed as the object is uninstalled. Some objects may not be possible to uninstall. For example, one object may be placed in a wallet to track the actions of a criminal that is allowed an early release, as a condition of the early release, and be present for a preset amount of time. Such objects may track the wallet, and therefore also indirectly its owner, and determine the type of content the wallet stores to verify that it is acceptable according to a set of policies. It may also inhibit some uses of the wallet, e.g., a wallet may be prevented from communicating with minors using social networking, but may be allowed to communicate with adult social networking users. An object of this type may not be uninstallable.

In some embodiments an object may provide rights to a resource that are limited to a specific number of instances of the wallet at one time, for example, a user may have instances of a wallet and an object installed on three devices, but the object may only allow one device at a time to access a movie file. In one possible embodiment of the present disclosure, each wallet may write state data concerning the use or absence of use of the resource to a central server (see the co-pending application, “Crypto Wallet Improvement Technology” by Markus Jakobsson and Keir Finlow-Bates), and objects in other wallets may retrieve this state data to determine whether access to the resource is permitted or prohibited. In another possible embodiment of the present disclosure, each instance of the wallet may generate a specific address for just that instance, and an NFT may need to be owned by that address for access to the resource to be permitted.

An entity associated with the wallet, such as the interface, may associate one or more access rights with one or more users of a wallet, where the rights may include rights to read content, write or modify content, and to install or uninstall. A wallet may have multiple users, each with potentially different access rights, where the user may be identified based on a password-based login, a biometric login, or a profile selection the users makes. The profile selection may determine what content is visible to the user, and what objects are active, as different users may be associated with different objects, and may even be associated with the same objects but with different privacy policies. Different users may also be associated with different collections of visible content, where such collections may be overlapping but do not have to be. Information about what is visible to what users and what objects are active for different users may be stored in one or more user profiles.

A user may clone a wallet using the methods disclosed in co-pending application titled “Crypto Wallet Improvement Technology” by Markus Jakobsson and Keir Finlow-Bates. The configuration data disclosed therein may comprise information identifying the installed objects, the associated privacy policies, and the access rights may be stored in one or more configuration files, which may be hosted on cloud servers or storage devices maintained by the users or organizations associated with the user. The configuration files may also comprise user profile data.

Different DRM objects may have contradictory requirements. For example, a first DRM object may require that a wallet belonging to a user of a first jurisdiction must report at least some transactions to an entity associated with this first jurisdiction. At the same time, a second DRM object may require that wallet of a user of a second jurisdiction, or of a user with a specific employment, must not store some pre-specified types of data pertaining to user transactions, e.g., to be compliant with a privacy policy specific to the second jurisdiction or employment. A user who satisfies both of these rules, e.g., belongs to the first jurisdiction and has the specific employment, would cause a conflict. This may be resolved by the interface having one or more prioritization rules that are evaluated when there is a conflict between the requirements of two or more DRM objects. A resolution may comprise determining whether to follow the directions of a first DRM object, a second DRM object, or neither, in situations where complying with both would cause a contradiction. Or, one possible approach to resolution may comprise the wallet identifying whether a conflict may be resolved through separating content and/or DRM objects into multiple wallets, in which case an interface may give a user an option of moving content to an existing wallet or partially cloning content into a new wallet. It may be that such conflicts are averted through checks at the time of installing new content or DRM objects in a wallet, for instance through automatically detecting that a conflict would be triggered, in which case an interface may provide a warning or prevent a user from installing a new object. Or, a DRM object may include the capability for a user and/or a wallet to trigger a report of a conflict to one or more third parties, such as the entities issuing the conflicting DRM objects. This can allow for entities to be informed of the presence and nature of conflicts, and potentially also for entities to negotiate outside the wallet environment to resolve a conflict. Entities may use human and/or automated means to resolve such conflicts. For instance, an entity may employ one or more machine learning classifiers which take as input information about the conflicting DRM objects, the associated content, the wallet and/or user, in order to decide whether and how a standard policy may be overridden. In one variant of this approach, a DRM object may itself include such machine learning classifiers and/or other logic that may be employed to determine whether and how its standard policies may be overridden in the case of a conflict, without the need to consult a third party. An example conflict resolution mechanism is implemented by an ordering of digital rights modules, wherein a DRM module that is higher up in a list is given priority to a DRM module that is lower down in the list. Another example conflict resolution mechanism is notify an external entity, such as a law enforcement related service provider, about the conflict, e.g., what DRM modules disagree, and request a resolution which may be cached by the interface and applied to automatically resolve later occurrences of conflicts involving the same parties. Conflicts may also involve more than two DRM modules, in which case the conflict may be partially resolved by removing a request from the DRM module with lowest priority and then determine whether the remaining requests still result in a conflict, and iterate the partial resolution process if so.

One or more DRM objects may be activated as a user interacts with one or more content elements, or performs other actions that are determined by the wallet. As a DRM object is provided information about an event or element, it may perform some processing on the provided information and generate a request. This request may be sent to the interface, or in some instances, to external third parties. The interface may act as an intermediary in communication with such external third parties, and determine whether to pass on a request from a DRM object or not, based on one or more rules. Those rules may pertain to the privacy policies associated with the requesting DRM object, but may also be related to policies associated with other DRM objects, including contradictory policies. The rules may further be specific to the determined event or content, where notification of the same to the DRM object resulted in the request from the DRM object.

A user can deploy a DRM object to monitor content use, such as limiting access to content, limiting the number of ownership transfers that can be performed in a given time period, to cause an escalation of verification of the user identity under pre-set conditions, and more. The DRM object that a user installs can be configured to monitor and report activity according to pre-set configurations. The recipient of one or more such reports can be a communication account associated with the user installing the DRM object, or another entity that is selected by this user. The recipient of the information may perform a service such as automatically identify expenses and generate an expense report for the wallet owner.

A DRM object may confirm to a third party service that a wallet in which the DRM object is operating is compliant with regulation, and to automatically report transactions required by regulation. The confirmation of compliance may take place when the wallet is used to perform some actions, such as transferring ownership of assets, including coins and NFTs. The DRM object may sign such transactions with a private key associated with the DRM object. The DRM object may also be used to report, e.g., to third parties, when qualifying events take place. One such qualifying event is the transfer, in or out, of crypto currencies exceeding a threshold amount. Another qualifying event may be the transfer, in or out, of crypto currencies, to or from an account that is associated with a blacklist associated with the third party. An example third party is a government organization that oversees money transfers in order to identify money laundry or funding of terrorist organizations. Another qualifying event may be the transfer, in or out, of crypto currencies or digital assets of commercial value to another party for which there is no registration in a know your customer (KYC) database or registry. A further qualifying event may be a repeating pattern of transactions below a qualifying threshold that, in sum, exceed the qualifying threshold, possibly within a certain time period.

In other embodiments, the DRM object may implement the passing on of certain information to the receiving entity in an automated version of the so called “travel rule” (see FinCEN Advisory, ‘Funds “Travel” Regulations: Questions & Answers’, https://www.fincen.gov/sites/default/files/advisory/advissu7.pdf). The DRM object may make a determination that the current wallet owner or receiving entity falls under the auspices of FATF Recommendation 16 (https://www.fatf-gafi.org/media/fatf/documents/recommendations/Updated-Guidance-VA-VASP.pdf). In some embodiments the DRM object may transmit additional metadata with the transaction, comprising some or all of the name of the sending party, identification of the sending party's financial institution if there is one, the physical address of the sending party, and a government issued identification number such as a social security number, a tax identification number, a company number, the name of the recipient, the address of the recipient, and any other specific identifier of the recipient. In another embodiment the DRM object may reject an incoming transaction by, for example, immediately transferring the incoming assets to a holding address inaccessible to the wallet owner for quarantining or further investigation, based on a lack of metadata included with the transaction. In this embodiment, the DRM object may quarantine incoming transactions based on an absence of one or more of the name of the sending party, identification of the sending party's financial institution if there is one, the physical address of the sending party, and a government issued identification number such as a social security number, a tax identification number, a company number, the name of the recipient, the address of the recipient, and any other specific identifier of the recipient.

An example DRM object may perform anomaly analysis related to events observed by the wallet, such as usage of content, transfer of tokens, changes of configurations, etc. One goal could be to detect likely malware attacks. Another goal is to detect theft of the wallet, and successful access to it. A user that is forced under duress to perform unusual actions may result in an anomaly being detected. The DRM object may use machine learning (ML) techniques to detect anomalies in observed events. Such techniques may take into account both properties of the wallet, such as a history of actions, and other properties, such as actions flagged as fraudulent by users of other wallets. Such techniques may rely on machine learning models and/or logic running on a third-party service to check events within a wallet as they occur, or they may rely on machine learning models and/or logic that are deployed to a wallet, for instance within a DRM object itself, and run locally on the same hardware as the wallet. Such techniques may perform simple classification of whether an action is anomalous or not, or they may output richer information such as the category of suspected anomaly and/or the estimated probability that an action is anomalous.

In response to the detection of an anomaly or a suspected anomaly, a security action may be taken. The security action may be to block one or more events from taking place. The security action may be to temporarily halt the operation of the wallet. Another example security action is to encrypt the content of the wallet with a public key for which the associated private key is not stored on the wallet instance on which the detection of the anomaly occurs, but on another associated wallet instance. Yet another example security action is to report an event to a third party, such as a user-designated party, a law enforcement entity, etc. The choice of security action may depend on the category of suspected anomaly and/or the estimated probability that an action is anomalous. The choice of security action may further depend on a sequence of actions and the corresponding history of anomaly detection results. For instance, a single transaction determined by an anomaly detector to have a 20% probability of being fraudulent may not result in a security action, but three such transactions in the span of an hour may result in temporarily halting the operation of the wallet.

A DRM object residing on a first device may communicate with a DRM object on a second device. The first device may implement a wallet, for example, whereas the second device may be a laptop. The second device may not be considered to be as secure as the first device. The first device may be used to initiate a transaction, after which a description of this transaction is authenticated by the DRM object on the first device. It may also be encrypted with a key held by the corresponding DRM object of the second device, which receives the encrypted and authenticated transaction description, decrypts it, verifies the authentication, and then causes information related to the transaction description to be rendered on an output entity, e.g., on a screen, a loudspeaker, or a headset. The output entity may have yet another DRM object, with which the DRM object of the second device can create a secure tunnel over which the data to be rendered is communicated. This tunneling may be a built-in feature associated with the hardware of the second device, or it may be implemented using software. This enables the first device, which is more secure than the second device, to use the second device for purposes of data output, while protecting the transaction data from being replaced, e.g., by malware intending to perform a bait and switch in which the user believes he is approving a first transaction whereas he is really approving a second transaction different from the first transaction. The pairing of DRM objects on different devices can be performed using asymmetric cryptography, e.g., using Diffie-Hellman Key Exchange. The DRM objects can also be installed and paired during times of relative security, e.g., before a user starts transacting on an NFT marketplace, thereby reducing the likely exposure to attacks. Aspects of this are disclosed in co-pending application titled “Cross-Device Digital Rights Management” by Markus Jakobsson.

The interface may be implemented as a software module, e.g., executing on an operating system of the wallet in which it resides. The interface may also be at least in part a dedicated hardware element, such as an ASIC, or stored in ROM, flash memory or EEPROM. The interface may be a routine running in a secure element or in a trusted execution environment, such as TrustZone™. The interface may access content data, and compute a function on the content data, where the function result is provided to one or more DRM module, whether in response to a request from such DRM module, or due to one or more instructions associated with the interface, conditionally causing the transmission of the function result to the DRM module. The content data may comprise a reference to content stored external to the wallet, or to content stored in the wallet. Example content types include but are not limited to: image data, audio data, text data, executable scripts, and data indicating usage of other content. The data indicating usage of other content may comprise browser history data, content access data, data indicating purchase and rental history of content, data indicating access to content, data indicating conversions to advertisements provided to a user of the wallet, and more.

### Figures

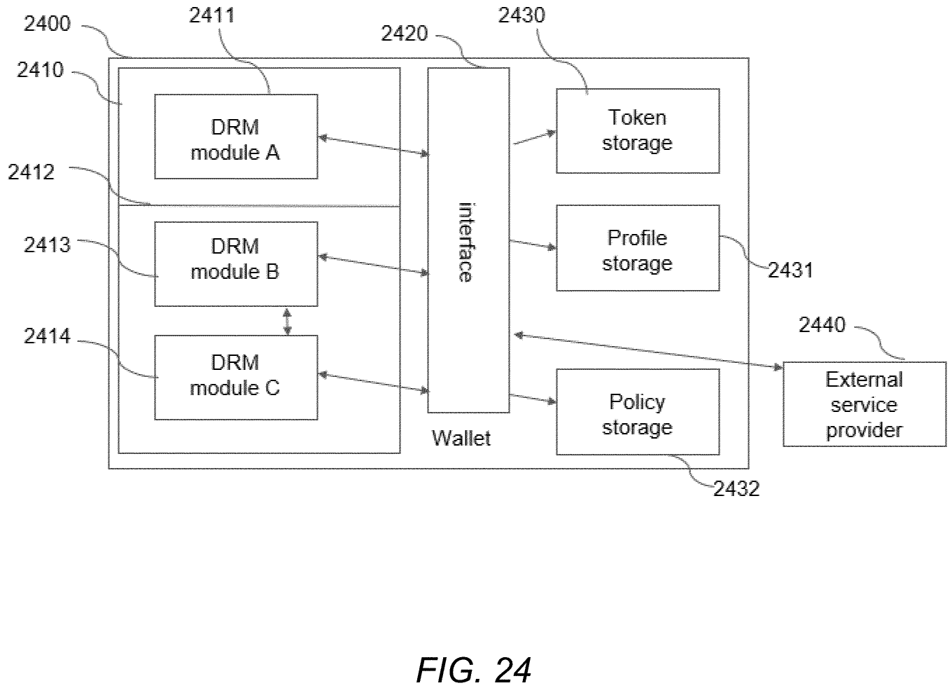

FIG. 24 illustrates wallet 2400 comparing a sandbox area 2410 comprising a first DRM module, referred to as DRM module A 2411, a second DRM module, referred to as DRM module B 2413, and a third DRM module, referred to as DRM module C 2414. DRM module B 2413 and DRM module C 2414 are configured to access each other's storage areas, e.g., DRM module B 2413 may request data kept in or by DRM module C 2414, or DRM module C 2414 may request access to a functionality associated with DRM module B 2413. Neither DRM module B 2413 nor DRM module C 2414 can access DRM module 2411, and vice versa, as indicated by partition 2412. Each of the DRM modules may communicate with interface 2420, e.g., to request read access to elements stored in token storage 2430, which may comprise crypto currencies and/or NFTs. DRM module A 2411 may request access to an NFT stored in token storage 2430 that DRM module B 2413 does not have access rights to, and may not even know exists. The latter corresponds to not having read access even to the directory portion of token storage 2430 that indicates the presence of the NFT. The DRM modules, such as DRM module B 2413, may have read or write access to profile storage 2431, or portions (such as directories) thereof. For example, one directory may comprise browsing data, and another may comprise purchase data. DRM module B 2413 may have full read access to the directory with browsing data, and be allowed to request the computation of a function F stored by interface 2420, where F takes as input content in the directory with purchase data. The function F may, for example, compute the value of all purchases performed in the last 72 hours. DRM module A 2411 may have access to all purchase data that is of a file type that DRM module A 2411 is monitoring, such as mpegs, but no other purchase data. The rules of what accesses are allowed by what DRM modules is stored in policy storage 2432. DRM modules may also request the transmitting of messages, including requests, to external service provider 2440, as well as other external service providers (not shown), according to rules stored in policy storage 2432, and using interface 2420 as a proxy. These services may transmit information to the DRM modules, such as DRM module C 2414, whether in response to a request from DRM module C 2414 or because DRM module C 2414 has subscribed to a notification of a particular type. These transmissions are proxied by interface 2420, which may verify compliance with one or more rules or policies, which may be stored in policy storage 2432. Policy storage 2432 also comprises rules and policy governing how to resolve conflicts between the DRM modules of sandbox area 2410.

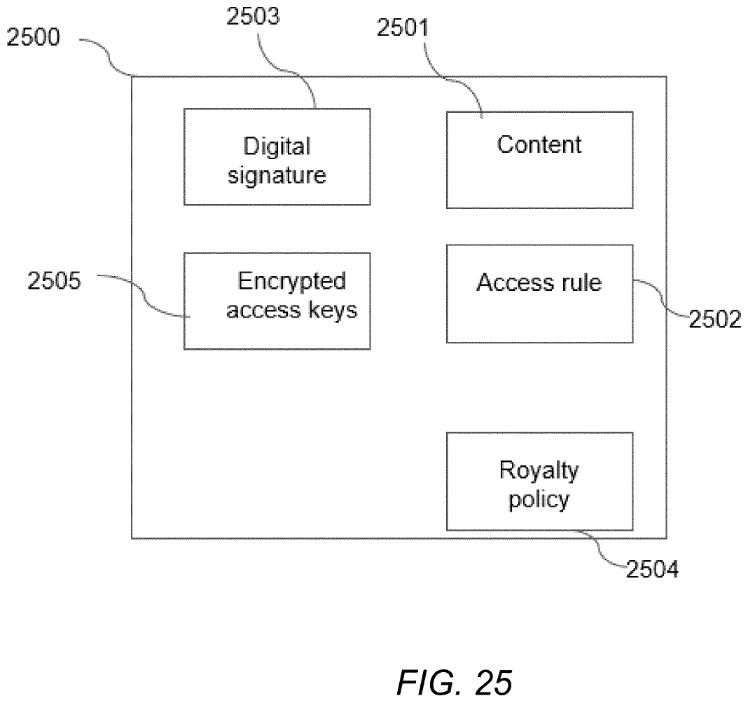

FIG. 25 illustrates an example NFT 2500, comprising a content 2501, which may comprise data encrypted using a key K (not shown), where K is a symmetric key that is encrypted using a public key of a party permitted to access the plaintext data; this encrypted data may be stored as part of encrypted access keys 2505. Content 2501 may also be not encrypted, but accessible, or it may be encrypted in part. Access rule 2502 indicates what software may read content 2501. This may indicate that DRM module A 2411, DRM module B 2413, and DRM module F (not shown, as it is not downloaded in wallet 2400) may access content 2501. Royalty policy 2504 indicates what parties get paid and under what conditions, where a condition may be the transfer of ownership of NFT 2500, the evolution of the NFT 2500, a rental of the NFT 2500, etc. DRM module C 2414 may have access rights to royalty policy 2504 and any event associated with the conditions of this policy. Furthermore, DRM module C 2414 may have the right to communicate with an external service provider 2440 to convey whether a proper royalty was paid when the event indicates it should be. DRM module C 2414 may hold keys that are needed to decrypt content 2501 of NFT 2500, and which it only releases to a buyer's DRM module C 2414 if the royalty is paid. NFT 2500 may also comprise digital signature 2503 that indicates that it is a valid NFT, as well as optionally a classification of the content 2501 of NFT 2500. DRM module B 2412 may determine whether the user of wallet 2400 is allowed to access content of the classification associated with NFT 2500, e.g., to determine what content is allowed to be accessed by a 13 year old person.

### Gamification of Movie Content

The disclosed technology facilitates differential story-telling in which slightly different versions of content are provided to different viewers. For example, a first viewer of a detective story, watching the movie from his home TV, may be provided with a first version in which clues A and B are present, but not clue C. A second viewer of the same detective story may be watching the movie from her laptop, and be provided a second version in which clues A and C are present, but not clue B. The selection of the content version may be performed at random, based on geography, language, time of day, date, or based on known social networking relationships between users such as the first viewer and the second viewer. After the first and the second viewer have both watched the movie, they may still be uncertain of some aspects of the plot, but may be able to discover these by discussing the movie with their friends and determining that they saw slightly different versions. Doing so may lead them to realize that they are, collectively, in possession of clues A, B and C, which together may help resolve the entire plot.

Another aspect of the disclosed technology is a mechanism for generating and distributing clues. Some clues may be provided to viewers in the movie, and others may be provided upon the viewers requesting additional clues. In one example, a first clue may comprise a series of screenshots corresponding to clips representing clues A, B and C. Seeing this first clue, the first viewer may recognize the screenshots corresponding to clues A and B, but not to clue C. The first viewer now knows both what segments he watched may be valuable to others, such as the second viewer, to resolve the entire plot, and he knows what he is missing, namely a clue corresponding to the screenshot taken from clue C. He may contact his friends and ask them whether they recall a scene that looked like the screenshot from the clue C segment. This first clue, which we may refer to as clue D, comprises segments from clues A, B and C. Another clue, such as clue E, may comprise a portion of clue A, or all of it. This clue would not be helpful to the first viewer, who was already given clue A. Yet another clue, such as clue F, may be distinct from clues A, B, C, D and E, but correspond to an outtake or discussion related to clue C. This may be helpful to the first viewer. Clue G may comprise a randomized clue, which the user does not know whether it will be helpful. Some clues, such as clue H, may be user-generated content (UGC). Different clues, such as clues A, B, C, D, E, F, G and H may be encoded in the form of NFTs. Some NFTs may be available for free to viewers of the movie, whereas others may be available at a cost. Different NFTs may have different costs. Some NFTs uses to convey clues may be peelable NFTs, where the content is determined upon detection of a peeling action, and could be based on contextual data such as what version of the movie the user viewed, what version(s) friends of the user viewed, and what other clues, if any, the user has accessed. Peeling is disclosed in co-pending application titled “Non-Fungible Token Peeling” by Markus Jakobsson. A user may resell NFTs with clues in them. In some instances, the disclosure of the clue depends on the time of ownership transfers. For example, if Alice buys an NFT with a clue and resells it within a week of buying it, the associated clue may not be viewable to the buyer Bob until at the end of the week from when Alice bought it. Such triggering of functionality is disclosed in co-pending application titled “Robust Personalization with Applications to NFT Evolution” by Markus Jakobsson. Some NFTs may be intentional mis-direction whereby the issuer intends to further confound or make the game more complex. Other NFTs may include or be comprised of advertisements for the purpose of revenue generation.

In one embodiment, NFTs are utilized to obtain, trade, and track clues. The NFTs may be video clips, audio segments, text, such as a screenplay or text messages between the characters, etc. The NFTs may or may not represent actual content in any of the differential stories. For instance, a given character to character text message may not be visible in any of the various versions of the film; but the text message may appear in an NFT. The scarcity level of the various NFT clues may be tightly controlled in an effort to improve the gamification of the problem and solution, and to maximize revenue to the production company.

In one embodiment an NFT clue may contain a single-use, or limited-use, video clue. Upon viewing, the NFT may be burned, or peeled, such as when an NFT shifts form, in this example a video clue may peel into a collectible of the film or production NFT peeling is disclosed in co-pending application titled “User-Specific Evolution, Spawning and Peeling” by Markus Jakobsson and Perry R. Cook; and in co-pending application titled “Non-Fungible Token Peeling” by Markus Jakobsson. The single- or limited-use video may be digital rights management protected in order to prevent copying and re-use. Additionally, while the embodiment is described as using a video clue, the clue may take many other formats, including text, audio, photographic, etc.

In another embodiment, the movie-related NFTs may be utilized with social media to communicate ideas related to the solution. These NFTs may be trackable for the purposes of marketing to those involved in the interactive nature of the movie, or to reward those, whether individually or as a group, playing the game exceptionally well. The nature and use of NFTs with social media is described in co-pending application titled “Automated Blockchain Based Recommendation Generation, Advertising and Promotion” by Markus Jakobsson and Stephen C. Gerber; co-pending application titled “Mechanisms for Social Media Integration of Non-Fungible Tokens Content” by Markus Jakobsson; co-pending application titled “Intelligent Social Media Content Creation with Feedback Loop” by Ajay Kapur, Rebecca Fiebrink, Markus Jakobsson, and Stephen C. Gerber; and co-pending application titled “Token Interaction using Social Network Communication” by Markus Jakobsson and Stephen C. Gerber.

In one embodiment, NFTs, whether previously issued and peeled, or newly minted, may be utilized to reward viewers as individuals or as teams for solving various challenges related to the produced content. The reward NFTs may be air-dropped to those involved, such as when the rewarder mints or sends an NFT directly to an individual's wallet. In another embodiment, the rewards may be part of a dynamic NFT that takes in specific data and evolves based upon the content. For example, an NFT may be purchased by each of the first 1 million viewers for $1. The NFT may dynamically shift as the individual feeds information into a trigger system, such as an on-chain smart contract or an off-chain contract-triggering daemon that monitors off-chain data, such as a user's social media feed. Dynamic or evolutionary NFTs are disclosed in co-pending application titled “Evolution of Tokenized Artwork” by Ajay Kapur, Markus Jakobsson, and Stephen C. Gerber; and in co-pending application titled “Token Content Unlocking Method” by Markus Jakobsson; and in co-pending application titled “Content Evolution Techniques” by Markus Jakobsson. In the example of 1 million viewers paying $1 per NFT, the successful completion of the challenge may result in the winner or winners earning a share or all of the monies paid. The payment may be performed with the issuance of cryptocurrency to the account or a form of non-fungible token with an inherent intrinsic value.

In one embodiment, a clue can only be purchased, or traded, by or to a user that has watched the associated movie. This avoids hoarding, and also makes the NFTs more valuable in terms of investment, as their purchase is access controlled. In one example use situation, a user who is paying to access a movie, e.g., renting or purchasing a copy, may be granted the right to purchase any related NFTs, or be allowed to buy up to a certain number of these within a limited period of time. In situations where only a limited number of clue NFTs are generated, additional constraints can be added, such as requiring a user to have watched a prequel in order to be given priority to buy clue NFTs for the movie. Some clue NFTs may be more rare than others. Some are randomly generated, e.g., using a post-purchase peeling mechanism, according to a probability distribution, a profile of the buyer, or other input data used to make a selection. In this example, the viewer may be issued an NFT along with the purchase of the video stream, thereby enabling subsequent NFT purchases or issuances. The issuance of NFTs to holders of the purchased video stream NFT may be controlled at a smart contract level, such that the destination wallet must contain both the original NFT purchased and the hint NFT.

In one embodiment, the movie, film, or video content may be streamed or otherwise transmitted with highly diversified pixel to pixel or frame to frame content in order to thwart viewers from capturing and electronically comparing the differences between two versions of the content in an effort to cheat the game or challenge. Additionally, audio manipulation techniques may be utilized to again prevent, or make difficult, automated comparisons. There is a rat race between providers of fake media content and content providers wishing to detect this. The disclosed technology may periodically update the obfuscation mechanisms to use new techniques fake media content providers are using to beat existing detection techniques. Digital Rights Management (DRM) techniques may also be used to render content, whether movie content or clue content, to avoid automated comparisons.

Two or more users may register to watch a movie together, but using different terminals, e.g., each from his or her own home. The system may provide different versions to the different users in a manner that guarantees that the users, together, have a sufficient number of clues. The viewers may be employees of an enterprise, for example, where the employer may indicate what employees should be required to pair with each other to determine combinations of clues necessary to make progress on solving a puzzle. For example, to encourage Alice and Bob to work with each other, a person configuring the system may require that the versions and their associated clues are distributed in a manner that makes it highly desirable for Alice and Bob to discuss the movie, thereby solving a problem. An employer may also indicate general relationships, e.g., between HR and developers, that are desirable, and indicate such constraints to the system that then randomly selects the distribution of versions and clues in a manner that favors collaboration across departments in the manner indicated by the employer. Dating applications may require that users whose personality profiles appear to be complementing each other are given versions and clues that cause a significant benefit for such users to collaborate. The system can also be used to add puzzles into educational material or compliance material in a manner that requires users to collaborate to solve the puzzles, thereby requiring them to discuss the educational or compliance material with each other to solve these puzzles. This helps assure that users do access the material, and helps enforce that they pay attention. Not all users who are registered need to watch the content at the same time, particularly considering that specific versions of the film may be available only during specific time windows.

One aspect of the disclosed technology is the creation of a network graph governing the provision of content versions and clues based on one or more constraints indicated by a configuration. This configuration may be provided by an admin or generated automatically based on one or more rules. One example rule is to cause the pairing up between new employees and old employees; another example rule is to cause the pairing up between users with complementary skills or knowledge, as determined by their positions or self-stated profiles or questionnaires. Here, the pairing up of two or more users corresponds to a providing of versions, clues or both of these according to a pattern that provides such groups with a benefit to solve a problem. For example, in an example situation where there are three clues, referred to as clue A, clue B and clue C, all newcomers to an organization may be given clue A, all old-timers clue B, and clue B may be given to a random subset of users. This causes benefits of collaboration between newcomers and oldtimers.

This disclosure makes use of several terms to identify the game players or viewers of the film, or similar content. Teams of players may be encouraged by the film developer. These teams may take the form of individuals connected by social media and they may be aggregated with the use of decentralized autonomous organizations (DAOs). These DAO players may join one or more DAOs with the intention of winning a challenge and earning a share of winnings. DAOs are typically groups of anonymous individuals, which makes connecting with other players within the DAO on social media more difficult. In one embodiment, a DAO group of individual players may join forces to solve a challenge. To support such an endeavor may require the formation of a social media group to which each player in the DAO would be subscribed, preferably automatically. Techniques for the formation of a decentralized and dedicated social media group are disclosed in co-pending application titled “Token Interaction using Social Network Communication” by Markus Jakobsson and Stephen C. Gerber, along with other co-pending applications described above.

The distribution of content, including movie content and clue content, may be performed at least in part based on the contents of user wallets, where these wallets may store information about accessed content, information about owned content, as well as information about recorded user actions, classifications, and other user information. The selection of what content to provide to what user may also depend on the social network of users, e.g., as indicated by their interaction, their location, potential co-location, and more. This can be done by wallets or by external entities receiving information from wallets in response to requests containing templates, where a template may be seen as a survey for the wallet to complete, e.g., a form. Such surveys are disclosed in co-pending application titled “Token Surveys and Privacy Control Techniques” by Markus Jakobsson and Stephen C. Gerber, and in “Usage Statistics Tokens and Applications” by Markus Jakobsson and Stephen C. Gerber. Thus, the wallets would disclose some facts about their associated users, in a manner that is respectful of user privacy as defined by the associated users having configured their systems; this information would be used to determine content, including clues, to distribute. Some content may be generated in real time based on received responses. The selection of content may be based on knowledge, interests and skills correlated with the information provided by a user, e.g., via his or her wallet. This provision of demographic and other information, by users and their wallets or other representatives, is helpful for content producers wishing to know their audience; know how to best customize content; and know how to best offer add-ons to potentially interested users.

In one embodiment, a viewer is required to collect a specific set of NFTs in a wallet to become a winner. For example, a viewer that has collected a specific 10 of an available 32 NFTs may be declared a winner. In this example, the user may be required to burn or trade away the NFTs that are not considered part of the solution. One or more NFTs, such as the initial viewer entry purchase may be capable of assessing or surveying the contents of the wallet to report or declare the wallet holder a winner. The wallet may be automatically sent a winner NFT and, in some cases, cryptocurrency, fungible, and or non-fungible tokens representing a prize.

Clue NFTs may belong to different functional classes. In some instances, it is apparent to a user, e.g., a buyer of the NFT, what class it belongs to whereas in other cases, this information, or at least some of it, is hidden. Examples of classes comprises: NFTs that can be resold; NTFs that, if resold, has a throttle that limits when the new owner can perform an action, such as rendering content; NFTs that can evolve; NFTs that can be peeled; the action taken in response to a peeling event, including the probability distribution of events; NFTs that can spawn; NFTs that can be viewed by a party other than the owner; NFTs that can be rented out; etc.

Since the revenue from purchases of NFTs, including clue NFTs, may be a significant portion of the revenue stream associated with content creation, it is important to create methods to detect and curb abuse. One such form of abuse is a recording of a clue and the generation, from such a recording of unauthorized clues, which may be offered for free, e.g., on Reddit™ or sold in NFT marketplaces. To limit the risk for this, clues may be personalized, e.g., visually or audio-wise configured to include identifiers, such as with the wallet address of the NFT owner or potentially identifiable information from the rendering device, where different users would receive NFT configured using different identifiers, and where an identifier is associated with a session or a user by the system. If the system later detects recordings of this clue, it may extract the identifier to determine the source of the abuse. Various penalties can be performed, e.g., automatic destruction of NFTs that have been purchased by the user associated with the identifier that is distributed. If a user has already sold such an NFT, it can still be destroyed, which will lead to a reduction of the reputation of the seller of the NFT and make future sales less desirable.

In one embodiment, a user selling a clue NFT may automatically cause the NFT to evolve as it is being opened by the new owner, where the post-evolution NFT may be encoding a new identifier that is not the same as the identifier of the NFT prior to the sale and evolution, but be tied to the new owner's identity. This makes attribution of distribution breaking the terms of service possible, and enables penalties to be leveraged to the users having broken the terms of service.

Another defense mechanism is the use of DRM technology to limit the reproduction of content contained in clue NFTs, and the associated movie content files. DRM technology can be used to limit what actions can be performed, e.g., copying or saving, as disclosed, e.g., in co-pending application titled “Token Creation and Management Structure” by Markus Jakobsson and Stephen C. Gerber.

Clues may in some instances indicate the identities of users with whom the user receiving the clue should collaborate to solve a problem, or other actions or events that the user should take. One example action is to go to an indicated location, which enables integration with augmented reality, mixed reality and virtual reality games. One event may be to meet a user, perform a purchase, find a physical clue in a nearby location, etc. Clues may involve a user traveling to a filmed scene location in either virtual reality or in-person, with or without augmented reality support, in an effort to identify additional clues from the scene. Users able to travel to a given scene location may be permitted to encapsulate their findings in an NFT for sale to other users attempting to solve the challenge; but who are unable to travel to the filmed location. A user's location can be determined by a GPS sensor associated with the user's wallet, or by the user photographing or scanning something at the location, e.g., a QR code, to prove presence; or a combination of such methods.

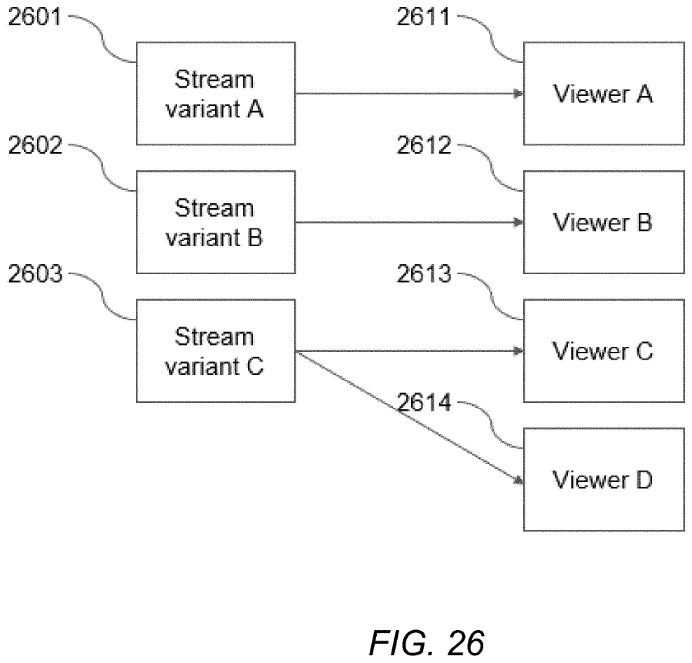

FIG. 26 illustrates viewers at different times and locations receiving different streams of the same film. Items 2601, 2602, and 2603 represent three different streams of, for example, a full-length feature film. These are labeled stream variants A, B, and C, respectively. Stream variant A 2601 is provided to viewer A 2611 on a Monday afternoon in the USA. Stream variant B 2602 is provided to viewer B 2612 the following day in South Korea. Stream variant C 2603 is streamed simultaneously to two viewers C and D, 2613 and 2614 respectively, who have elected to watch the film at the same time from two different locations in the United Kingdom on Wednesday evening. Viewer C 2613 and D 2614 may communicate to each other over social media to share their experiences watching the film.

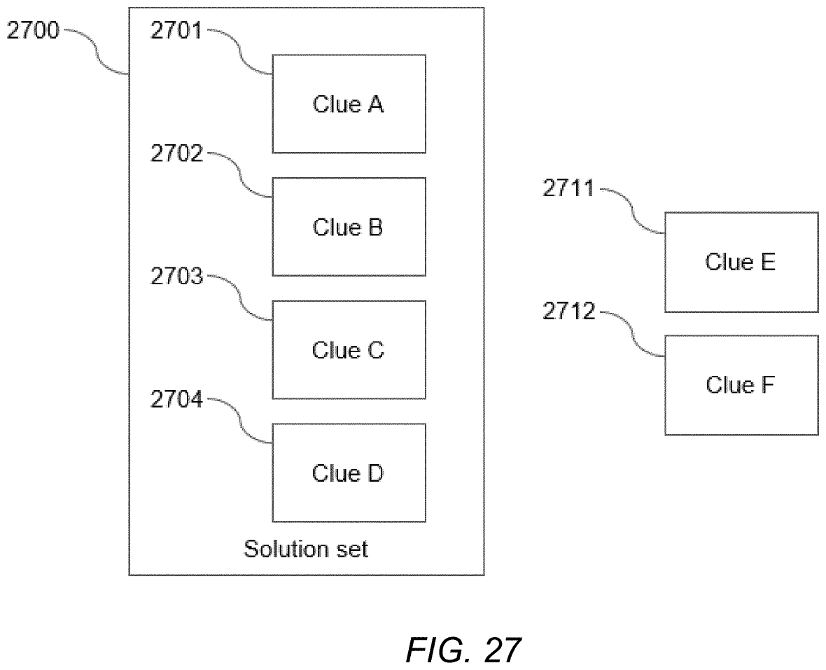

FIG. 27 illustrates a collection of clues comprising a solution. Solution set 2700 represents the necessary clues, in the form of NFTs labeled clue A 2701, clue B 2702, clue C 2703, clue D 2704, that solve the challenge. Clue E 2711 and clue F 2712 represent clues that are either unnecessary to solve the challenge or represent intentional misdirection, for example. One skilled in the art will recognize that sub-categories of clues may exist whereby other NFTs, not shown, are required to create clue D and to complete a solution set.

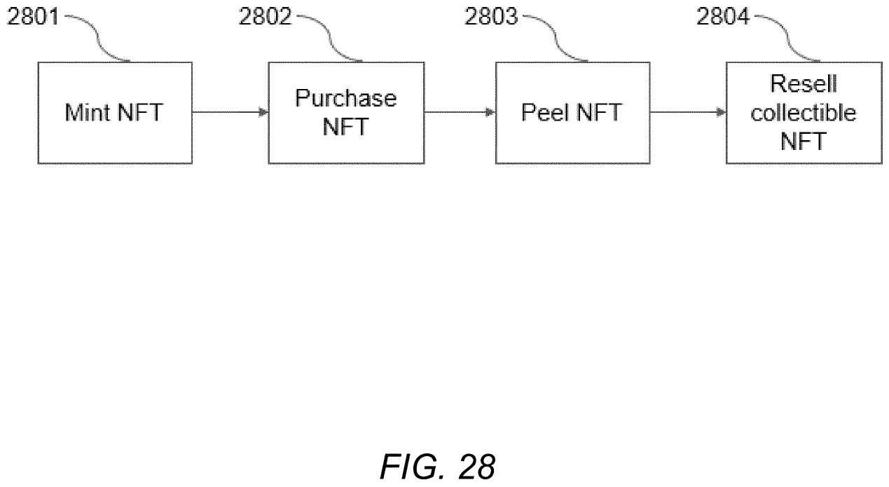

FIG. 28 illustrates an NFT peeling into a collectible. In this example, a film production company has distributed various versions of a full-length movie. The film company has prepared 2600 hints for sale as NFTs. Each hint may be minted into multiple NFTs, where the number may be limited, e.g., only 1000 clues of one type minted, or minted on demand at any number. In the latter case, only some of the NFTs, e.g., the first 500 of a type, may have some property, e.g., live for more than 1 month; be possible to resell; be peelable, etc. One of these NFTs has been minted in step 2801. Alice has watched the film and purchased the NFT 2802. Alice elects to peel the NFT 2803 rather than holding it to resell later in its current unpeeled form. She consumes a single-use video clip that reveals a partial solution to the mystery. Upon completion, the NFT peels into a collectible from the movie, and the single-use video is no longer available to Alice, or any subsequent buyer of the NFT from Alice. Instead, Alice may choose to hold the NFT, such as when it is required as a part of a solution set, or she may elect to resell the collectible NFT 2804.

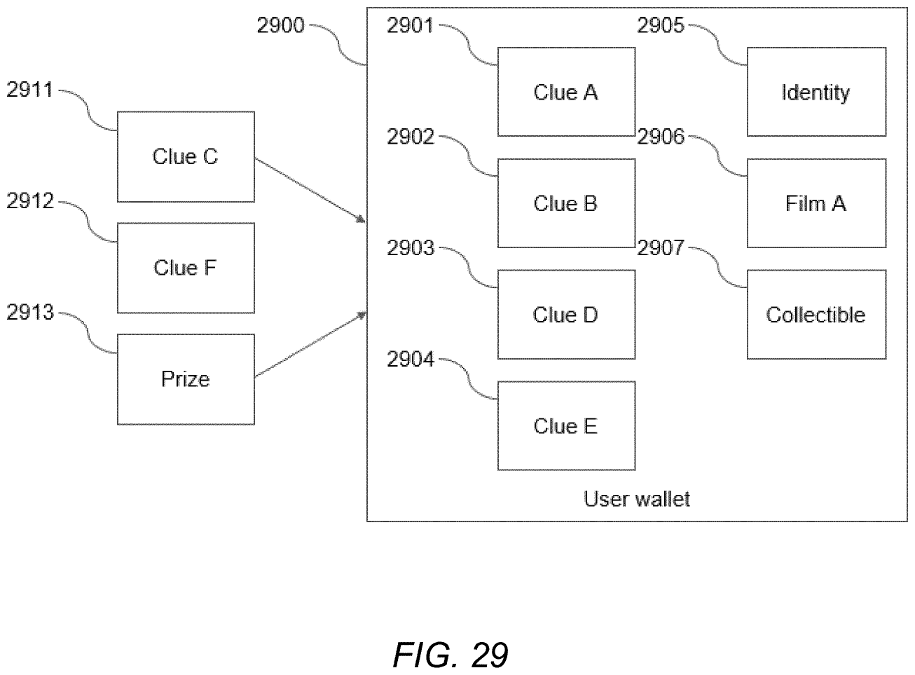

FIG. 29 illustrates a user's wallet containing NFTs and the potential addition of a new NFT. A user's wallet 2900 is depicted with an existing inventory of NFTs including an NFT indicating the purchase or viewing of Film A 2906. The user also has collected clues, such as clue A 2901, clue B 2902, clue D 2903, clue E 2904, and identity token 2905, and a collectible token 2907. In this example, the user may be missing one clue, clue C 2911 in order to complete a set. Clue F 2912 is not required to complete the set. Once purchased clue C 2911 is added to the user's wallet (not shown); unlocking the ability for the wallet, one or more of the NFTs, or a 3rd-party daemon to award the user with a prize token 2913 based solely, or in part, on the contents of the user's wallet.

### Mobile Wallet Resource Control

One aspect of the disclosed technology is a unit to determine the physical association between a mobile wallet and a user of the mobile wallet. For example, the mobile wallet may be incorporated in a device with the form factor of a bracelet, a watch, a ring, or other wearable technology, and may have a sensor that enables the detection of a physical association or the absence of such, with a user. For example, this may be a sensor that detects proximity to the skin, a heartbeat sensor, or a buckle that identifies when a user removes the device from being worn, or a Bluetooth connection or proximity detection between the device and another device owned by the user that is commonly in close proximity to the user such as a mobile phone. There are many other ways of implementing a sensor that can be used to determine the physical association between the device incorporating the mobile wallet and a user, and such sensors would also detect the absence of such a physical association. Multiple sensors can be used to determine the physical association between a mobile wallet device and a user, where the wallet determines that it is physically associated with the user based on the one or more sensors. For example, a first sensor may determine a heartbeat of a user and a second sensor may determine that a clasp is opened. Both sensors may be imperfect, and the heartbeat sensor may miss one or more heartbeats based on not being in perfect contact with the skin of the user at all times; similarly, the clasp sensor may identify a disassociation event if a user opens the sensor without taking the device off, but simply to scratch himself or herself. One of the sensors may identify a disassociation event without the other doing so, which could result in the wallet determining that it is still physically associated with the user. In another use example, two or more sensors may signal the association status to a processor associated with the mobile wallet, and the mobile wallet determining that it remains physically associated with the user as long as a threshold number of such sensors indicate that the association remains. This threshold may be two, for example. If there are three sensors that are used to determine physical association, and the threshold is set to two, then as long as at least two sensors indicate that the mobile wallet is physically associated with the user, then the state of the wallet would remain “associated”, but if less than the threshold number of sensors indicate association, then the state of the wallet would be changed to “disassociated”. Each sensor may be associated with a weight, and the sum of the weights of the sensors that indicate association can be combined, e.g., added together, and compared with a threshold value. A sensor may also output a certainty score associated with being physically attached, e.g., a value of 28 or 39, where such values can be combined, and optionally weighed as described above, after which the combined value can be compared to a threshold to determine how to set the state. The output of the one or more sensors can also be input to a machine learning element that has been trained to determine whether the mobile wallet device is physically associated with the user or not, e.g., based on heuristic indications for historical measurements.

Another aspect of the disclosed technology is one or more units used to determine liveness of the user with which the wallet is physically associated. This may be the same one or more sensors that determine physical association, but does not have to be. The liveness sensors are used to determine that the mobile wallet device is associated with a live user. For example, this may comprise determining that there is a detected heartbeat. The liveness detection may be distinct from the detection of being physically associated. As a rather colorful example, a user may have a wearable device with the form factor of a ring. The wearable device may detect being physically detached by determining that it is no longer in physical contact with a user (e.g., the finger of the user). However, liveness could be determined using a heartbeat or body temperature sensor. If the user's finger is cut off, the unit determining physical association would indicate that this remains true, but the liveness sensor would indicate that the liveness criteria is not satisfied for the mobile wallet device. If this ring is transferred to the finger of an attacker, the ring would momentarily not have the physical association criteria satisfied, nor the liveness criteria, but would then have both satisfied again. In some example uses, the determination of a state change would not be instantaneous, and one of these signals may be missed.

Yet another aspect of the disclosed technology is an authentication unit. This may be part of the mobile wallet, e.g., reside on the wearable computing device hosting the mobile wallet, e.g., in the form of a sensor such as a biometric sensor, a user interface enabling the input of a credential, or a sensor such as a heartbeat sensor that, coupled with a processor executing a machine learning process determines that based on historically observed heartbeat patterns of the user and current observations, there is a match indicative of the user being the expected user. In another embodiment, the authentication unit may determine that the heartbeat sensor and other biometric sensor indicate high levels of stress and, although matching the biometric patterns of the owner, may nevertheless restrict access to the device until the user's stress levels have dropped below a given threshold. In such an embodiment, the system and apparatus may, for example, prevent the user from accessing assets under stressful duress such as threatened force.

In another embodiment the authentication unit may require evidence that the user is not under the influence of substances that impair judgment, and may restrict access if such an influence is detected. For example, the authentication unit may require the successful passing of a breathalyzer test, blood test, or sweat sample reading test by a suitable connected sensor, thereby restricting transactions initiated whilst intoxicated or impaired.

The authentication unit may also be associated with an external device such as a smartphone that is paired with the device associated with the mobile wallet. The authentication unit is used to determine whether a user associated, e.g., physically associated, with the mobile wallet is a user who is on a list of allowed users. In some instances, the authentication unit also determines what user it is. The determination may require a user indication such as a selection of a username, but in some instances, this is not required.

A user may start wearing a mobile wallet device, causing this to be physically associated with the user, and causing liveness indications to be determined. Such a user may utilize an authentication unit to register as being the individual who is physically associated with the mobile wallet device. We refer to this as the user being paired with the wallet. A user becomes unpaired with the wallet if performing or being associated with an action that causes a physical disassociation, as described above. A user may also become unpaired with the wallet by performing or being associated with an action that causes a liveness verification to indicate that liveness is not detected. In one embodiment, a user becomes unpaired with the wallet based on an output from a heuristic scoring engine, such as the machine learning (ML) unit described above. Unpairing may also take place as a result of the detection of one or more anomalous event, such as a significantly increased heartbeat (potentially indicating fear) followed by a request, to a user interface of the wallet, to transfer a large number of resources in terms of their associated ownership status. Any event indicative of a risk can trigger an unpairing. A person of skill in the art will recognize that there are many possible variants of detected events that would lead to an unpairing, including variations and combinations of the approaches described herein.

Another risk detection event may be the detection that a user's wallet, incorporated on a phone, is no longer in the user's possession. This may be determined in a variety of ways. One such way is to determine that (a) the phone is not in a known location, such as the home of the user, and (b) the phone is not connected by Bluetooth to a wearable device of the user, such as an Apple Watch™ or an Oura™ ring. Another way is that there are at least two consecutive failed login attempts. A third way is that the user authenticates using a biometric technique, e.g., on the phone, but conveys a distress signal, e.g., by intentionally failing the biometric authentication, e.g., by using the wrong finger or by pressing the finger too hard on the sensor for the fingerprint to be read. Such risk identifiers can be used to trigger security actions.

The disclosed technology also comprises a storage unit that stores access control information, such as one or more cryptographic keys, an access control list (ACL), or a policy indicating what users have access rights to one or more resources, and optionally, the nature of such access rights. Example access rights include the right to read content, the right to transfer ownership of one or more tokens, the right to grant other users access rights, the right to enable other wallet instances to access content, the right to delegate any of these rights, the rights to erase data, the rights to append-write data, and more. Other rights may represent a sliding scale, for example, relating to the amount of a given asset that may be transferred, whereby, as more liveness and competence criteria are met, more of a given asset may be transferred within a specific time period. These are simply illustrative examples of the rights that can be associated with the control information, e.g., in the format of a matrix of access right values, where such values may indicate rights or grant rights. A value such as a bit string indicating the types of access rights can be used, or one or more cryptographic keys that may be used to decrypt data or sign requests, or a combination of or variation of such. Access control for tokens and other data stored in wallets is disclosed in co-pending application titled “Custodial Wallet Sub-Accounts” by Markus Jakobsson.

The access control indications may be conveyed to one or more digital rights management (DRM) objects associated with the wallet, e.g., as disclosed in co-pending application titled “Wallet with Modular Rights Management” by Markus Jakobsson and Keir Finlow-Bates, where one or more DRM objects initiate actions based on the access control information and/or the changes of the same.

In one embodiment of the disclosed technology, a rule engine associated with the mobile wallet determines a risk and performs a modification of at least one access control information element in response to detecting the risk. The risk may be indicated with a physical disassociation of the mobile wallet device from an associated user, or with an unpairing of the user from the mobile wallet. One example modification of access control information is to block all ownership transfers until a user pairs with the mobile wallet again. Another example is a blocking of all ownership transfers corresponding to values exceeding $100, until a qualifying action is observed. One example qualifying action is the resumption of a non-anomalous state and the pairing between the user and the mobile wallet. Yet another example qualifying action is the authentication to yet another wallet, such as a hardware or cold wallet, associated with the mobile wallet, causing that other wallet to unlock the mobile wallet. Access control modifications can be made in a manner that is contingent on a risk score computed based on sensor data, such as the sensors used to determine physical association or liveness; the risk score may also be based on requested events, and environmental observations. Example environmental observations comprise but are not limited to sensor inputs indicating that the paired user is afraid, distressed, disassociated from the mobile wallet, or that such events have been observed within a specified time period, such as in the ten minutes preceding the generation of the risk score.

In one embodiment, the determination of risk employs one or more machine learning components. A machine learning component such as a neural network performing logistic regression could be applied to a single type of sensor, for instance to output a prediction based on heart rate alone that a user is stressed, or to output a prediction based on gait, measured with an inertial measurement unit such as in a smartwatch or fitness tracker, that a wearer is the intended user. Or, a machine learning component such as a neural network performing logistic regression could be applied to multiple types of inputs, for instance taking data from a heart rate sensor, an inertial measurement unit, the recent history of sign-on requests and transactions, and others, to predict a single output indicating the probability of a risky event in progress. Or, multiple layers of machine learning and potentially also rule-based components could be used, for instance where a top-level neural network responsible for predicting the probability of a risky event takes input from another neural network responsible for using gait to predict whether the wearer is the intended user, along with other inputs, and the top-level neural network's output is combined with other information using hard-coded rules to compute the overall determination of risk. In some cases, machine learning components may be entirely pretrained, such as user-agnostic models that predict stress from audio of a person's voice or from changes in heart rate. In some cases, machine learning components may be fine-tuned to the particular user, for instance where a model that flags a transaction as potentially fraudulent is initially pre-trained according to labeled data from many other users, but as the user makes transactions it adapts to reflect what is typical for this particular user. Or for instance a model predicting stress in the user's voice may adapt to reflect the observed vocal qualities and variation thereof as the user interacts with the device, for instance through voice verification interactions, or through capturing of utterances in the course of daily use. In some cases, such machine learning components may be entirely bespoke to the given user, being trained from scratch and updated in an online or batch procedure with data captured from that user alone, for instance developing models of typical movement between locations as sensed by GPS and WiFi signals, so that deviations from this typical movement can be identified. Where fine-tuned or bespoke models are used, the mechanisms for combining the outputs of such models into an overall determination of risk may change dynamically, for instance allocating less weight or trust to such models when they have been trained on fewer data points, and allocating progressively more weight or trust as their training sets grow through additional user observations.

In one embodiment, a user has some explicit control over the training and/or use of machine learning components used in the system. For instance, a user may opt to provide additional training examples for models that are to be trained or fine-tuned to the user, for example providing a number of examples of himself or herself speaking in a “non-stressed” voice, or opting to provide examples of previous non-fraudulent purchases or examples of legitimate location variation, even if those predate the purchase or configuration of the mobile wallet resource control system. Or, for instance, a user may choose to disable or reweight particular machine learning components, for example disabling the gait analysis component after noticing that it is flagging many legitimate uses as suspicious, or after noticing that false positives from this component led to one or more risk events that impeded legitimate use. User interfaces that enable users to query the cause(s) triggering the system to identify a risk event, for instance through explainable AI (XAI) techniques, can facilitate such behaviors, as can user interfaces that enable users to observe the outputs of machine learning components over a recent history or even in real time, to look for errors or alternatively to gain trust in the system components.

In one embodiment, the detection of a risk triggers a delayed permission. Examples of this are provided in co-pending application titled “Second Factor Improvement Technology” by Markus Jakobsson and Keir Finlow-Bates, wherein a credential is temporarily “frozen” for a period of time, during which a verification is performed. Other security actions can also be triggered, such as access rights being limited, revoked or otherwise modified for a duration of time in response to the detection of a risk, and wherein a verification may be performed during this time period and the limitation, revocation or modification are canceled, maintained or replaced with another constraint in response to the outcome of the verification.

In one embodiment, a particular wallet may be configured with transaction restrictions that require outgoing transfers of wealth to occur with only a specific whitelist of addresses. A corporate wallet address may accumulate wealth and be transferred to another address for conversion to fiat. If the key holder is under duress, the system restrictions, which may or may not detect distress, may limit either the size of outgoing transfers or the destination; thereby improving the security of the funds and reducing the potential violent threat to the key holder.

In one embodiment, a rule engine associated with the mobile wallet determines a condition that is indicative of safety and performs, in response, a modification of at least one access control information element, where such modification may be to reset the access rights to a permissive level set for the mobile wallet. There may be multiple such permissive levels, and these may be selected depending on the observed events. For example, a first permissive level may correspond to a situation involving a user who is detected, e.g., based on GPS and WiFi signals, to be at home or at work, and for which there are no physical indications of distress observed for a threshold duration of time such as one hour, and where the user has authenticated, e.g., as described above, within a time period of 15 minutes. A second permissive level may correspond to a user who is physically at rest, and based on audio inputs, is alone. There may be many more permissive levels. Different permissive levels may be associated with different sets of access rights.

Whereas the disclosed technology is particularly useful in the context of wallets implemented on or as wearable computing devices, many of the same principles also apply to other forms of mobile wallets, such as mobile wallets implemented on smartphones. Whereas these may not have some of the sensors, such as sensors to determine physical association, other replacement building blocks to determine risk or the absence thereof may be used instead. One such example method comprises techniques to determine that a user of a phone is different from a registered user of the phone, e.g., using the user-facing camera and a biometric template for the determination of whether the active user looks like the registered user. The disclosed techniques for modification of access rights may also be associated with other methods of determining risk or the absence thereof, and can be applied to modified versions of traditional USB-dongle based crypto wallets, where such modifications may comprise GPS sensors that determine anomalous locations and changes of location.

In one embodiment, the mobile wallet resides on a smartphone, and sensors useful to determine whether a user associated with the wallet is in distress reside on another device, such as a wearable computing device with the form factor of a ring or a watch. For example, a heartbeat sensor incorporated in a smartwatch may determine that a user is likely in distress, and convey that signal to an associated smartphone, e.g., one that is paired with the smartwatch. The distress signal is used by a processor associated with the smartphone to evaluate the rule engine and determine that there is a risk, where such determination is used to trigger a modification of the access rights associated with data referenced by or stored by the wallet.

A wallet can be used to store many types of data, including tokens, user configuration data, user event data, current access control data, and more. Example tokens include crypto coins and non-fungible tokens (NFTs). Example configuration data include data indicating the functionality of the wallet, including its associated user interfaces. It may also comprise some access control data, e.g., data that indicates the maximum access rights associated with the wallet, e.g., as set by a user using another associated wallet. The user event data may comprise data indicating what content the user has consumed, where content may be NFT content, relate to browsing history, or may include purchase data. The current access control data may be different from the maximum allowed access control data, as it may take into consideration risks that trigger the reduction of access rights, as disclosed herein. The data associated with the wallet can be backed up in a secure manner, e.g., using encryption and data authentication methods, where the location of the backup may be cloud storage, an associated wallet, or personal storage associated with the user of the wallet. Tokens are typically stored on cloud hosting resources or public databases, or sometimes on one or more blockchains. Ownership data is typically stored on a blockchain. A wallet may also locally store some or all of the token data, e.g., for purposes of more rapid access to such data or access that is not affected by the availability of Internet access. The usage of data, e.g., rendering of it, replication of it, the granting of permission to it, etc., can be governed by one or more DRM objects that may be housed in the wallet or in an associated entity that may be secured against malware by having restricted access, and which may be protected against abuse by running in a trusted execution environment (TEE.)

A user may be associated with multiple wallets. One wallet may perform a remote software-based attestation of the security of another wallet, to determine that the second wallet is not corrupted, e.g., by malware. One method of performing software-based attestation is disclosed in M. Jakobsson, “Secure Remote Attestation”, available at https://eprint.iacr.org/2018/031.pdf, also see U.S. Pat. No. 10,747,878. Software Based Attestation (SBA) can be performed when one wallet, such as a mobile device based wallet, is identified as being associated with risk. Then, the wallet may be made unavailable to its user, or only available for some limited types of use. This could be maintained until SBA is performed on the wallet associated with the high risk, e.g., using another wallet of the same user as a verifier in the SBA.

In one embodiment, a first wallet detects an event such as a risk or an unpairing event, and performs a security action in response, where the security action causes a limitation, at least temporarily, of the access rights from the wallet to data. Examples of such data to which access is logged is content associated with NFTs, the right to transfer ownership of NFTs or other tokens, personal data such as activity log data or preference data indicating purchase preferences or advertising preferences, and more. The first wallet may cause this limitation by setting a time-out period during which some types of data cannot be accessed, and wherein such accesses are controlled by a digital rights management module associated with the first wallet. The first wallet may also erase keys, or erase data. To later gain access to keys or data which were erased, the first wallet may perform one or multiple actions. One action is to request and be granted access to such keys or information from another associated wallet, such as a second wallet, where the second wallet stores the keys or information, or can generate these from data it stores. Another action is the retrieval of erased data from an external storage such as a cloud storage, where the cloud storage records may be encrypted and access to the cloud storage may require user authentication. The decryption of cloud storage records can be performed using an access key such as a decryption key generated from a seed associated with the first wallet, and optionally also with the second wallet.

In one embodiment, the detection of the event such as the risk or the unpairing event causes a distress signal to be generated by the first wallet and transmitted, for example, to a second wallet, a security authority, or to an entity storing a log that is accessible by the second wallet. The log may be an encrypted entry on a blockchain, for example. Alternatively, the first wallet may suppress an all-ok signal that is otherwise periodically beaconed to the second wallet or to the entity storing the log. The presence of a distress signal or the absence of an all-ok signal, which we collectively refer to as a warning event, indicates a potential risk event, e.g., to the second wallet. In response to the determination of a warning event, further security actions external to the first wallet may be performed. For example, the warning event may cause the first wallet to limit access, by the first wallet, to resources it controls. Examples of such resources may be locally stored NFTs, locally stored media content, locally stored log files, locally stored keys. Here, locally stored refers to data stored on the second wallet or an external storage that can be controlled by the second wallet. The limitation of access may comprise a refusal to let the first wallet (or any wallet at all, except for the second wallet) to read data, to initiate ownership transfers, initiate ownership transfers to new destination addresses, or to write data. Another security action that may be performed by the second wallet is the generation of a warning for a user, e.g., to be displayed on a user interface, or conveyed using a communication channel such as an SMS message, an email, or a push notification. Other entities may also take security actions in response to the detection of warning events. Such security actions may comprise limitations of access to resources, the initiation of location tracking and logging of events associated with the first wallet, e.g., by infrastructure radio transmitters in the environment of the first wallet. One example event to the logged may be audio signals detected in the proximity of the first wallet, as determined by recent locations or detected locations, where locations may be detected by identifying characteristic radio signals and identifiers such as Bluetooth Device Identifiers, UDIDs, IMEAs, and other values transmitted by radio to or by the first wallet. This enables the locating of the first wallet by infrastructure nodes in case of a warning event having taken place, as well as a limitation of actions possible to be taken using the first wallet.

The security actions taken in response to a warning event, whether by the wallet detecting it, by an associated wallet, or by third party nodes such as infrastructure devices, may be at least in part configured by a user when setting up the first wallet. By associating one or more policies with risk events, the user can thereby select how he or she wishes to respond to various threats. For example, a first user may wish only some types of wallets to be trackable in terms of their location, and only under certain select triggering circumstances such as only when at least three consecutive failed authentications have taken place for the first wallet. A second user may wish some wallets, such as a wallet provided to a child, always to be trackable by the second user. A third user may change the policies indicating what actions are taken in response to a notification of a warning event, such as a requirement to reconnect or re-pair a wallet to a specific unit of hardware, such as a cold wallet.

In one embodiment, the security action taken depends on the reason underlying a warning event. For example, the unpairing of a wallet may by itself not be the cause for any security action other than a notification to a user and a logging of the circumstances of the unpairing; however, the unpairing of a wallet followed by another high-risk event such as a failed authentication attempt may cause another security action. If a user of a wallet manually initiates a distress signal, such as by clicking on a physical button of the wallet five times in a row within five seconds, this may initiate yet another security action, such as the summoning of law enforcement to a location conveyed by the wallet. Communications may be encrypted or obfuscated to avoid that an attacker manages to determine what type of signal is being transmitted. Distress signals may also be transmitted using radio identifiers different from those used in regular communications, to decouple the transmission of the distress signal from the wallet sending it. This can be achieved by storing at least two different device identifiers by the wallet or device implementing the wallet and selecting the device identifier based on the context.

A user may set or select policies identifying what qualifies as events triggering warning events. For example, a user may specify that any attempt to transfer ownership rights of an NFT from a first mobile wallet is a triggering event, while allowing transfers of ownership of NFTs worth up to $10000 within any 24-hour period without the triggering of a warning event from a second wallet associated with the user. The user may similarly configure a wallet for his or her child, where this “child wallet” is associated with a policy to issue a warning event in a situation indicative of theft of the child wallet, where such situations may include the change of access rights to data indicated by the user performing the configuration.

In one embodiment, a user may employ a user interface to select among a number of high-level risk sensitivity “profiles”, for instance “high sensitivity” in which small estimated probabilities of risk nevertheless lead to the triggering of security actions, “low sensitivity” in which only quite high probabilities of risk lead to the triggering of security actions, or “medium sensitivity” in between the two. Such an interface may impose a delay, for instance of 24 hours or longer, before a requested change from a higher sensitivity to a lower one will go into effect. Such an interface may enable users to schedule periods of lower sensitivity in advance, for instance on days and times when they find it most convenient to make transactions and know they are likely to be in a low-risk environment. A very high sensitivity profile could be seen as somewhat analogous to freezing one's credit, a common action by people who have reason to suspect identity theft and who are willing to trade additional security for lower convenience in opening a new credit account, an action that is likely to be rare and also able to be anticipated and even scheduled in advance. Moving to a lower-sensitivity profile could be planned in advance around similarly anticipated activities.

At least part of the processing disclosed herein may be performed by one or more digital rights management (DRM) modules associated with the one or more wallets disclosed. Multiple DRM modules governing different tasks may be associated with one and the same wallet, and may communicate with each other. Different wallets located on different physical devices may also be associated with different DRM modules, which may communicate with each other, e.g., over secure channels or using public databases such as blockchains to store data that may be encrypted and/or authenticated. This data may surreptitiously convey signals such as distress signals, e.g., using steganographic methods. The collaboration of DRM modules associated with different physical devices is disclosed in co-pending application titled “Cross-Device Digital Rights Management” by Markus Jakobsson.

One beneficial use of the disclosed technology is for automated protection of assets in situations where potential abuse, such as a malware attack or a phishing attack is detected. The determination of risk may comprise detecting an incoming message from an unknown party, user access to information related to a very small amount of cryptocurrency gifted to him (a form of abuse commonly referred to as “dusting”), or one or more anomalous, where anomalies may be detected by comparing past user behavior and contexts with current observations of the wallet.

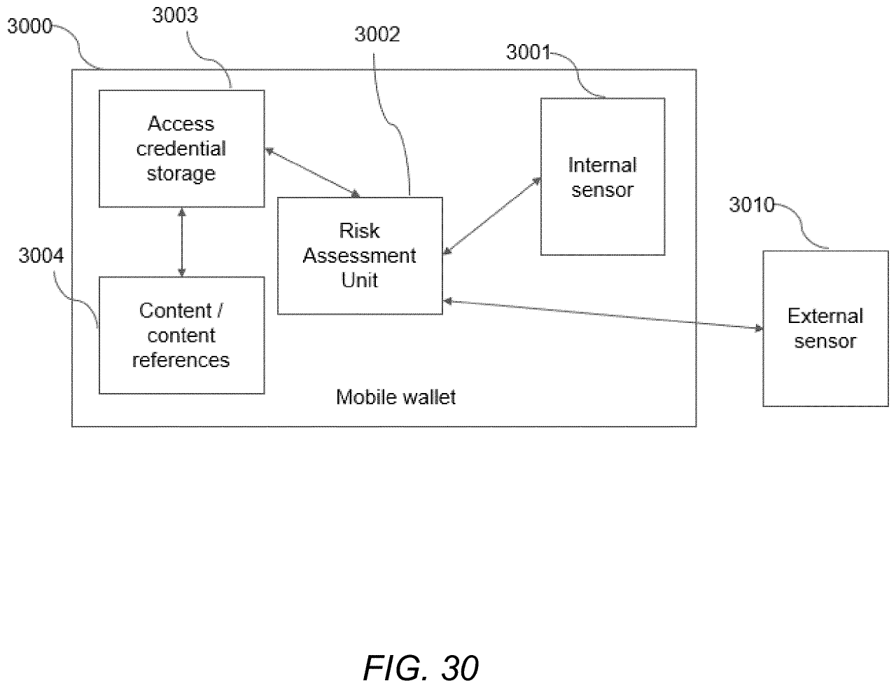

FIG. 30 illustrates an example mobile wallet 3000, which may be housed on a USB drive, a phone or a wearable device, and which may optionally be paired with an external sensor 3010, e.g., on a smartwatch or another wearable device, and which may have an internal sensor 3001. External sensor 3010 and/or internal sensor 3001 may be used by risk assessment unit 3002 to determine a risk. The sensor may be a biometric sensor, or be a software unit that determines an action, such as a failure to enter the correct password. It may also be the source of data used to detect anomalies, e.g., a location sensor that determines an unusual environment or an accelerometer that determines an unusual movement. The risk assessment unit 3002 receives one or more signals from external sensor 3010 and/or internal sensor 3001 and determines that there is a risk, which causes a security action to be triggered. One example security action is the removal or modification of at least some access credentials stored in access credential storage 3003. Such credentials may be used to access content or content references 3004, which may be stored in mobile wallet 3000. When a risk event is detected, it triggers a security action such as the deletion or modification of access credentials, thereby causing limitations in access to content associated with wallet 3000. Such reductions may be temporal, e.g., last for 24 hours, or may last until a reversing action takes place. Example reversing actions include a command given from another associated wallet, a more demanding authentication process than normally performed to access the wallet 3000, a positioning of the wallet 3000 in an environment associated with security, such as the user's home, or a combination of these.

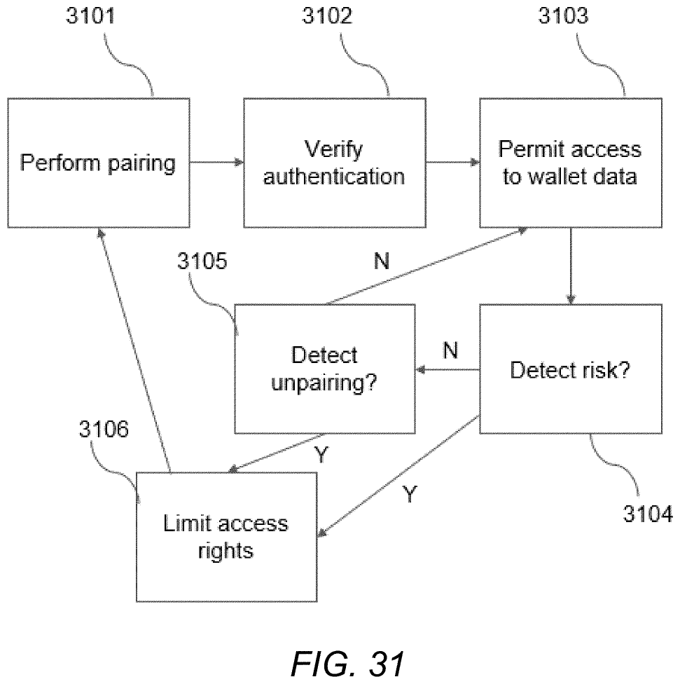

FIG. 31 illustrates a typical usage scenario. In step 3101, the wallet 100 successfully performs a pairing with an associated device, such as a wearable computer comprising external sensor 110. Alternatively, the pairing may correspond to a bonding between the wallet and a user, such as by a wallet 100 implemented in a smartwatch where the bonding comprises cloning of the bracelet of the smartwatch, as described, for example in M. Jakobsson, “How to wear your password”, http://citeseerx.ist.psu.edu/viewdoc/summary?doi=10.1.1.564.8207. In step 3102, an authentication is verified, e.g., a biometric authentication or a password-based authentication by the user of the wallet. In step 3103, the wallet permits access to wallet data, such as NFTs and crypto coins. In step 3104, it is determined whether a risk is detected. A risk may be detected based on a signal from a sensor indicating tampering of the wallet or an associated device, based on a sensor indicating that the user is aroused, or based on an anomalous access to the data of the wallet, such as a request to transfer ownership of a large number of items or a valuable element, e.g., with a value exceeding $2000. If a risk is detected, the processing continues to step 3106, otherwise to step 3105. In step 3105, it is determined whether the wallet is being unpaired, e.g., the bond established in step 3101 being broken. This may be due to the opening of a clasp, the physical removal of the watch from an environment containing an associated device that is in communication with the wallet using Bluetooth, etc. If unpairing is detected, the processing continues to step 3106, otherwise to step 3103. In step 3106, at least some access rights are limited. The access rights may be to one or more crypto coins, to one or more NFTs, to personal purchase history data, to browser data, to a personal profile indicating commercial interests, etc. The access rights may be modified by the erasure of at least one key. There may be some keys that enable the processing of NFT content, e.g., to render an image or a movie. Other keys are used to transfer ownership of tokens. Yet other keys may encrypt files with personal data. The erased keys may remain on other wallet devices associated with wallet 3000, and may be recovered from such wallets after access is again permitted (step 3103). In some embodiments, access rights are modified by erasing files, e.g., a browser history file. In yet other embodiments, the access rights are modified instead by setting variables indicating access rights, where these variables are evaluated by a digital rights management module prior to permitting access to a file. A combination of these manners of limiting access can be used. In some embodiments, a distress signal is transmitted to an associated wallet in step 3106, or an all-ok signal is no longer transmitted with regular intervals if the state of step 3106 is reached. The use of distress signals or the suppression of all-ok signals can be used to indicate the need for emergency help, such as law enforcement, or at least to initiate a phone call to the wallet owner to determine whether all is ok; the user may respond with a first secret password if all is ok, and a second secret password if he is in an emergency, such as being held up. Signaling can also be performed as described in Johan Hastad et al, “Funkspiel Schemes: An Alternative to Conventional Tamper Resistance”, available at https://www.arijuels.com/wp-content/uploads/2013/09/HJJY00.pdf.

The disclosed technology is not limited to protecting mobile wallets, but can also be applied to protect other types of wallets. For example, a corporation may receive payments into a wallet address that is associated with a cold wallet stored in a vault, or where the private key for transferring token ownership is distributed between multiple wallets in the same manner designated entities can be distributed using threshold secret sharing methods, as disclosed in co-pending application titled “Escrowed Wallet and Transaction Tracking Technology” by Markus Jakobsson. A trigger for a security action in such an embodiment may be a transfer request that is anomalous, e.g., goes to an account that has not received transfers to it before from this wallet, has not received transfers of a similar magnitude, or has not been registered as a valid funds recipient. The anomalous event may also be a transfer at a different time of the day from what is otherwise done, or using devices different from what is normally done. The triggering of the security action can lock down funds, undo a request, cause an escalation of authentication needs to proceed, etc.

### Distinguishing Between Different Types of Digital Signature Requests

In the present disclosure, solutions to the problems of a) clearly indicating to a user what the significance of the data they are signing is, and b) automatically detecting and categorizing the purpose and function of data presented to the user for signing, are presented.

In an embodiment of the present invention, a blockchain wallet may receive a request from a web3 website to present data for signing. The blockchain wallet may comprise a component which scans or analyzes the data to determine what the nature of said data is in order to categorize it. The component may categorize the data as one of: a transaction, a challenge/response, a voucher, or as some other unrecognized data.

A voucher may comprise one or more of: a transaction, metadata, a counter, instructions for execution within a virtual machine or interpreter, machine code for execution on a processor, a data structure comprising attributes or properties of an object instantiation of a programming language class, a JavaScript Object Notation text fragment, one or more blockchain addresses, a hash of all or some of the aforementioned components, and/or a digital signature of the hash produced by an issuer of the voucher.

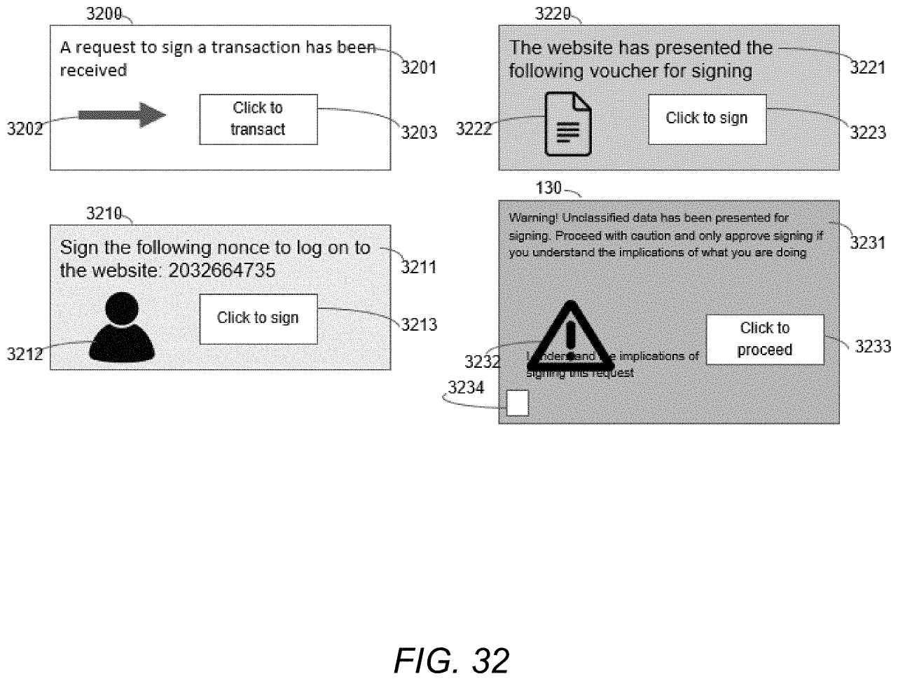

The blockchain wallet may then present the user with an interface, for example a pane, page, or dialog, to approve signing of the data. In an exemplary instance of the present disclosure, the interface may use one or more of a different color, a different title, a different font, a graphic or logo, or a different interface component layout when presenting the data, based on the categorization. For example, in a illustrative implementation of one part of the present disclosure that is not meant to be limiting in any way is presented in FIG. 32:
1. A request to sign a transaction may be presented on a purple dialog box (3200), with a title reading, “A request to sign a transaction has been received” in a Nunito font (3201), and a graphic representation of an arrow (3202), with a button labeled “Click to transact” (3203).
2. A request to sign a challenge/response may be presented on a green dialog box (3210), with a title reading, “Sign the following nonce to log on to the website” in a Roboto font (3211), a graphic representing a silhouette of a person (3212), with a button labeled “Click to sign” (3213).
3. A request to sign a voucher may be presented on an orange dialog box (3220), with a title reading “The website has presented the following voucher for signing” in an Arial font (3221), a graphic of a piece of paper (3222), with a button labeled “Click to sign” (3223).
4. A request to sign uncategorized data may be presented on a red dialog box (3230), with a title reading, “Warning! Unclassified data has been presented for signing. Proceed with caution and only approve signing if you understand the implications of what you are doing” in a monospace font (3231), and a graphic representing a warning sign (3232), a button labeled “Click to proceed” (3233), and furthermore, the red dialog box may include a checkbox with a label reading, “I understand the implications of signing this request”, which must be checked for an “approve signature” button to become enabled (3234).

We now proceed to disclose systems and methods for producing the component responsible for identifying and categorizing data presented for signing as a transaction, a challenge/response, a voucher, or something else.

For the purposes of this disclosure Ethereum will be examined, however, those skilled in the art will appreciate that techniques disclosed may equally be applied to other blockchain systems such as Bitcoin, Solana, Waves, Polkadot, Cardano, and others.

In Ethereum, a transaction is a reverse-length prefix (RLP) encoded serialized data structure comprising a nonce, a gas price, a maximum amount of gas, a destination address (either an account or a contract address), a value of native cryptocurrency ether to transfer, a data field, which requires an ECDSA signature to validate the transaction. The component may therefore determine that data presented for signing is a transaction by determining that a structure of the data matches the structure of a transaction. Furthermore, the component may determine the value of native cryptocurrency that is to be transferred and the destination of said value in the form of the destination address, and may then inform the user interface to display the signature request with relevant information concerning the data in a suitable dialog as previously disclosed.

In a further embodiment, the component may comprise a database of known transaction structures and contract interactions, and may determine the nature of the transaction by comparing the transaction data with templates stored in the database. Subsequently, the component may instruct the interface to present further human-readable information to the user, for example, “Transaction transfers 1 ETH to address 0xABC . . . 123”, or “Transaction initiates a swap of 5 DAI for 5 AAVE in version 3 of the Uniswap Decentralized Exchange.”

The component may determine that data presented for signing is a nonce related to a challenge/response identification or authentication request. For example, the component may examine the data and determine that it is an integer, i.e. a nonce, and not a transaction, and therefore safe to sign. In another embodiment, web3 websites and blockchain wallets may implement a standard whereby a nonce is prefixed or postfixed with a “magic number”, namely an agreed-up number or string indicating that the data is a nonce.

The component may determine that data presented for signing is a voucher, namely a data structure recognized by a function in a smart contract, with the smart contract subsequently acting on the data provided through a transaction presenting the signed voucher. A voucher thus acts as an “off-chain” transaction that may be presented by a party (either the voucher signer, or another party, or both) at a later date. A voucher may therefore cause a smart contract to change a data structure or state to one that a user may not desire.

In one embodiment, the component may inspect the presented data to determine whether it comprises a voucher. Methods used to make the determination may comprise: examining whether the length of data exceeds an expected length for a nonce, whether the data comprises a transaction wrapped in other data, whether a structure of the voucher matches that of a known entry within a database of voucher structures, or some other method.

If the component concludes that the data presented for signing comprises a voucher, the component may instruct the interface to present the user with this conclusion through means disclosed above. The database may comprise information on risks associated with various voucher structures, and may pass this information to the interface for displaying to the user in order to provide further information for the user to make a decision as to whether to sign the voucher. In an exemplary case, the component may conclude that a first voucher presented for signing by a web3 website comprises an instruction to mint a non-fungible token (NFT) on a smart contract, and may inform the user thereof. In a second exemplary case, the component may conclude that a second voucher comprises an instruction to a smart contract to permit a further account to transfer an NFT owned by the user, and may inform the user thereof. The user may subsequently decide to sign the first voucher and reject the second voucher. In a further illustrative example, the web3 website may claim on a web page that a third voucher allows a user to join an NFT contract minting whitelist, but the component may determine that a structure of the third voucher corresponds to a voucher commonly used to permit a transfer of digital assets from the signatory to a third party specified within the third voucher. On informing the user, they may notice the discrepancy between the claim by the website, and the action as determined by the component, and may decline to sign the third voucher.

In a further embodiment of the present invention, the web3 website injecting the data for signing into the blockchain wallet may include data indicating what the structure and purpose of the data is. The component may then verify a claim by the web3 website that the data is a transaction, a challenge/response, or a voucher, and may present the data for signing if the verification succeeds. If the verification fails, for example by the web3 website presenting a transaction but claiming that it is a challenge/response nonce and the component determining this.

For example, a web3 website may use a prefix indicating that the data is a nonce, and that a cryptographic hash of the nonce is to be signed using a private cryptographic key held by the blockchain wallet in order to authenticate control or ownership of a public cryptographic key or blockchain address derived from the private cryptographic key. The component may determine this as valid, and may subsequently hash the nonce using a corresponding cryptographic hash function, and may then present a hash output to the interface for the user to approve for signing. The web3 website may then authenticate the public cryptographic key by verifying that the hash of the nonce has been signed by the private cryptographic key, or by verifying that the public cryptographic key may be used to derive the blockchain address and that the signature is valid.

Thus, in one embodiment of the disclosed technology, a context is encoded in a formatting input of a message, where different contexts preferably correspond to distinct user experiences, and where the formatting makes it not possible to find collisions, e.g., having a user sign a challenge response and then use the resulting signed response to cause a transaction to be performed, e.g., the change of ownership of a token.

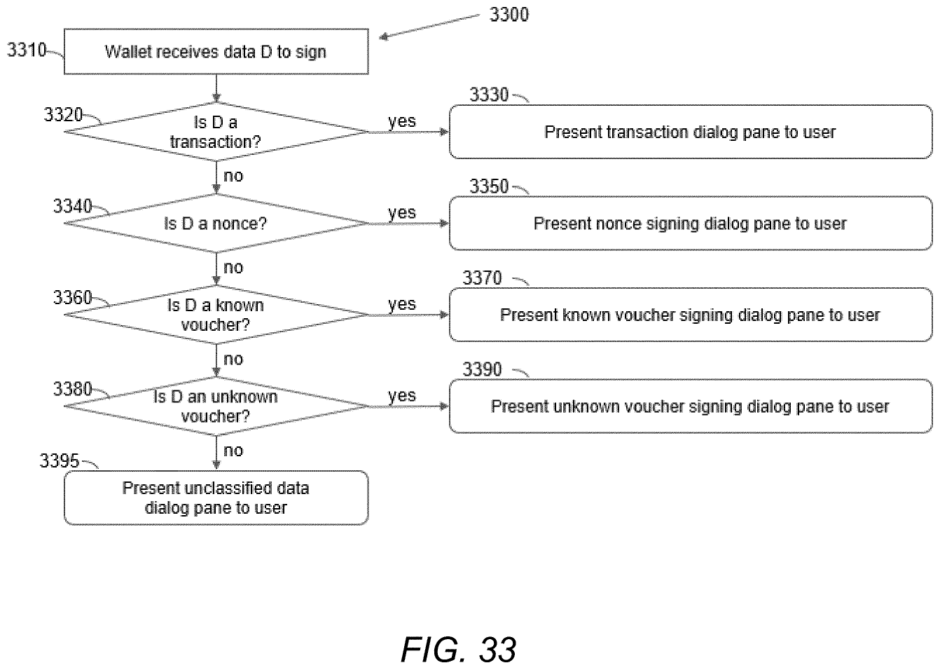

In FIG. 33 a possible exemplary implementation (3300) provided for illustrative purposes and not meant to be limiting is presented. Actions may commence by a wallet receiving data D to sign, as shown in step 3310.

Actions may proceed with the wallet determining whether D comprises a transaction, for example, a transfer of digital assets from a wallet address to a third-party address, as shown in step 3320.

If the wallet determines that D is a transaction, actions may proceed to step 3330, and the wallet may present a transaction dialog pane to the user presenting the transaction to be signed, for example as shown in FIG. 1 (3200).

If the wallet determines that D is not a transaction, actions may proceed to step 3340, in which the wallet may determine whether D comprises a nonce for signing, for example, a challenge for a login session.

If the wallet determines that D is a nonce, actions may proceed to step 3350, and the wallet may present a nonce dialog pane to the user presenting the nonce to be signed, for example as shown in FIG. 32 (3210).

If the wallet determines that D is not a nonce, actions may proceed to step 3360, in which the wallet may determine whether D comprises a known voucher for signing, for example, a voucher to mint an NFT in a known smart contract that the user may previously have interacted with safely. In other embodiments the wallet may comprise a database of vouchers known to be safe, provided by the wallet software provider.

If the wallet determines that D is a known voucher, actions may proceed to step 3370, and the wallet may present a voucher dialog pane to the user presenting the voucher to be signed, for example as shown in FIG. 32 (3220).

If the wallet determines that D is not a known voucher, actions may proceed to step 3380, in which the wallet may determine whether D comprises an unknown voucher for signing, for example, a voucher comprising a data structure parsed to determine the data structure comprises a text representation of a Solidity or JavaScript object. In some embodiments the wallet may recognize the data D as representing such a data structure, but may not find the data structure in a database of vouchers or data structures known to be safe and provided by the wallet software provider.

If the wallet determines that D is an unknown voucher, actions may proceed to step 3390, and the wallet may present a voucher dialog pane to the user presenting the unknown voucher to be signed alongside a warning as to the unknown nature of the voucher, for example as shown in FIG. 32 (3230).

If the wallet determines that D is not an unknown voucher, actions may proceed to step 3395, and in some embodiments the wallet may present a dialog pane to the user presenting the data D to be signed alongside a warning as to the unknown nature of the data, for example as shown in FIG. 32 (3230). In other embodiments, based on a previously determined skill level of the user, the wallet may present a dialog informing the user that the data has been rejected based on security concerns.

Those skilled in the art will appreciate in light of the above disclosure that steps 3320, 3340, 3360 and 3380 may be conducted in any order, with step 3395 conducted if 3320, 3340, 3360 and 3380 all return a determination of “no”.

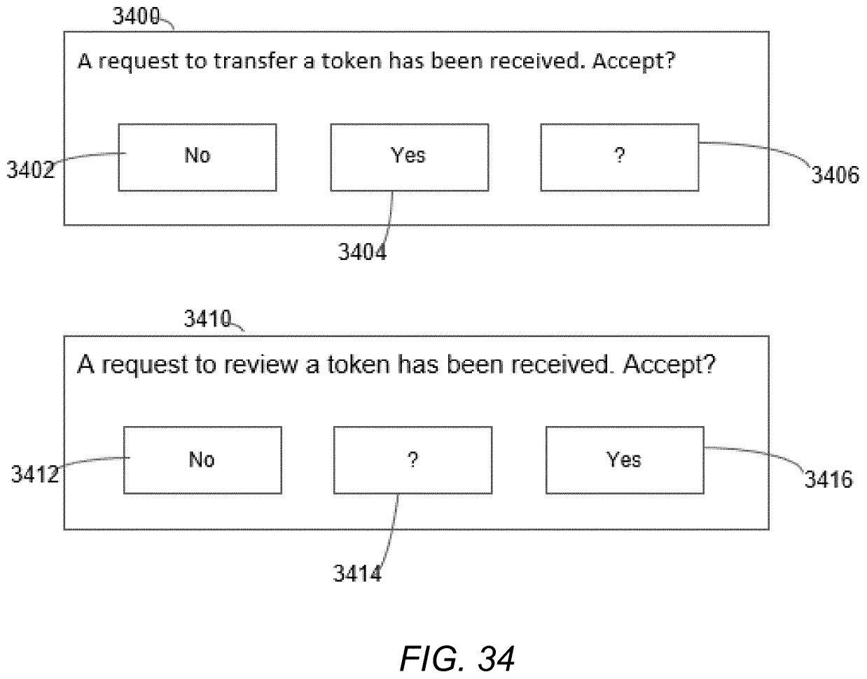

The manner in which a user may interact with a user interface may be instrumented to suppress the risk of mistakes. For example, consider a situation involving two types of approval as illustrated in FIG. 34, wherein a first approval (3400) corresponds to agreeing to transfer ownership of a token to a beneficiary or buyer, and a second approval (3410) corresponds to accepting a positive review of a token. If the user experience (UX) were similar in these two examples, it is likely that some users may think (maybe being confused or being actively tricked) that a request to transfer a token is instead a request to add a positive review of a token, thereby accidentally transferring the ownership of the token. Instead, the UX of these two actions should be different, e.g., using three buttons for both. For the transfer of ownership, the first button (3402) may be labeled “no” and correspond to a refusal to transfer ownership; the second button (3404) may be labeled “yes” and correspond to an agreement to transfer ownership; while the third button (3406) may be labeled “more information” or “?” and correspond to a request to learn more about the terms of the transfer—clicking the third button (3406) may cause a human-readable description of the terms to be displayed. Clicking the “yes” button (3404) may require the user to click “yes” again on a popup that describes the sales price (if any) and the estimated market price (if known), highlighting any discrepancies. The user can also click “take me back” on the popup to change her mind. In contrast, for the acceptance of the review, the first button (3412) may be labeled “no” and correspond to a refusal to receive and display the review; the second may be labeled “more information” or “?” (3414) and cause information about the reviewer to be displayed; and the third button may be labeled “yes” (3416) and cause the review to be accepted. A user who is used to accepting reviews will be used to clicking on the third button, and therefore, when thinking she is accepting a review (or simply letting her motor memory cause her to click the third button) on a transfer request, the user may be met by an unusual user experience (namely the “more information” experience of the ownership transfer, as opposed to the pop-up asking the user to confirm.) Similarly, a user thinking she wants more information about a reviewer may realize that something is wrong when she clicks the second button of an ownership transfer request and receives the pop-up. Similarly, requests to borrow a token will have a different format and UX than requests to buy a token. A graphical approach to distinguish between different types of approvals and transactions can be used; such approaches are disclosed in co-pending application Ser. No. 63/311,283 titled “Wallet User Privacy and Permissions Interface” by Markus Jakobsson and filed on Feb. 17, 2022.

The disclosed technology addresses problems such as wallet draining attacks, wherein a user is made to believe that one event (such as minting) is taking place whereas another (such as transferring out an NFT) is instead performed. An example of such an attack is described in a Jul. 7, 2022 tweet by Montana Wong, https://twitter.com/Montana_Wong/status/1545081928017031168. By differentiating the user experience (UX) for actions of different classes, this threat is avoided. Here, the classes correspond to collections of actions with similar outcomes. Multiple classes that all result in benevolent outcomes can be gathered in a common class. If an action could have adverse outcomes, this action is isolated in a class that is different from the benevolent action class. Since most actions can have both benevolent and adverse outcomes, it is also important to isolate the potentially-adverse actions from each other, by associating them with different classes, and where these different classes cause differences in the UX. A system designed using the disclosed technology can choose the UX associated with a given class to cause a differentiation with another class, and wherein the UX differences are significant when the actions of the two classes are likely to be desirable to be confused with each other, e.g., using social engineering attacks mounted by an attacker. Two classes whose associated actions that are not known to be confused with each other by attackers may have lesser UX differences without significant harm. Thus, the multi-dimensional space describing UX experiences can be mapped to the classes in a manner that two classes that attacker would find desirable to confuse with each other to victims would have great UX differences. Here, one dimension of the UX space may be the button design (e.g., location and appearance); another be the button interaction (e.g., click or swipe); and yet another dimension may be the use of 2FA methods. 2FA methods, in turn, may have different associated UXs from each other.

FIG. 32 is an illustrative example of an implementation of a user interface for providing a categorization of a received request to be signed by a user.

FIG. 33 is an illustrative example of a method, 3300, for categorizing a received request.

FIG. 34 is an illustrative example of two types of approvals, wherein a first approval, 3400, corresponds to agreeing to transfer ownership of a token to a beneficiary or buyer, and a second approval, 3410, corresponds to accepting a positive review of a token

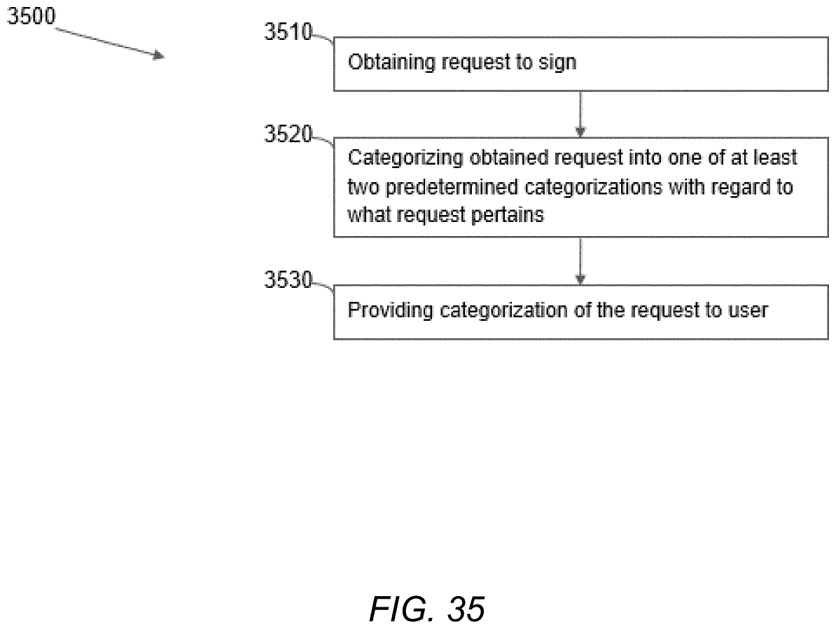

FIG. 35 is a flowchart of an exemplifying embodiment of a method 3500 performed by an entity, such as a wallet or associated with a wallet, for enabling a user, such as an owner of the wallet, to sign a request. FIG. 35 illustrates the method comprising a step 3510 of obtaining the request to sign and a step 3520 of categorizing the obtained request into one of at least two predetermined categorizations with regard to what the request pertains. FIG. 35 also illustrates the method 3500 comprising a step 3530 of providing the categorization of the request to the user. In this manner, a received request, requesting the user to sign something may be analyzed as to what it is the user is requested to sign. By categorizing the received request, the request is determined to pertain to a predetermined type, e.g., as exemplified above being a transaction, a nonce as part of a challenge/response, a known voucher, an unknown voucher, or unknown type of request. By then providing the categorization of the received request to the user, the user is made aware of what is requested of the user, thereby enabling the user to make a more conscious action and not being fooled or tricked into signing something the user does not intend to sign.

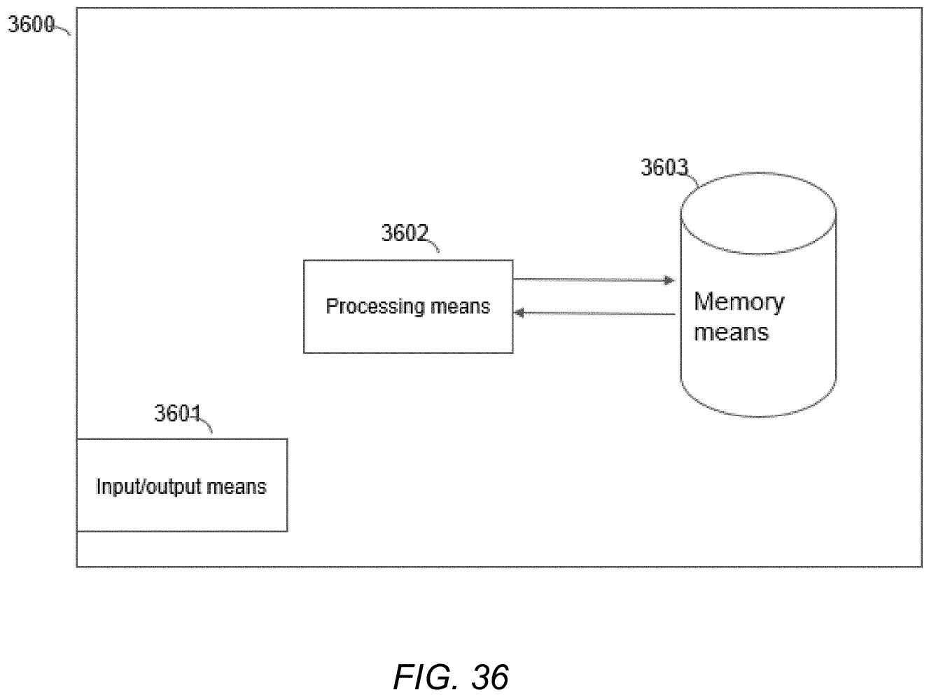

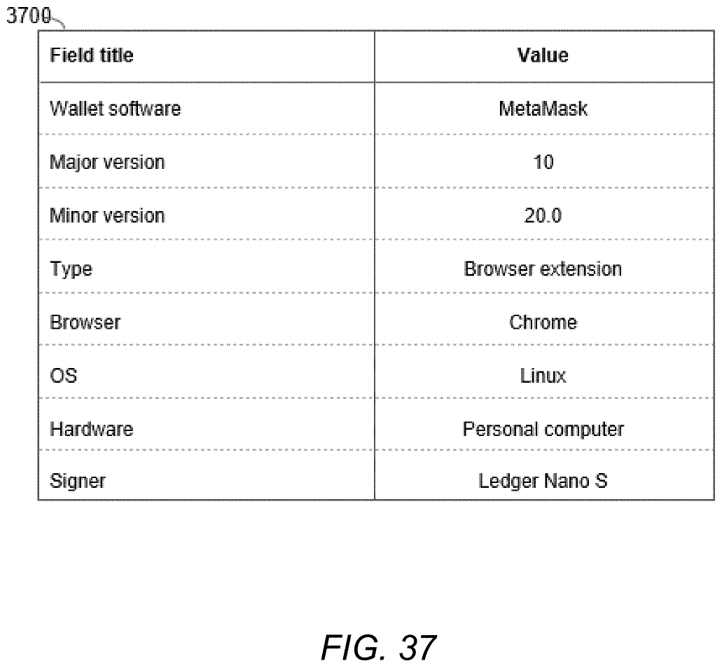

FIG. 36 block diagram of an exemplifying embodiment of an entity 3600, such as a wallet or associated with a wallet, configured for enabling a user, such as an owner of the wallet, to sign a request. The entity 3600 is illustrated comprising input/output means 3601 by means of which the entity 3600 may receive information and transmit or provide information to other units, devices and/or entities. FIG. 36 also illustrates the entity 3600 comprising processing means 3602 and memory means 3603, the memory means 3603 comprising instructions, which when executed by the processing means 3602 causes the entity 40 to perform the method(s) described herein.

### Blockchain Wallet for Adding Identifying Data to Transactions

### Wallet Identification Strings

A blockchain wallet may be identified by a user agent string, which in one embodiment may comprise a format adapted from that used by web browsers. See for reference “User Agent Accessibility Guidelines (UAAG) 2.0” by the World Wide Web Consortium, retrievable from https://www.w3.org/TR/UAAG20/.

For example, in one embodiment, blockchain wallets may produce a text string identifying:
The wallet software (for example, MetaMask, CoinBase, Brave)
The major and minor version number
The software type (for example, web browser extension, in-app browser, stand-alone executable)
The operating system (for example, Android, iOS, Windows, Linux)
The hardware type (for example, mobile, phone, tablet, computer, tv, hardware wallet)
The platform (for example, Apple iPad Mini, Asus Chromebook, Ledger Nano S)
Other identifying characteristics of the wallet

The string produced may then be appended as further data to a transaction as a string, possibly encoded in binary.

FIG. 37 is a block diagram providing an example, presented for illustrative purposes and not meant to be limiting in any way, of a possible embodiment of a data structure (3700) representing details concerning a blockchain wallet.

In other embodiments, the resulting string may be undesirably long, given that a cost is typically associated with transactions on a per-byte basis, and therefore a lookup table may be generated, translating a given string (henceforth referred to as a version string) to a shorter byte sequence (henceforth referred to as a version bytecode).

Where a version string or version bytecode representation of the blockchain wallet and execution system may be added to a transaction varies between blockchain platforms. For example, in Bitcoin, arbitrary data may be stored in a segwit part of the transaction, or as part of a BIP-16 pay-to-script-hash transaction comprising an opcode with the version string or version bytecode. In Ethereum, transactions comprise a data key/value pair, and the version string or version bytecode may be added there.

Watchful Bridge Validation of Transactions Through Version Strings

In an enhancement to the present embodiment, a first wallet may write a registration record to a blockchain or to a smart contract running on the blockchain, registering details concerning the wallet used for signing transactions related to blockchain addresses that the first wallet comprises. Subsequently, a consensus system of the blockchain, or functionality within the smart contract may determine that a transaction from an address purported to come from the first wallet may not feasibly have been generated by the first wallet. For example, the transaction may comprise a version string incompatible with the registration record indicating that the transaction was generated and signed by a second wallet of different origins to the first wallet, or the transaction may comprise details that could not have been generated by the first wallet. This may result in the transaction being rejected.

In an alternate embodiment, the transaction may be rejected by a watchful bridge. Watchful bridges are disclosed in a co-pending application Ser. No. 63/368,218 titled “Watchful Consensus Mechanism”, by Bjorn Markus Jakobsson and filed on Jul. 12, 2022.

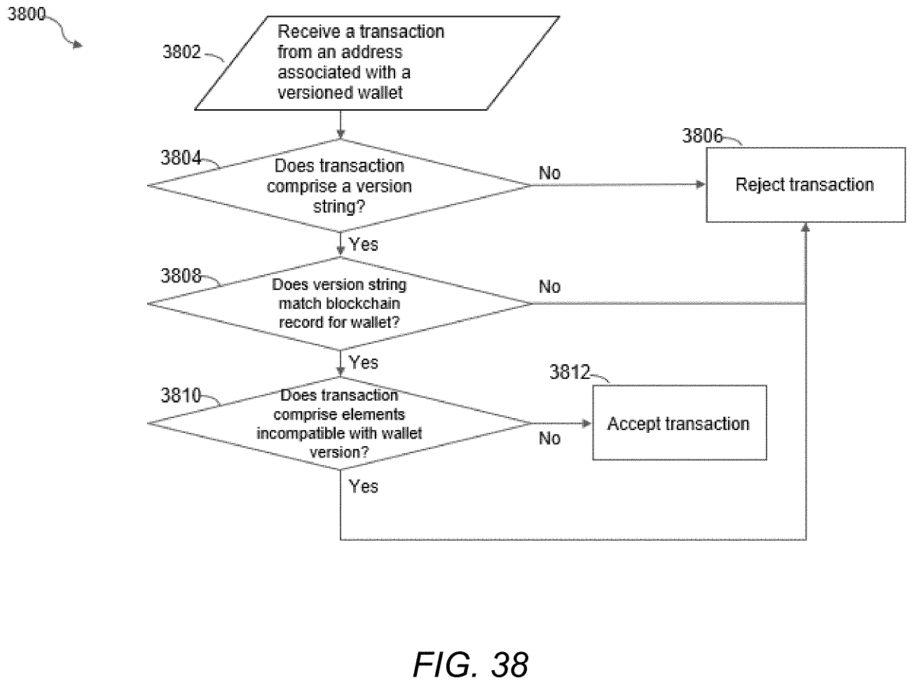

FIG. 38. presents a flow chart illustrating a method (3800) embodying a use of a version string lookup table and associated wallet capabilities for accepting or rejecting a transaction by a watchful bridge.

Actions may commence with the watchful bridge receiving a transaction from an address associated with a versioned wallet, as shown in step 3802.

Actions may proceed with the watchful bridge inspecting whether the transaction comprises a version string. If the transaction does not comprise a version string, actions may proceed to step 3806, and the transaction may be rejected. If the transaction does comprise a version string, actions may proceed to step 3808.

In step 3808, the watchful bridge may verify that the version string matches a recorded version on the blockchain for the versioned wallet. If the version string does not match the recorded version, actions may proceed to step 3806, and the transaction may be rejected. If the version string does match the recorded version, actions may proceed to step 3810.

In step 3810, the watchful bridge may inspect the transaction to determine whether it comprises elements incompatible with the recorded version of the wallet. In some embodiments, the watchful bridge may comprise a database comprising records marking which versions of wallets do or do not support specific transaction structures, addressing schemes, features, and other functionalities. If the transaction comprises elements incompatible with the recorded version of the wallet, actions may proceed to step 3806, and the transaction may be rejected. If the transaction does not comprise elements incompatible with the recorded version of the wallet, actions may proceed to step 3812, and the transaction may be accepted.

A wallet user may wish to upgrade or change their wallet, for example, by importing a private key associated with a blockchain address into a new wallet. In an enhancement of the present embodiment, a user may submit to the blockchain a transaction signed by the blockchain address using the versioned wallet indicating that at some point in the future the versioned wallet will upgrade or be in some way altered to a new wallet, said transaction comprising a new version string.

### Contractual Signing Evidence

One aspect of the disclosed technology is a system that provides security based on observations relating to transactions containing evidence that a transaction was submitted by a user using a wallet that displayed to the user a standard legal contract or terms and conditions, such as previously disclosed in co-pending application Ser. No. 63/370,362 titled “System and Method for a Blockchain-based Verifiable Click-Through Agreement” by Keir Finlow-Bates and filed on Aug. 3, 2022 and Ser. No. 18/045,400 titled “Instant NFTs and Protection Structure” by Markus Jakobsson et al. and filed on Oct. 10, 2022, ensuring that the user cannot later deny in court that they never saw the contract. One method for proving this would be to demonstrate that the user used wallet software that displays such contracts.

The wallet may add data to the transaction indicating the software build and version of the wallet used to submit the transaction, thereby providing on-chain evidence that the user utilized wallet software in which transaction details options were indeed made visible to the user. In a further embodiment, the wallet may also add data to the transaction indicating the user approval of a standard legal contract or terms and conditions, for example, by appending or including a hash of the transaction details options or associated legal contract signed using a private key held in the wallet.

In an embodiment of the present disclosure, a smart contract may accept or reject a transaction based on a presence or an absence of a component of the transaction indicating the transaction was generated by a wallet presenting to the user the standard legal contract and/or terms and conditions, and optionally that the user accepted the standard legal contract and/or terms and conditions, for example, by clicking an “I agree” button at the bottom of the standard legal contract and/or terms and conditions.

The smart contract may reject a transaction that is submitted by a wallet that does not display the standard legal contract and/or terms and conditions to the user. The smart contract may also reject the transaction if a recipient specified in the transaction is not authorized to receive assets that the transaction transfers, for example, because the recipient is on a ban list, as disclosed in co-pending provisional application 63/377,508, titled “NFT contract with banlist and allowlist to enforce honoring of royalties” by Keir Finlow-Bates and filed on Sep. 28, 2022. In an alternate example, the transaction may be rejected because the recipient address is not registered on the blockchain as an address generated by an acceptable wallet, for example, a wallet that displays legal contracts and/or terms and conditions to the user.

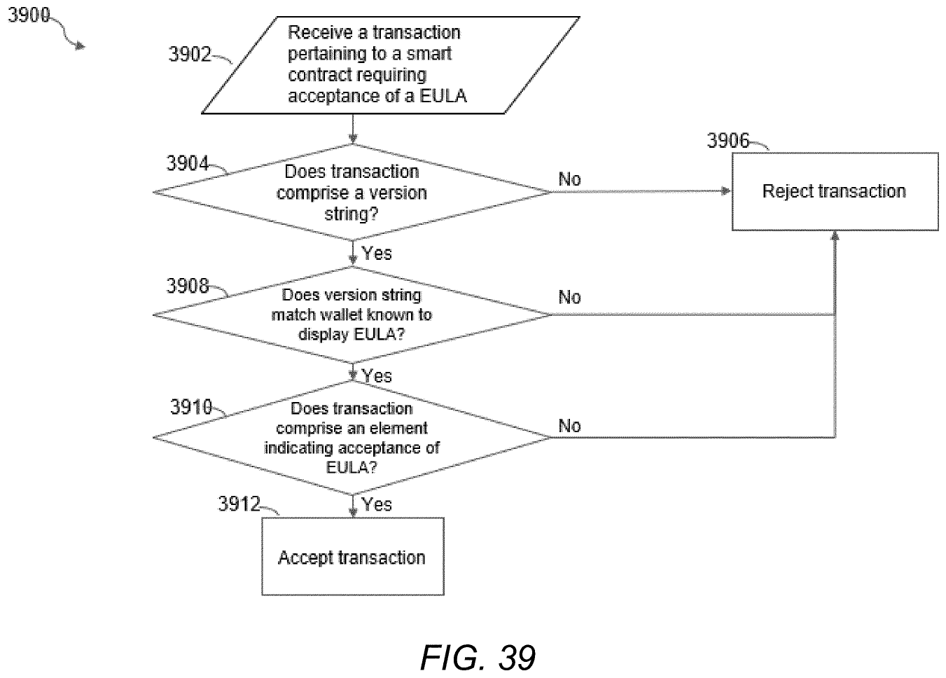

In FIG. 39 a method for ensuring a user has agreed to an end user license agreement (EULA) pertaining to a blockchain transaction is presented. An example, presented for illustrative purposes only and not meant to be limiting, may be an NFT smart contract that requires users to agree to copyright licensing terms relating to commercial use of underlying digital assets linked to NFTs instantiated by the NFT smart contract.

Actions may commence by a blockchain node, a validator, or a smart contract (henceforth “the validator”) receiving a transaction pertaining to a smart contract requiring acceptance of a EULA, as shown in step 3902.

Actions may proceed to step 3904, in which the validator may inspect the transaction to determine whether it comprises a version string or not. If the transaction does not comprise the version string, actions may proceed to step 3906, and the transaction may be rejected by the validator.

If the transaction comprises the version string, actions may proceed to step 3908, in which the validator may determine whether a version of the wallet indicated by the version string corresponds to a wallet that displays the EULA. If the validator determines that the wallet did not display the EULA, actions may proceed to step 3906, and the transaction may be rejected by the validator.

If the validator determines that the wallet did display the EULA, actions may then proceed to step 3910, in which the validator may inspect the transaction to determine whether it comprises an element explicitly indicating acceptance of the EULA. If the validator does not detect the element, actions may proceed to step 3906, and the transaction may be rejected. If the validator does detect the element, actions may proceed to step 3912, and the transaction may be accepted.

In other embodiments of the present disclosure, some of steps 3910, 3908 and 3904 may be optional.

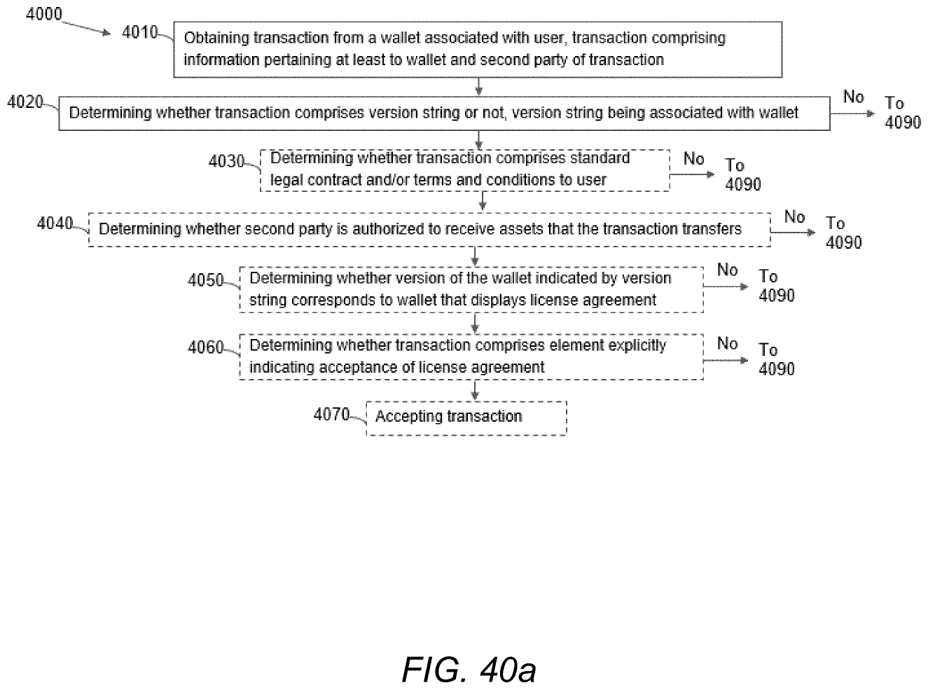

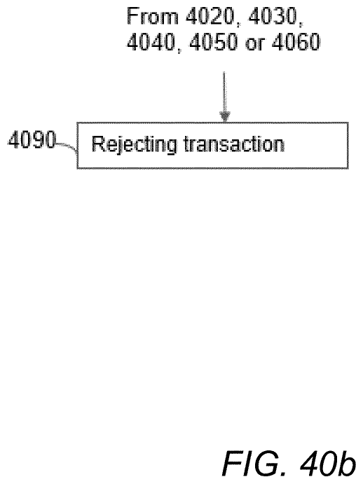

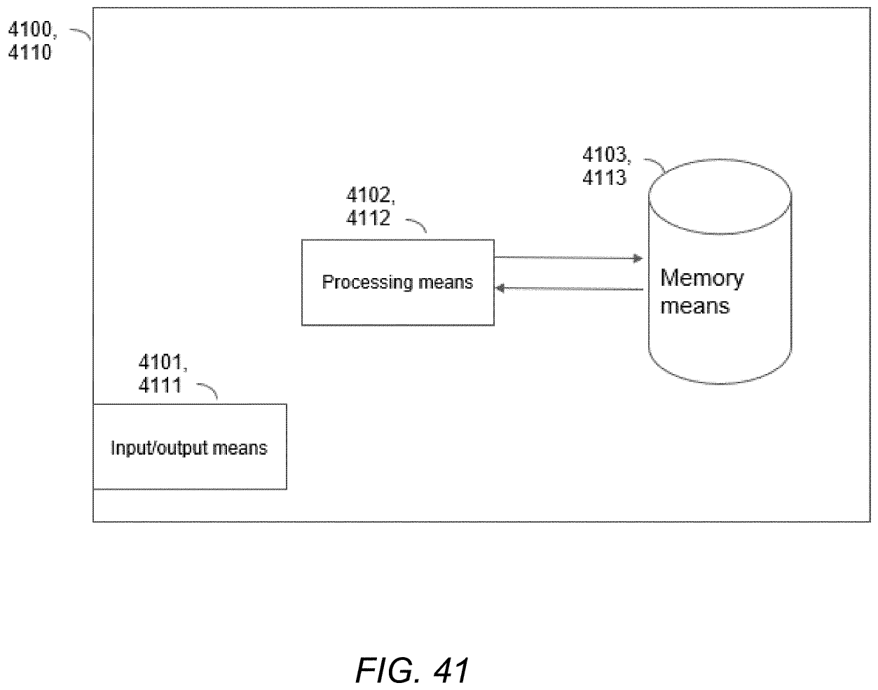

FIGS. 40a and 40b are a flowchart illustrating an exemplifying embodiment of a method performed by a smart contract for accepting or rejecting a transaction. FIGS. 40a and 40b illustrate the method comprising a step 4010 of obtaining the transaction from a wallet associated with the user, the transaction comprising information pertaining at least to the wallet and a second party of the transaction, and a step 4020 of determining whether the transaction comprises a version string or not, the version string being associated with the wallet. In the case when the transaction does not comprise the version string, FIGS. 40a and 40b illustrate the method comprising a step 4090 of rejecting the transaction. FIGS. 40a and 40b also illustrate the method possibly comprising a number of additional steps 4030-4060. Each of these steps is optional and the method may comprise all of them, none of them or any combination of them. FIGS. 40a and 40b also illustrate the method comprising an optional step 4070 of accepting the transaction. Accepting the transaction may be performed when at least the transaction comprises the version string associated with the wallet. Depending on which steps of 4030-4060 are comprised in the method in any specific embodiment, corresponding conditions should be fulfilled in order to accept the transaction. Merely as an illustrative example, if the method in an embodiment comprises step 4030 of determining whether the transaction comprises a standard legal contract and/or terms and conditions to the user, and when the transaction does not comprise the standard legal contract and/or terms and conditions to the user; then the condition that the transaction comprises the standard legal contract and/or terms and conditions to the user must be fulfilled in order to possibly accept the transaction as defined by step 4070.

FIG. 41 is a block diagram of an exemplifying embodiment of a smart contract and/or a wallet configured for accepting or rejecting a transaction. FIG. 41 illustrates the smart contract 4100 or the wallet 4110 comprising input/output means 4101, 4111 by means of which the smart contract 4100 or the wallet 4110 may receive information and transmit or provide information to other units, devices and/or entities. FIG. 41 also illustrates the smart contract 4100 or the wallet 4110 comprising processing means 4102, 4112 and memory means 4103, 4113, the memory means 4103, 4113 comprising instructions, which when executed by the processing means 4102, 4112 causes the smart contract 4100 or the wallet 4110 to perform the method described herein. The smart contract 4100 or the wallet 4110 may for example be, or be implemented in, a server, a computer, a cloud server or any entity or arrangement comprising processing means for executing the method.

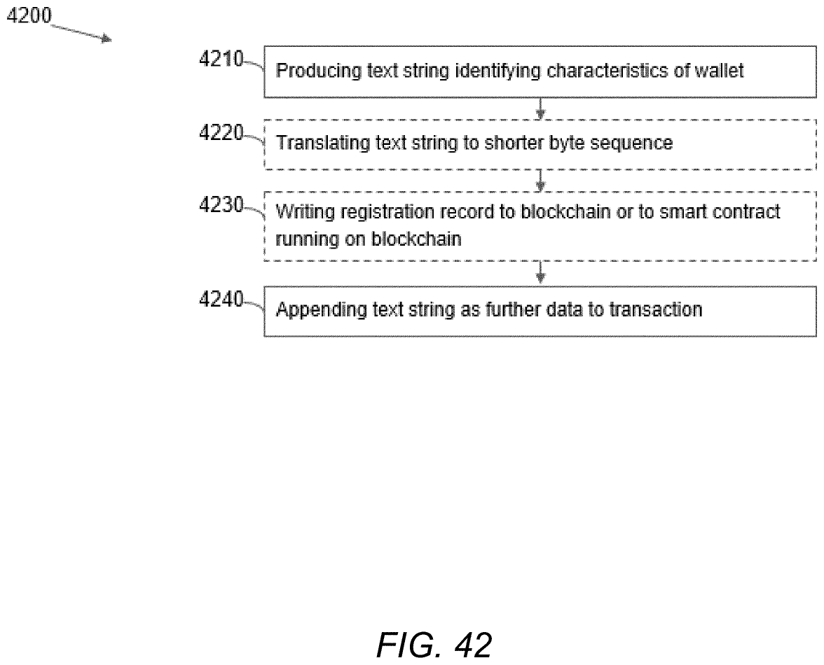

FIG. 42 is a flowchart illustrating an exemplifying embodiment of a method performed by a wallet for accepting or rejecting a transaction. FIG. 42 illustrates a method 4200 comprising a step 4210 of producing a text string identifying characteristics of the wallet and a step 4240 of appending the text string as further data to the transaction. FIG. 42 also illustrates the method comprising an optional step 4220 of translating the text string to a shorter byte sequence. The method 4200 may comprise another or further optional step 4230 of writing a registration record to a blockchain or to a smart contract running on the blockchain.

### Automated Wallet and Transaction Control

The disclosed technology can be expressed as a system that can be implemented using one or more elements that provide functionality such as the following:
An interface that enables the general user experience of a Web2-like social media and wallet provisioning and management interface and asset control interface for the user, enabling a large population of non-specialist users to use Web3 technology without having to modify their principal workflow, given familiarity with Web2 technology such as the iOS centric Apple™ wallet. For example, this means that resources may be made available to a user who authenticates to the wallet using biometrics, without exposing such biometric information or associated templates to the public. This is not currently provided by today's Web2 or Web3 technologies.
Capabilities to adopt and deploy new blockchain addresses across a spectrum of user needs from custodial to non-custodial service providers. This requires generation of and management of keys, in a manner that is transparent to the end user. This is not currently provided by today's Web2 or Web3 technologies. For example, when a new user expresses interest in joining the crypto Web3 space, their first challenge is funding their entrance so that they can make purchases, exchanges, and pay network transaction fees; all of which requires at least one crypto wallet address. Wallet addresses may be provided to the users in an opaque manner with friendly-names, such as “Alice's Wallet”, where the user need not be familiar with specific wallet addresses or with complete transparency where the user can see and manage the addresses specifically, with or without associated friendly-names. The addresses may also be custodial or non-custodial, where a custodial wallet is one where the private keys are managed by an authorized third-party.
A service for enabling different types of hot/warm/cold addresses for serving a spectrum of user needs. This benefits from a user interface to enable the user to visually understand classifications and maintain these in a practical manner; such an approach was disclosed in co-pending application Ser. No. 63/280,184 titled “Wallet User Interface for Management of Interaction” by Markus Jakobsson and filed on Aug. 22, 2022. Moreover, this approach benefits from the automated management of wallet contents, including a multiplicity of wallet addresses. Such methods were disclosed in co-pending application Ser. No. 63/370,768 titled “Profile-Based Wallet Selection and Use” by Markus Jakobsson and filed on Aug. 8, 2022, co-pending application Ser. No. 63/370,365 titled “Partitioned Address Spaces in a Single Blockchain Wallet” by Keir Finlow-Bates, Steve Gerber, and Markus Jakobsson and filed on Aug. 3, 2022, and co-pending application Ser. No. 63/314,424 titled “Crypto Wallet Improvement Technology” by Markus Jakobsson and Keir Finlow-Bates and filed on Feb. 27, 2022. Further benefits and novel techniques will be disclosed herein. The disclosure in co-pending application Ser. No. 63/314,424 titled “Crypto Wallet Improvement Technology” by Markus Jakobsson and Keir Finlow-Bates and filed on Feb. 27, 2022, describes how to generate and maintain a state of a wallet, including a collection of wallet identifiers, such as cryptographic keys, as well as methods for user interfaces suitable for such wallets. These approaches can be combined with each other and with the techniques disclosed in the instant invention, as will be appreciated by a person of skill in the art.
A service for setting wallet and transaction policies in an automated, pre-configured, AI-managed, or user-configured manner to reduce risk exposure during transactions or from breach. For example, a specific policy may require that any non-fungible token with a value that exceeds 1 ether be segregated to a new wallet with no other assets in an effort to shield that token from the activities of a more active wallet with increased exposure to risk. An AI-managed policy system may take into account a user's appetite for risk, such as their total investment size, level of activity, and security habits to set policies and thresholds to best suit the individual. For example, an AI-managed policy system may detect that users new to Web3 are far more likely to fall for click-link scams that expose a particular token, token type, or coins; and therefore, the AI may configure the various policies to ideally protect the user's assets or transactions from harm.
A “watchful AI” that monitors activity to provide recommendations and to reduce the risk of loss or breach. Similar to the AI-managed policy settings, a watchful AI system may be provided to assist the user in finding assets best suited for purchase or trade. For example, an AI weighing the individual's interests based upon their history, and the transaction history of others, may provide a purchase recommendation to a user based upon the actions of other similar users. Similarly, the watchful AI may strongly recommend against an action that is, for example, particularly risky from a security perspective.
A data mining, logging, and analysis system to provide beneficial data to the watchful AI, to the users in the form of recommendations and security advice, and the operating enterprise in the form of actionable or saleable intelligence. Public blockchain networks are data rich ledgers that may be data mined for a variety of purposes. For example, the aforementioned ability to identify the actions of similar users, or to identify patterns and histories of scammers that follow similar patterns from scam to scam, or to identify the types of actions that cause unusual transactions that bleed assets from wallets. The ability to monitor and match active “approvals” on the blockchain network may provide the system with an ability to prevent an asset from entering a wallet and being immediately transferred by an active approval to a scam mer.

The above benefits and goals are merely illustrative, and additional applications, techniques and benefits are disclosed herein.

### Using Consensus-Based Artificial Intelligence

The disclosed technology may utilize the notion of watchful actions, e.g., as carried out by bridges or using consensus mechanisms, was disclosed in co-pending application Ser. No. 63/365,936 titled “Using Watchful Bridging for Blockchain Fraud Prevention” by Markus Jakobsson, Stefan Dufva, Keir Finlow-Bates and Guy Stewart and filed on Jun. 6, 2022, and co-pending application Ser. No. 63/368,218 titled “Watchful Consensus Mechanisms” by Markus Jakobsson and filed on Jul. 12, 2022. Watchful actions may also be performed in other manners, e.g., using a Decentralized Autonomous Organization (DAO) or a trusted authority, such as a consumer representative selected by a user associated with a transaction to which a watchful action is taken. In one embodiment, the watchful mechanism is implemented using a consensus mechanism by a quorum of entities that operate an AI that may be modified using another consensus mechanism. We refer to this as a Consensus-driven AI (CAI). This notion was introduced in co-pending application Ser. No. 63/232,728 titled “Secure and Intelligent Decentralized Technology” by Markus Jakobsson, Stephen C. Gerber, and Ajay Kapur and filed on Aug. 13, 2021. It can be implemented using machine learning (ML) wherein each participating node determines new weights for the ML engine and the nodes collectively agree on what weights to use, based on consensus.

In one embodiment, a wallet comprises a local application, executed on a user's computer such as mobile phone or laptop. In another embodiment, the wallet is hosted online, e.g., as a cloud application, and is accessed by the user over a network such as the Internet. The wallet may also be provided as a Web2.0 style service, or hosted by a quorum of collaborating participants, potentially operating using consensus mechanisms. The wallet application, independent of the location of execution and the manner a user accesses it, would preferably perform tasks such as new user onboarding, user credentialing, policy setting, wallet and asset creation and management, and transaction approvals, which may be supported by policies that may be set by a user or a representative thereof, or learnt by an AI component tasked with protecting the user in a manner that is consistent with the user's needs, actions, and exposure to risk; this may be a CAI, for example.

### Setting Degrees of Automation

In one embodiment, the disclosed technology determines a degree of automation based on a risk assessment, and performs an action using the determined degree of automation; additionally, the disclosed technology may determine a degree of approval interaction from a user or administrator, such as requiring an extra level of “are you sure” approval or the use of additional approval techniques such as, but not limited to, two-factor authentication. For example, a wallet user may have engaged with a first entity (such as a merchant, a peer wallet user, etc) some number of times without problems, where an example problem may be an action that is reported as undesirable by the wallet user, such as fraud. This may be recorded as a positive recommendation score associated with the first entity. The wallet user may also have utilized a given smart contract in the past and approved of it, whether explicitly (such as providing positive feedback) or implicitly (by not providing negative feedback), thereby endorsing the smart contract. This may be recorded as a positive recommendation score associated with the smart contract. Another smart contract that is more restrictive, i.e., safer, for the wallet user than a smart contract with a positive recommendation score would also be considered having a positive recommendation score. Engaging again with an entity with a positive recommendation score, or transacting in a manner governed by a smart contract with a positive recommendation score is considered low risk, whereas engaging with an entity with a low recommendation score (including no recommendation score at all) or transacting in a manner governed by a smart contract with a low (or no) recommendation score is considered higher risk. The risk score is computed based on one or more recommendation scores associated with the wallet user, or optionally, with the wallet user and one or more recommendation scores associated with one more other users trusted by the wallet user. The risk score is compared with one or more thresholds and an action is taken based on the result of the comparison. If the risk score is very low, such as below 0.2, then an automation degree is set to fully automatic, which may mean that an agent associated with the wallet of the wallet user will perform actions on behalf of the wallet user to facilitate a transaction, such as a purchase. This may, for example, mean that the wallet user simply has to indicate a wish to perform the transaction, and no further confirmation or action is needed for this to be effectuated. However, if the risk score is higher than this very low threshold, but still lower than a second threshold such as 0.42, then the transaction may be performed with a medium-degree of automation, e.g., an agent may perform some tasks on behalf of the wallet user. If the risk score is yet higher than the medium level, but lower than a very high threshold value such as 0.9, then the degree of automation is set to none, meaning that the user has to perform multiple actions to complete the transaction. If the risk score exceeds the very high level, e.g., 0.9, then the degree of automation is set to a negative level, meaning that not only is no automation performed by the agent, but in addition, further user actions are required by the wallet user to approve and finalize the transaction. Examples of such actions may include actions selected by the wallet user at a setup stage, and may include second-factor authentication (2FA) methods, a need to verify the desirability of the transaction with additional users associated with or representing the wallet user, or the involvement of a “cool-off period”, e.g., a period of say 12 h after an approval of the transaction is received from the wallet user until said approval is processed by the wallet of the wallet user, thereby causing the completion of the transaction. If the wallet user or associated users should select to terminate the transaction before such time of completion, the transaction approval would be undone and the transaction not completed. If the wallet user is a child and the transaction requested is of a value exceeding a threshold value set by a parent of the wallet user (we may refer to this user as the admin) then the admin may be requested to approve the transaction before it takes place. A person of skill in the art will recognize that these are merely illustrative and non-limiting examples of machine-assisted control of automation degrees. In some implementations, the determination of the risk score is performed using an AI, or using machine learning (ML) components. The determination of automation may be performed by the wallet of the wallet user, or by a device used by the wallet user, including a cloud service engaged by the wallet user for protection of the wallet user and streamlining of transactions involving the wallet user. The entity that determines the degree of automation may be implemented as a CAI. In some embodiments, the code for the determination of the degree of automation is executed in the wallet of the wallet user, but is maintained, evolved, stored, and improved by a collection of entities that together comprise a CAI. The wallet may have a configuration that may be one or more values identifying the risk profile of the wallet user, where these one or more values are also provided as an input to the computation of the degree of automation. This configuration may identify a wallet (or portion thereof) to be a hot wallet, a warm wallet, or a cold wallet, for example. A cold wallet may require much more stringent security, and an associated greater cumbersomeness of use, than a warm wallet, which may in turn be more secure but less convenient to use than a hot wallet. This corresponds to different risk scores for these three different types of wallets, where the cold wallet is associated with the greatest risk score, causing the most restrictive usage. In one embodiment, individual risk scores are assigned to different items of one and the same wallet, thereby creating a wallet encompassing the entire range of functionality from a cold wallet to a hot wallet within one and the same wallet, where said same wallet may be a physical construct or merely a logical construct. The risk scores may be scalars, e.g., a value from 0 to 100 identifying the risk associated with the token or tokens to which the risk score is associated. Risk scores may also be vector values, e.g., comprise multiple component values where one component value may govern one aspect of a security solution such as whether 2FA technology is needed to cause an ownership transfer, whereas another component value may govern another aspect of a security solution, e.g., whether a user needs the permission of an admin to take a given action relative to the token. Thus, instead of talking about a wallet being “hot”, “warm” or “cold”, it makes sense to speak of tokens contained in a wallet being “hot”, “warm” or “cold”. Here, a “hot” token is one that can be transacted in a manner as if it were stored in a hot wallet, whereas a “cold” token requires many more user verifications and approvals to be transacted. In some embodiments, a wallet may only display hot and warm tokens, while cold tokens are not even possible to determine the presence of unless a specific user action is taken, e.g., a 2FA action, authentication using a physical token, etc. The contents of a wallet may be clustered in terms of their classification (such as “hot”, “warm” and “cold” or other risk-related classifications) and rendered in user interfaces based on such clustering. A smart contract in a “warm” partition of the wallet (i.e., comprising all the warm tokens) may be granted limited access to the warm and the hot tokens, but may have no access rights at all as far as cold tokens are concerned.

Trust-supporting techniques like 2FA in transactions or delays in transaction completion focus on the wallet holder—the entity being protected. The system may also add a layer of trust measurement to the transaction elements themselves instead of relying exclusively on trust monitoring by the wallet holder. For example, the history of a seller's past transactions, similarity of price point and transaction terms for similar products or services, frequency of past fraud reports on the product/service class, locations of transaction participants, and other emerging and/or AI-observed correlations with trust or fraud. These various attributes of the transaction and participants can constitute a trust rating by transaction. Ratings of attributes can range from a trusted party's assessment to an automated, distributed voting mechanism. An example of the first is an industry-standard, trusted third party making seller trust ratings publicly available. An example of the second is group affirmation based on a persistent public record of successful transactions by a seller.

In one instantiation, a wallet or wallet holder could be designated as able to complete transactions of only specific, pre-defined trust ratings. For example, a wallet held by a new wallet holder within an end user-friendly wallet system may initially be authorized only for highly-trusted transactions, transactions in which multiple transaction elements indicate high trust. Over time, those limits may change. In another example, a wallet holder may be limited by a guardian to protect a wallet holder from their own poor decisions, e.g., a family member attempting to protect a child or at-risk senior citizen. Rules governing what to allow a given user to do with or without further steps of confirmation and approval (e.g., by other users, such as a guardian or system administrator) can be configured manually and added to a user profile, which may be resident in a wallet. The protective measures can also be expressed by an AI or machine learning component that identifies risks based on user behaviors, the type of applications a user has, the type of transactions the user performs, the consistency of behaviors, applications and transactions, e.g., over time; demographic information about a user, and optional rules configured at the beginning of the use of a wallet. An example rule may identify actions that a child of 12 years old may take, based on societal norms, parent input, observed actions of the user, such as an attraction to violent imagery and games, local laws, and more. As the child ages, some of these rules may automatically modify, e.g., to enable the child to access age-appropriate material unless indications of risk arise.

### Generating and Maintaining Crypto Addresses

In one embodiment, the system is configured to provide new users with crypto addresses. The addresses may be made available to the user in a transparent manner or as a managed-service where the user is not exposed to the underlying addresses, but rather a proxy solution where, for example, multiple wallet addresses may be grouped by service or given friendly names for ease of use. Each address may be configured to provide a specific service, such as a cold, warm, or hot wallet. A cold wallet is a wallet that is very rarely interacting with the surrounding world, commonly in order to shield the associated assets from theft or other abuse. A hot wallet is a wallet that is used to perform large numbers of transactions, many of which may be low-value or require the interaction with untrusted entities, such as other wallets, their owners, and untrusted smart contracts that may comprise malicious code. A warm wallet is a wallet that may be used to interact with limited numbers of low-risk entities, and which may be used to transfer assets to or from hot and cold wallets, thereby acting as a buffer. Different wallet addresses with different purposes or usage objectives, as described above, may be automatically managed and generated, whether from a single initial seed phrase or otherwise, as described in co-pending application Ser. No. 63/314,424 titled “Crypto Wallet Improvement Technology” by Markus Jakobsson and Keir Finlow-Bates and filed on Feb. 27, 2022. Whereas we explain the classification of wallets as having these three types (hot, warm and cold), this is merely for purposes of illustration, and any number of wallet types may be used by an entity controlling the assets of these wallets, where the different wallets may be used to shield the owner from risk. In the disclosed system, these multiple wallets may be executed by and maintained by one or more pieces of hardware. This one or more pieces of hardware may have a common user interface with which the pieces of hardware receive instructions from authorized users. The individual wallets may be executed in different physical components, insulated from each other by means of computational separations, such as different sandboxes, different compartments of a trusted execution environment (TEE), where TrustZone is one example TEE. Alternatively, a given wallet may be generated from one or more seed values, upon a user request to access the contents. The location of the generation may be in a TEE or in another environment that is secured against malware. After such a wallet has been generated from its seed values, the user is given access to the contents, e.g., using one of the user interfaces (UIs) described herein, prompting one more actions to be taken. Examples of such actions may include the transfer of wallet contents to other wallets, whether owned by the same owner or another user. After a user has completed the access to the wallet contents, the wallet state may be erased from the secure environment at which it was executed, enabling another wallet to be built there in its place.

As new crypto addresses are generated, they are maintained by the wallet in a manner that is preferably transparent to the wallet user, unless the wallet user enters an admin mode in which technical details such as crypto addresses are disclosed. An example crypto address is a public key used for assignment of ownership rights to tokens, whether non-fungible tokens (NFTs) or fungible tokens, i.e., crypto funds. Actions can be taken on tokens assigned to a crypto address by using a corresponding private key to generate a digital signature related to the token, e.g., for purposes of transferring ownership or access rights of the token. This private key may be associated with one or more wallets, e.g., of a given user and her family members. Different tokens can be controlled by different users by the distribution of the private keys that can be used to generate digital signatures related to the tokens, where the owner of the tokens is identified using the public key related to the private key used for signing. The permissioning may use the technology disclosed in co-pending application Ser. No. 63/311,283 titled “Wallet User Privacy and Permissions Interface” by Perry R. Cook and Markus Jakobsson and filed on Feb. 17, 2022. Access rights can be associated with users of wallets, as described above. They may also be associated with tokens, as disclosed in co-pending application Ser. No. 63/365,269 titled “Directed Acyclic Token Structure” by Markus Jakobsson and filed on May 23, 2022, in which case the management of access may be performed by an agent associated with the token that is considered the owner of a token.

### Governing of Transactions Based on Risk Classifications

Cold wallets are typically where users and enterprises maintain their most valuable assets. Cold wallets typically see a very small volume of transactions in an effort to shield the cold wallet assets from harm. Hot wallets are the opposite of cold wallets, they are where most transactions occur and where the least valuable assets should be kept. As assets increase in value, they are typically moved from hot wallets to cold wallets until the time comes to sell or transfer the assets—at which time they are often moved back to hot wallets. When utilized properly, cold wallets are only ever exposed to transactions with the owner's hot wallets, thereby protecting them from malevolent transactions built by 3rd-parties. Warm wallets are an in-between where assets of high value might be transacted with a trusted third-party, such as a well known marketplace or exchange. Each address may also be configured with custodial or non-custodial secret key access.

For example, a service may issue an address that is accompanied with the secret key or mnemonic phrase for the user to store securely. This service may be provided in part by a wallet, and/or in part by an external server. The keys may be generated at the server or at the user's client computer for safety and liability reduction. The server may also generate secret keys for user addresses that are maintained by the server operating company. The server typically generates secret keys in a secured computation and storage environment. Whether the keys ever are allowed to be exported from this secure environment are at the discretion of the server configuration and/or user request. Access to secret or “signing keys” that are held at the server may be enabled through traditional Web2 techniques, such as passwords, passcodes, hardware keys, 2-factor authentication techniques, biometrics, and so on. User access to keys maintained at the client side may also be protected by traditional Web2 techniques, as the MetaMask™ browser extension currently protects its mnemonic phrase and signing keys with a simple password. The creation and maintenance of different types of wallet addresses with different purposes may coincide with types of key access and the appropriate level of protection that each type of wallet may deserve. Keys may also be protected using biometrics, e.g., encrypted using symmetric keys that can be derived from stored data if the valid biometric input is provided, e.g., matching a biometric token. The encrypted keys may be decrypted by a user providing the right biometric input, causing the correct decryption of the encrypted key; the resulting key can then be used to generate a digital signature, e.g., for the transfer of the associated token. One way to use biometric tokens is disclosed in co-pending application Ser. No. 63/273,921 titled “Biometric Authentication using Privacy-Protecting Tokens”, by Markus Jakobsson and filed on Oct. 20, 2021; another approach is disclosed in co-pending application Ser. No. 17/808,264 titled “Token Creation and Management Structure” by Markus Jakobsson and Stephen C. Gerber and filed on Jun. 22, 2022.

For example, Alice, a long-time Web2 user, arrives at the server's remote welcome page and desires to create her first Web3 crypto wallet so that she can invest in a popular cryptocurrency. A typical first-time user like Alice is likely to only need one crypto address, such as one hot wallet address, and she may be provided a choice of whether to use a non-custodial or custodial wallet and how to protect it. Examples of how to protect the wallet may comprise requiring biometrics for access, or a password; to require second-factor authentication (2FA) or multi-signature approvals for any actions leading to a transfer out of tokens; to require a third party to approve transactions of select types before they can take place; etc. In this example, Alice elects a crypto address with signing keys maintained only by the server and accessible solely with a password, with no further protective measures. Alice might be presented with a warning that this is a very easy solution to use, but also the most risky—particularly if her password is easily replicated by a 3rd-party, e.g., brute-force guessed. At the same time, she might be advised that the system will grow with her as she learns the Web3 space. For example, once Alice has assets above a threshold, the system may encourage Alice to upgrade her security posture with a stronger password, 2-factor authentication, or even a hardware or “cold wallet.”

In another example, Bob sets up his first “account” on the platform and elects to have the platform auto-manage wallets on his behalf. The “account”, in this example, might not be a wallet address, but a typical Web2 account created on a private server with an email username and password. Similar to the use of a Yubikey™ hardware fob, or other 2FA technology, Bob's account is accessed with a combination of password and hardware wallet which Bob uses solely to sign messages, or data transactions, that prove he is in possession of the hardware wallet. The service providing access to the contents of the wallet, which may be a trusted entity, a Decentralized Autonomous Organization (DAO), or operated by a quorum of parties that operate using a consensus mechanism, may operate the verification of the 2FA.

In one possible embodiment of the present disclosure, a DAO may have final control over the contents of the wallet, and as new addresses are created for the wallet, these may be added to a list maintained in the DAO. Assets may be registered against the address of the DAO, and the DAO may internally keep track of which wallet address is the owner of which asset. Subsequently, a first asset registered against a first address of the wallet may only be transferred using a transaction signed by the private key of the first address submitted to the DAO. The transaction may be held in escrow until it is approved by a quorum of DAO voters, or may be executed only after a predetermined time period has passed unless vetoed by a quorum of DAO voters.

The verification of the 2FA may also be operated by a third party. The approach can use the technology disclosed in co-pending application Ser. No. 63/314,293 titled “Second Factor Improvement Technology” by Markus Jakobsson and Keir Finlow-Bates and filed on Feb. 25, 2022, for example. The system automatically configures a trio of hot, warm, and cold wallets on Bob's behalf, that it maintains automatically based upon Bob's activities and the value and accessibility needs of the assets. The automatic maintenance may cause the automated transfer of an asset from a hot wallet to a cold wallet if its value exceeds a threshold value, such as 1 BTC, where this threshold value may be set by Bob or determined, by the system, by observing the risk profile of Bob, where this risk profile is computed based on transactions performed by Bob, settings of Bob's wallet such as the transaction and privacy policies, and using a set of weights for a machine learning (ML) algorithm operated by the service provider, and generated from observing other accounts, attempts to abuse of such accounts, and a determination of what countermeasures did or would likely have stemmed such abuse attempts. The platform also created a special wallet address for Bob to store his “soul-bound” or “social” tokens, as described in co-pending application Ser. No. 17/808,264 titled “Token Creation and Management Structure” by Markus Jakobsson and Steve Gerber and filed Jun. 30, 2022. The soul-bound tokens are special in that they relate directly or indirectly to Bob.

An embodiment of an auto-managed wallet platform may comprise a use of a multi-factor authentication gateway for a user, a private key held in a first trusted execution environment, a one-time hash pad seed held either in a second trusted execution environment, either in the cloud or in a hardware device held by the user, and a proxy smart contract on a blockchain that acquires, hold, and dispenses of assets on the user's behalf.

In the embodiment, when a user signs up for a wallet they provide a username and password, and optionally configures other MFA mechanisms. A private key is generated and stored securely in a first trusted execution environment, which may only sign transactions on behalf of the user if instructed to do so after the user has authenticated. A one-time hash pad seed, S, is generated and stored securely either in the first trusted execution environment, or optionally in a second trusted execution environment, and a predetermined number of passwords, P, may be generated by repeatedly hashing the one-time hash pad seed with a cryptographic hash function, f( ), and with an Nth password pN corresponding to fP−N(S). A smart contract may be deployed and initialized with PN. Note that the seed S is therefore the Pth password, as fP−P(S)=f0(S)=S.

Subsequently, the user may authenticate to the first trusted execution environment and may submit a transaction to the first trusted execution environment for transferring an asset, for example, to transfer a token previously transferred to the smart contract. The trusted execution may request a current one-time password from the one-time hash pad, which initially may be password p2 and in general for a Kth transaction may be password pK=fP−K(S). In one implementation of the embodiment the user may obtain the password pK from the second trusted execution environment for inclusion in the transaction. In a second implementation the first trusted execution may comprise the second trusted execution environment, and may calculate the password pK for the Kth transaction itself and ensure that the transaction comprises the password. The first trusted execution environment may then submit the transaction to the smart contract.

The smart contract may then determine that a hash of the password supplied in the transaction is equivalent to a current password stored in the smart contract, may verify that the transaction has been signed by the private key, and may subsequently execute the transaction, for example, by transferring the asset. The smart contract may then update the current password with the password supplied in the transaction.

If the hash of the password supplied in the transaction is not equivalent to the current password stored in the smart contract, the smart contract may reject the transaction.

### Transferring Assets Between Custodial and Non-Custodial Wallets

Cindy is a third wallet user, who uses a custodial service for the storage of tokens, i.e., a service that manages Cindy's private keys associated with the crypto addresses used to manage the tokens Cindy owns. At one point, Cindy wishes to transfer her tokens to a non-custodial wallet, e.g., a wallet Cindy runs on hardware such as her phone, a USB fob, or a laptop. To the greatest extent possible, Cindy wishes to retain the same user interface (UI) as she is used to from the custodial service. The custodial service may offer to export a set of parameters used for the configuration of the non-custodial wallet(s) Cindy creates, where these parameters are used to set up a UI and a user experience (UX) resembling to a very large extent the experience of the custodial wallet. The export of these parameters can be performed at a charge. The parameters may be expressed as a digital container that can only be read by a digital rights management (DRM) module of a pre-approved type, or a trusted execution environment (TEE) that is pre-approved, e.g., by the custodial service or a sponsor thereof. In one embodiment, Cindy decides to partition the tokens previously held by the custodial service into multiple wallets, e.g., one hot wallet and one cold wallet. The cold wallet may be allowed to see icons representing the tokens in the hot wallet, but have no access rights to these, except the right to initiate transfer requests from the cold wallet, such transfer requests being presented to Cindy when she accesses the cold wallet next. Cindy may also be notified about the requests, e.g., by an SMS, as a connected wallet requests access. Such SMS requests may be limited to wallets operated by collaborators of Cindy's (such as Cindy's children or colleagues), as opposed to a hot wallet operated by Cindy herself. When Cindy accesses the wallet to which the requests are made (which does not have to be a cold wallet), she is provided with information about what tokens are requested, from what wallets, and by what user (as a wallet may have multiple authorized users). She can then approve the request (e.g., transfer the ownership rights or access rights to the requesting party), or approve a modified request (e.g., change the ownership transfer request to a borrowing request, and then approve the modified request), or deny the request. She can cause some parties or some requests to be automatically blocked onwards, or blocked for a set amount of time, or blocked for requests associated with specified tokens (e.g., based on their content, their value, etc.); she can also create rules to automatically approve requests of pre-specified types. These rules can be evaluated each time Cindy starts the wallet to which requests are made, or they can be evaluated and effectuated by a custodial service to which Cindy selectively transfers access rights to at least some tokens. Thus, Cindy may use both a non-custodial wallet and a custodial wallet at the same time, and the user experience Cindy is presented with may be designed to mimic what Cindy would have seen and experienced if there was no such partition. This cannot always be achieved completely, but it is desirable to make the two UXs as similar as possible to simplify the use of a new configuration by a user of an old configuration. Example techniques for doing this are disclosed in co-pending application Ser. No. 63/303,569 titled “Chameleon User Interface Method” by Markus Jakobsson and Stefan Dufva and filed on Jan. 27, 2022. The use of ML can be applied to approve, deny or modify requests, both for custodial wallets and non-custodial wallets, and the ML weights and rules used can be transferred from a custodial wallet to a non-custodial wallet when transferring control. Transfer of control can also be made from a non-custodial wallet to a custodial wallet, analogously in manner to the description above but in the opposite direction. A custodial wallet service provider may request a payment to import configuration settings and apply them to a given configuration. Configuration settings may also be provided by third-party service providers, as disclosed in co-pending application Ser. No. 63/303,569 titled “Chameleon User Interface Method” by Markus Jakobsson and Stefan Dufva and filed on Jan. 27, 2022.

### Automation of Request Responses

In one embodiment, the management of wallet addresses and transactions is aided by the existence of a set of rules or policies. Rules may exist for the automated processing of transactions, such as those that may come from a trusted source—as may be the case when the described platform intends to move an asset from the user's wallet to another wallet owned, or previously signed, by the same user. A similar rule might exist to automatically approve a transaction below a specific threshold, or to automatically deny a transaction above a specified threshold. The rules may be managed by the user or by an algorithm or AI associated with the platform. Rules may also be triggered based upon transaction risk. As an example, Alice set up her wallet in the previous example and has bought and sold crypto worth $900 in total. A transaction request has come in to withdraw all or nearly all of her cryptocurrency in exchange for a recently minted non-fungible token. The AI, having monitored and evaluated Alice's behaviors may auto-deny the transaction based upon rules, or, it may provide Alice with a very obvious “high risk” notification in the user interface for approval, or it may require extra verification from Alice that she is willing to approve this transaction based upon AI-controlled rules and is not under duress. The application of rules may apply to activities, token types, token histories, user histories, reports of fraudulent activity associated with a third-party, and rules may include whitelisted and blacklisted addresses.

In one embodiment, one or more private keys associated with the rights to change ownership of one or more tokens are stored both with a custodial wallet service provider and a non-custodial wallet, which may be controlled by a wallet owner, such as Alice, Bob or Cindy in the examples above. If the service providing the custodial wallet is temporarily unavailable, the wallet owner may still transfer ownership of associated tokens using the private keys held in or generated by the non-custodial wallet(s) of the wallet owner. The non-custodial wallet may integrate different access controls than those of the custodial wallet. For example, a non-custodial wallet may have technology to determine physical theft of the device operating the non-custodial wallet, e.g., as determined by anomalous GPS location data, anomalous attempts to access, etc.; in contrast, the custodial wallet may use technology to determine likely attempts at breaching wallets it protects by an attacker performing large numbers of brute-force attempts to authenticate using common credentials, such attacks being performed for one or more accounts held with the service provider. Some of these measures may be transparent to the end user, except when a triggering event takes place and a step-up action such as 2FA is required by the user. The use of two entities to enable transactions is helpful in contexts where a non-custodial wallet enables a custodial wallet to perform automated actions on its behalf, e.g., using a set of rules or an AI provided by the non-custodial wallet to the custodial wallet, and wherein the custodial wallet is required to follow the guidance provided by the non-custodial wallet, logging actions that it takes in response to such guidance. Instead of assigning capabilities to a custodial wallet, the non-custodial wallet can assign access rights to token transactions, e.g., in the form of private keys and rules or AI expressions describing automation tasks, to distributed entities, such as consensus mechanisms. An example consensus mechanism may involve a quorum of participants to which the owner of a private key (and resources governed by the same private key) may share the private key(s) using cryptographic threshold sharing mechanisms. Digital signatures using the shared private keys can be generated using traditional cryptographic means, by the quorum of participants of the consensus mechanism, as well as other actions, such as undoing of anonymity measures. For example, one can use techniques such as those disclosed in the 1997 publication titled “Distributed ‘Magic Ink’ Signatures” by Markus Jakobsson and Moti Yung, available online at https://link.springer.com/content/pdf/10.1007/3-540-69053-0_31.pdf. The quorum may comprise a threshold number of participants, all having staked some resource. Thus, instead of minting coins, or in addition to it, these participants may represent wallet owners and carry out automated actions on the behalf of these parties. Such actions may include transferring property to heirs once it is determined that a wallet owner has passed away, which can be certified using one or more trusted oracles. It may also include automating the transfer of access, e.g., for renting, borrowing or use governed by some usage rules specified by the wallet owner. The usage rules may determine how much, how often and how a given user may access a given resource, for example, and may be used to control such accesses without the direct real-time involvement of the wallet user or his/her computational equipment. Some of the rules governing the control may be specified by the consensus mechanism itself, e.g., to control transfers of ownership rights in order to limit abuse, such as fraud.

### Initiating the Distributed Control Over One or More Assets

To provide distributed control over an asset, such as a token, the owner of the asset may encrypt the access control data (e.g., the private key governing control over the token) using a public key of the entity that it wishes to provide control over the asset to. This entity, as described above, may be represented by a quorum, wherein different members of the entity may have portions of the decryption key needed to decrypt a ciphertext generated using the public key of the entity. It is known in the art how a quorum of such members can process an encrypted message (where the message may be access control data) to generate shards of the encrypted message, each shard being assigned to a member making up the entity, wherein a quorum of such entities can decrypt their given shards of the encrypted access control data to obtain a distributed representation of the access control data, wherein they can then utilize, as a quorum, the decrypted shards, thereby performing an action that appears to have been made directly by a party with full access to the access control data. The action may be to transfer ownership of a token, based on one or more rules, or based on an AI output, where the AI configuration may, e.g., be provided by the wallet owner, by the entity operating on behalf of the wallet owner, or a combination thereof. A wallet owner can, at any point in time, modify the rules or the AI, by providing updates, or can block access to the asset from the entity it previously provided control; such blocking of access can be performed by modifying the rules and/or the AI to identify to the entity not to take an action, or to transfer the assets governed by the distributed private key to be owned by a public key different from the one whose public key was distributed, and for which the corresponding private key is known to a party that is now, as a result of the transaction, the owner. This party may be the wallet owner and/or a custodial wallet service and/or another distributed entity that may be controlled using a consensus mechanism. The transfer of ownership and access rights may also be performed by the distributed entity, by the collaboration of a quorum of members, and according to the rules and AI associated with the asset.

Identifying and Protecting from Malevolent Transactions

Watchful bridges and watchful consensus has been disclosed in co-pending application Ser. No. 63/365,936 titled “Using Watchful Bridging for Blockchain Fraud Prevention” by Markus Jakobsson, Stefan Dufva, Keir Finlow-Bates, and Guy Stewart and filed on Jun. 6, 2022; and Ser. No. 63/368,218 titled “Watchful Consensus Mechanisms” by Markus Jakobsson and filed on Jul. 12, 2022. Watchfulness can also be implemented by an AI, such as a CAI. It may also be implemented as a feature of wallets, whether custodial wallet or non-custodial, e.g., as part of the service performed by a custodial wallet or as part of the software or hardware making up the non-custodial wallet. This may be rule-based, AI-based, or utilize a combination of such components. In one embodiment, the system is deployed with an artificial intelligence (AI) capable of monitoring many wallet addresses and transactions in real time across an entire spectrum of blockchain activities, whether public or private. For example, the databases and blockchains described throughout this disclosure may be permissioned or permissionless, providing an ability for the described systems and methods to enable transactions and asset movements to, from, and within permissioned (private) blockchains and permissionless (public) blockchains. One objective of the AI is to prevent unwanted or malevolent transactions from executing. For example, Carol is a very active Web3 user and has several high-value, high-profile NFTs in a particular wallet address. She is bombarded daily with “airdrops” of mostly junk or scam tokens that may cause Carol to lose valuable assets when attempting to resell or click links associated with the token. The AI, having monitored Carol's activities and assets, is capable of immediately moving the worthless or scam tokens from Carol's wallet and transferring them to a quarantine or null address, or to otherwise hide the potentially malicious tokens from Carol, unless she enters an admin mode in which case she will be able to inspect the hidden tokens, potentially being marked up with explanations why they were identified as such. In another example, David clicked a link on his favorite social website that is requesting he crypto-sign a transaction for what he believes is a free NFT. The AI, being rather suspicious of the new NFT with no history, and what it believes may be a dangerous smart contract automatically shifts the transaction to a fresh wallet address that has never been used and risks no existing assets, even if the wallet address is intended to be single-use only. Or, the AI may provide David with a very obvious warning about the risks present in this signing. Or, any number of AI-triggered actions that one skilled in the art of smart contracts and blockchain methods will recognize to prevent or deter loss.

### Incorporating Watchfulness

The notion of watchfulness has been proposed as a technical tool to manage data on a blockchain, e.g., by a watchful bridge performing filtering of blockchain entries as they are transferred from one chain to another, or a watchful consensus mechanism used to filter entries within a blockchain. Watchful filtering, independent of how it is performed, can be used to implement a moral principle, such as protection against crypto heists, protection against phishing, or protection against malware that extorts users. It can also be used to implement filtering of inappropriate content, which may be a matter that depends on the jurisdiction where digital content is created, consumed or transported through.

Whereas watchful filtering is a powerful tool for good, it can also be abused, e.g., by autocrats wishing to suppress truthful reporting of news—a problem that has plagued society for centuries. This disclosure identifies novel techniques to address shortcomings and risks associated with such abuse.

### Tracking Capabilities

Accordingly, it is desirable to manage what types of filtering actions can be performed at various locations. For example, in the context of a consensus-based watchful filtering mechanism, for some types of filtering actions, the consensus participants may be required to be selected in a manner that limits some type of filtering to select entities. More sensitive operations may require larger and more diverse quorums for the consensus to be completed, whereas less sensitive operations may be attainable to smaller quorums, including single-member quorums.

For example, the action of reassigning ownership of a fungible token from a first user within a jurisdiction to a second user within the same jurisdiction may be possible for an authorized representative of the jurisdiction. On the other hand, if the first user is associated with a first jurisdiction and the second user with a second jurisdiction different from the first jurisdiction, then the reassigning of ownership may require the collaboration of representatives from the two jurisdictions for the reassignment to be legitimate. This is an example of a rule that may be general and apply to all fungible tokens. The breach of such a rule (e.g., by an attempt to unilaterally reassign ownership, by only one of the above-mentioned representatives) may lead to an inconsistency, e.g., if the two jurisdictions are represented by two separate blockchains. Similarly to how an inconsistency between an L1 chain and L2 chain can be dealt with, an inconsistency like this can be addressed by one or more prioritization rules identifying how to resolve inconsistency, e.g., by one blockchain having priority over another blockchain, where inconsistencies are resolved in favor of the prioritized blockchain.

A rule may also be specific to a given token. For example, a first non-fungible token (NFT) may be associated with a first rule identifying what entities (such as bridges or consensus systems) may perform what operations. Such rules may be conditional on one or more jurisdictions, and/or of the actions associated with the NFT. An example action is a transfer of ownership to an entity that has an associated verified identity recorded, e.g., in the form of an anchored token. An anchored token has also been referred to as a soul-bound token, and has the property of being associated with an entity, e.g., the owner, in a manner that cannot be reassigned. Another example action is a transfer of ownership to an entity that does not have an associated identity recorded, or for whom the identity has not been verified by a trusted party. Based on this context (i.e., whether the entity to which the token is to be transferred has an anchored identity or not) different restrictions in terms of the actions taken on the token may be applied. A token transferred to an entity without an anchored identity may be denied by a bridge in charge of verifying, within its jurisdiction, that all ownership is associated with identity-verified entities. Another transfer, to an entity with an anchored identity may not be denied by the same bridge. At the same time, a second NFT may have a different rule, allowing the bridge to block an ownership transfer to the NFT independently of the identity context of the transferee.

It is also desirable to enable tracking to identify when a filtering action took place. For example, if a first blockchain entry is replaced with a second blockchain entry different from the first blockchain entry, then the second blockchain entry may be required to comprise a reference identifying the modification type, a reference to the first blockchain entry, or information establishing the membership of the quorum of participants comprising the watchful entity performing the filtering. These are simply illustrative examples of tracking components that could be required to be entered into the second blockchain entry. Tracking components may also be expressed in a separate log referencing the blockchain entries to which they relate. One example of a separate log is an off-chain log.

An example tracking component is a reference, incorporated in or associated with a token X that is generated from a token Y, by a watchful entity. For example, Y may be an NFT, with ownership assigned to a first user, and X may be a copy of the NFT, reassigned to belong to a second user. The watchful entity may modify X, e.g., to limit its functionality, where this is done in response to detection of potential abuse. The tracking component may indicate the abuse that triggered the action. For example, one example abuse is an estimated attempt of an adversary to gain access to an account or wallet of a user and to transfer tokens held in the account or wallet; a corresponding action may be to block these transfers of ownership and to initiate a second factor authentication (2FA) process.

A related technique is a detection mechanism to identify the compliance, or non-compliance, with a requirement to include a tracking component as described above, enabling non-compliant watchful entities to be identified and penalized, e.g., by being blocked by other network participants. The detection may rely on bounty hunters, a technology disclosed in co-pending application Ser. No. 63/208,366 titled “Perpetual NFT Assets” by Markus Jakobsson, Stephen C. Gerber, and Guy Stewart and filed on Jun. 8, 2021.

The tracking components may be registered in a separate storage area, which may be off-chain, in another blockchain, or in another location of the same blockchain as in which the associated token(s) are recorded. Tracking components may include references to the token(s) to which they are associated. In one embodiment, these references may be encrypted, only enabling entities with the appropriate decryption keys to determine the association. The encryption may use symmetric key or asymmetric key cryptography. The tracking components comprise information indicating the action taken, where example actions comprise a blocking, a modification, a registering of ownership data in a database, the verification of access rights, etc. The information indicating the action taken may also be encrypted, thereby limiting the ability to determine the action to entities with the appropriate decryption keys. This may be done in an analogous manner to how references are encrypted, which is given examples of above. Alternatively or in addition, escrow techniques such as those disclosed in co-pending application titled “Escrowed Wallet and Transaction Tracking Technology” by Markus Jakobsson, can be used for the recording of the information indicating the action taken, and/or for the references.

Some tracking components are transmitted to an auditing entity, e.g., in response to the tracking component being generated to describe a given filtering action performed by a consensus entity, a bridge, or another entity implementing watchfulness. A token may comprise one or more tracking guidelines specifying how tracking is to be performed, e.g., by generating an encrypted record or a non-encrypted record, whether the record needs to be authenticated by the entity generating it, whether the record is to be incorporated into the filtered token or otherwise associated with it where it is stored, or whether the record is to be stored in an off-chain database, communicated to a third party such as an auditing entity, etc. Different types of filtering actions may be associated with different types of tracking guidelines, and the guidelines may be expressed as a set of rules indicating conditions and actions, where an example condition may describe the type of filtering action (such as reversing ownership, performing evolution, adding escrow data indicating ownership, etc) or the entity performing the filtering action (e.g., a watchful entity associated with a specified jurisdiction, with a specified corporation, with a specified consumer representative, by a specified trusted party, etc), or a more detailed description (e.g., adding escrowed ownership records because the token is transferred into a specified jurisdiction), or a combination of such illustrative examples of conditions. Example actions include the creation of tracking records of specified formats, e.g., authenticated and encrypted, and transmitted to a specified recipient entity that may be an auditing entity or may manage an off-chain database.

In one embodiment, a tracking component comprises a publicly readable sub-component and an encrypted sub-component. The publicly readable sub-component comprises a description related to the encrypted sub-component, such as an identifier that specifies what entity or entities can decrypt the encrypted sub-component. The identifier may be a public key, a hash of a public key, a unique handle, a label identifying one or more entities, such as a group of entities where one or more of the group members can decrypt the encrypted sub-component. For example, the identifier may indicate that a given sub-component can be decrypted by a representative of a specified jurisdiction. The identifier may also specify the conditions under which the encrypted sub-component may be decrypted. For example, the identifier may specify that a suspicion of a crime associated with the token is necessary to decrypt the encrypted sub-component, or that the decryption of the encrypted sub-component can only be performed to verify that royalties were properly paid for a given transaction, and that the encrypted information may not be used for any other purpose. Such rules may be legally binding in some jurisdictions but not in others, and the capability to decrypt, i.e., the access to the decryption key or a decryption oracle, may be limited to jurisdictions respecting the rules as legally binding.

In one embodiment, a transaction involving a party A and a party B, such as the transfer of token C from A to B, causes the generation of a log entry, which we refer to as L. Here, both parties A and B, or one of these parties, may be associated not with a plaintext identity but with an escrowed identity record, explained next. For example, party A may be associated with the escrowed identity record EID_A and party B with an escrowed identity record EID_B. In order to perform the transaction, one or both of these parties may have to prove knowledge of a private key associated with the escrowed identity record. For example, in one embodiment, the identity value of A is a value h1\hat{ }r*h2\hat{ }{id_a} mod p, wherein h1 and h2 are generators and id_a represents A's identity and r is a random value. Here, g is a generator and A represents exponentiation modulo p, p being a prime. In a traditional transaction, a user A digitally signs a message referring to a token to be transferred and the recipient B of the token to be transferred, where the digital signature is generated using a private key xA corresponding to public key yA associated with the ownership of the token. If the public key of B is yB, the traditional signature releasing ownership may be DigSig((yB,T),xA), namely a digital signature of (yB,T) using xA, where T represents the token to be transferred, e.g., may be a hash of that token. This is an illustrative example and is intentionally simplified. The digital signature may then be recorded, e.g., on a blockchain. In the improved system disclosed herein, the digital signature may be of a format DigSig((yB,T, PROOF),xA) where PROOF represents a proof of knowledge of (r,id_a) based on the value h1\hat{ }r*h2\hat{ }{id_a} mod p, where preferably PROOF does not disclose id_a. This is also a simplified description. A more detailed system may also comprise a certificate C on the value h1\hat{ }r*h2\hat{ }{id_a} mod p, generated by a trusted party to assert that the identity id_a has been verified, and wherein C is tied to a wallet identifier such as yA in this example. Before a transaction is logged, e.g., recorded on a blockchain, there would be a verification of PROOF by the consensus mechanism, and of C being a valid certificate related to the wallet of party A. This proves that A has a validated identity before the transaction from A to B of the token is allowed. This has many security benefits, including allowing the identity of A to be determined if the token that is transferred turns out to be obtained by fraudulent means, or comprises illegal content.

Analogously, the recipient of a token being transferred, which is party B in the illustrative example above, may be associated with a certified identity value h1\hat{ }s*h2\hat{ }{id_b} mod p, and may generate a proof of wanting token T to be assigned to it, where the proof may be a proof of knowledge of (s,id_b) relative to h1\hat{ }s*h2\hat{ }{id_b} mod p, analogously to the proof PROOF above, and wherein the proof of B may be generated relative to T to indicate that the token T is requested. This proof by B would be associated with the transfer request described above, thereby indicating that B requests for the token T to be provided to it. The consensus mechanism may refuse to transfer T before this proof by B has been verified. This also has many security benefits, one of which is an avoidance of token spam, which is a problem of increasing significance, wherein a token owner gifts an unwanted token to a recipient, without the approval of the recipient. Sometimes the gifted token comprises malicious smart contract components, illegal material, unwanted advertisements, or other spam.

Automatic adjusting of assets and wallet configurations to match security posture requirements and risk tolerance.

In one embodiment, assets may be automatically moved between wallets or into fresh wallets based upon one or more factors, such as the overall security posture or risk tolerance for a given client, and/or a given wallet. For example, a particular wallet may have an inherent maximum tolerable valuation based upon its wallet type. For example, a hot wallet may include a threshold that enables an automated movement of crypto funds exceeding $1,000 in equivalent value—such as from the sale of a valuable asset from the hot wallet. Funds in excess of $1,000 may automatically be moved to a warm or cold wallet to prevent a build-up of value in a most heavily exposed hot-wallet. In a similar manner, a newly purchased NFT in the hot wallet over a similar threshold may automatically move to warm or cold wallet addresses. The movement of assets between wallets may be transparent to the user or not. For example, Edward has tens of thousands of dollars in cryptocurrency and NFTs in his “account”. His “opaque account structure” may be composed of numerous wallets with different levels of exposure—all in an automated processing manner where Edward has no knowledge of what exists in any particular wallet, or that it is even more than a single wallet address. In another example, Frank has 6,211 NFTs and the system maintains each of those assets in a separate wallet in a manner which appears to Frank to be a single wallet. The movement of assets in such a manner may be aided and protected by the watchful bridge innovations described in co-pending application 63/365,936 titled “Using Watchful Bridging for Blockchain Fraud Prevention” by Markus Jakobsson, Stefan Dufva, Keir Finlow-Bates, and Guy Steward and filed on Jun. 6, 2022. Wallet configurations may also be adjusted for reasons other than to address risk, such as to adjust to changing needs of a user, e.g., based on new behavioral events associated with the wallet. For example, a given wallet may be used casually, for collecting low-value NFTs for a period of time, in which the ownership is mostly monotonically increasing; after which the user increasingly starts using the wallet for storing tokens of investment value, where the user very frequently buy and sell such token. The new usage of the wallet signals a greater risk to the user (e.g., to fraud such as phishing or malicious smart contracts), but also establishes a greater need for assessment of value, trends in investing, tools for automated trading based on changing market situations, and more. The detection of such a change in behavior may trigger the installation of new tools, enablement of new features, etc., potentially after verifying this with a wallet user authorized to make the determinations.

### Anonymity

The instant invention does not preclude the use of anonymous user/client structures where allowed by law. Accounts on the system may or may not require identification services. The association of a wallet address, or group of addresses may be made by the system, or associated as a group with external addresses that are signed by a user capable of proving possession of the platform account key, whether a password, mnemonic phrase, or secret key, and the signing of a message with personally held private keys. Thus, anonymous transfers are compatible with non-custodial wallets. Anonymous transfers can also be made using custodial wallets, where accounts may be created and maintained without knowledge of personal details of the owner. Additionally, account configurations within the system may be pseudo-custodial whereby the secret keys are contained within the hardware of a 3rd-party system, but accessible only by the holder of a separate key which may be of many types, without limitation, such as passwords, biometrics, mnemonic phrases, personal hardware keys, including the ability to control access with two factor authentication, etc. In some jurisdictions, transactions involving anonymous accounts may not be permitted; may be limited to transactions of specified types (such as receipts of funds but not sending of funds, or only involving NFTs); or may be limited to particular value ranges, whether per transaction, for a given time period, or over the life of the wallet. The instant invention is compatible with the use of escrowed identity information, e.g., where a user proves his or her identity to a verifying party who certifies an encrypted token, the token comprising identity information or a reference to such; and where the certified token is associated with an account. The token may comprise a cryptographic key, such as a public key. The association between an encrypted token and an account (or a wallet) can be made by the owner of the private key corresponding to the public key of the token, without the removal of the layer of encryption. This can be done using zero-knowledge protocols. Such structures are commonly referred to as identity escrow structures. Identity escrow techniques were disclosed in co-pending application Ser. No. 63/322,265 titled “Escrowed Wallet and Transaction Tracking Technology” by Markus Jakobsson and filed on Mar. 22, 2022. If abuse is detected, pre-specified authorities can decrypt the encrypted token to determine the identity of the account owner. An example of a pre-specified authority may be a distributed entity such as the one disclosed herein in the context of automation of responses to requests, wherein the private key used to decrypt the encrypted token is distributively held by the members of the entity, in a way that requires a threshold collaboration, referred to as a quorum, for an action to be taken. One such action is decryption of the encrypted token; another is a determination whether an encrypted token corresponds to a specified identity or not. Other actions are possible, as will be appreciated by a person of skill in the art. In one embodiment, the token comprises information useful to reverse transactions made by the account owner, allowing a quorum of members of the entity able to decrypt the encrypted token to reverse transactions in a selective manner.

One problem associated with traditional hardware wallets is that the loss of hardware causes the loss of the data it stores as well. At the same time, backups, such as cloud backups, need to be bulletproof against dictionary attacks and robust against changes in biometric information. One approach to address this problem is the use of encryption of data using at least two different keys, where one of these keys is sufficient to decrypt, should the other (such as a biometric key) fail. Another approach is the use of sequences of information elements, where each such element has an amount of entropy that is insufficient to safeguard the key, and where a large number of elements are combined to achieve sufficient entropy, e.g., 160 bits for a symmetric key. One aspect of this approach is an entropy estimation tool to help guide a user to select strong key material, e.g., based on the commonality of choices. For example, one information element may correspond to a GPS location associated with a user-selected clue of “Favorite monument”; if a user selects a location, e.g., from a map, where the location may correspond to a monument such as the Eiffel tower or the Golden Gate Bridge, this is assigned a low entropy by virtue of being a common choice. Thus, whereas password strength checkers mostly measure length and apparent variability of characters, the entropy assessment tool we disclose estimates entropy by comparing choices to commonly expressed preferences, which may be harvested using surveys, for example.

Shielding Users from Wallet and Transaction Complexity

In one embodiment of the present disclosure, a user may be shielded from a presence of blockchain addresses, public keys, and private keys, with the wallet grouping addresses and recording within the wallet known capabilities of the assets against those groupings. A service, either within the wallet or as an external component accessed by the wallet and optionally with access to addresses provided by the wallet to the service, may provide 3rd-party requests with address-specific details that the user is not normally exposed to, and may undertake actions on the user's behalf. This may reduce the complexity of interacting with blockchain wallets and smart contracts and hence improve the user experience.

For example, Linda owns hundreds of NFTs, one of which grants her access to an online community. To prove her ownership of the NFT, the online community operates a validation service that associates Linda as a signer of the wallet address containing the specific non-fungible token. Linda's NFT happens to be in a wallet address grouped with 9 other wallet addresses in a series of what she considers “cold storage wallets” but has no specific knowledge or desire to know specifically which wallet address the NFT resides corresponds to. The service that manages Linda's accounts automatically selects the correct address to validate with the online community's validation service based upon the deployed contract address for the token. At no time is Linda required to know which wallet address is associated with the token.

A possible implementation of the above disclosure is presented in FIG. 10, which is provided for illustrative purposes only and is not meant to be limiting in any way.

In another example relating to fungible tokens that may be instantiated by smart contracts using the ERC20 standard, Melissa may collectively own 100 tokens of type A stored across a plurality of wallet addresses, and may wish to engage in a transaction comprising exchanging the 100 tokens of type A for 50 tokens of type B. The service that manages Melissa's accounts may automatically move the 100 tokens of type A to a single address before submitting a swap transaction from the single address to a decentralized exchange, the swap transaction requesting a swap of the 100 tokens of type A for the 50 tokens of type B, and may subsequently move the 50 tokens of type B to a new cold storage address. At no time is Melissa required to know that the plurality of wallet addresses were involved in the transaction or that the 50 tokens of type B are stored in the new cold storage address.

In one embodiment, a wallet is used to read one or more tags associated with physical items, each such physical item being associated with an information string that is conveyed to the wallet by means to reading a visual code (such as a QR code), receiving a radio transmission (e.g., using RFID technology and/or near field sensors), or by facilitation of a user who copies an alphanumeric code associated with the physical item to an interface associated with the wallet. The information string may comprise a certificate on a public identifier, such as a public key, and a private key, e.g., associated with the public identifier. By receiving the information string and parsing it, the wallet determines the certificate and the private key; determines that the certificate is valid, and uses the private key to transfer a right associated with the physical item to the wallet. This may be an ownership right. In one example use case, the person operating the wallet removes or disables the conveyance of the information string after having received it to the wallet, thereby blocking others from receiving it to their wallets; in another example use case, as soon as the user's wallet receives the information string and registers it by publicly recording this, e.g., by posting a digital signature created using the private key of the information string, along with the certificate of the information string, to a blockchain. This is only recorded the first time such a signature using the private key of that information string is used, unless the wallet releases the rights to recording ownership by another entity, e.g., by digitally signing that entity's public key using the private key of the wallet, having already associated the physical item with the wallet by recording the digital signature using the private key of the information string, signing the public key of the wallet that has the ownership rights to the physical item.

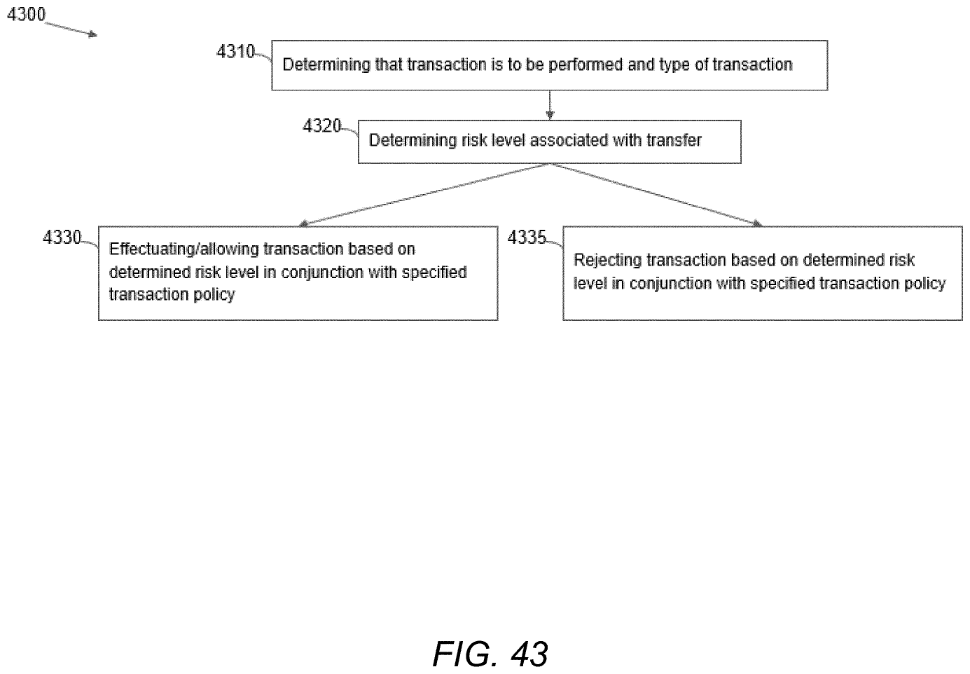

FIG. 43 is a flowchart illustrating an exemplifying embodiment of a method performed by a first wallet or an entity associated with the first wallet for handling transactions of digital assets of the first wallet. The first wallet has a specified transaction policy. FIG. 43 illustrates the method 4300 comprising a first step 4310 of determining that a transaction is to be performed and the type of transaction. As described above, a digital asset may be transferred between wallets. By transferring the digital asset is meant that transfer of rights, or ownership, of the digital asset from the first wallet to a second wallet. The transaction may be triggered by the value of the digital asset having increased to a value so that the digital asset is moved to a second wallet of the same user/owner as that of the first wallet, and with the second wallet having higher security constraints than the first wallet. The transaction may also be triggered by the user/owner of the first wallet selling the digital asset to a second user, the second user owning the second wallet. FIG. 43 also illustrates the method comprising a step 4320 of determining a risk level associated with the transfer. This is thoroughly described and exemplified herein and the risk level may also be referred to, or incorporating, risk score(s), risk exposure, risk assessment, and/or risk profile. FIG. 43 also illustrates the method comprising a step 4330 of effectuating/allowing the transaction based on the determined risk level in conjunction with the specified transaction policy or a step 4335 of rejecting the transaction based on the determined risk level in conjunction with the specified transaction policy.

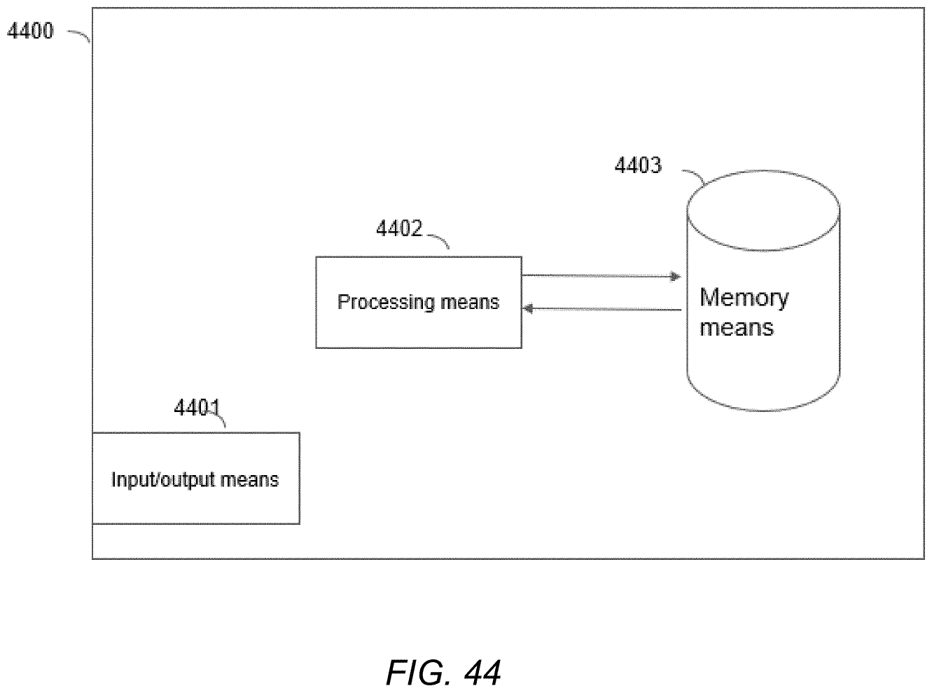

FIG. 44 is a block diagram of an exemplifying embodiment of a first wallet (4400) or an entity associated with the first wallet configured for handling transactions of digital assets of the first wallet. FIG. 44 illustrates the first wallet (4400) or an entity associated with the first wallet comprising input/output means 4401 by means of which the first wallet (4400) or an entity associated with the first wallet may receive information and transmit or provide information to other units, devices and/or entities. FIG. 44 also illustrates the first wallet (4400) or an entity associated with the first wallet comprising processing means 4402 and memory means 4403, the memory means 4403 comprising instructions, which when executed by the processing means 4402 causes the first wallet (4400) or an entity associated with the first wallet to perform the method described herein. The first wallet (4400) or an entity associated with the first wallet may for example be, or be implemented in, a server, a computer, a smartphone, a cloud server or any entity or arrangement comprising processing means for executing the method.

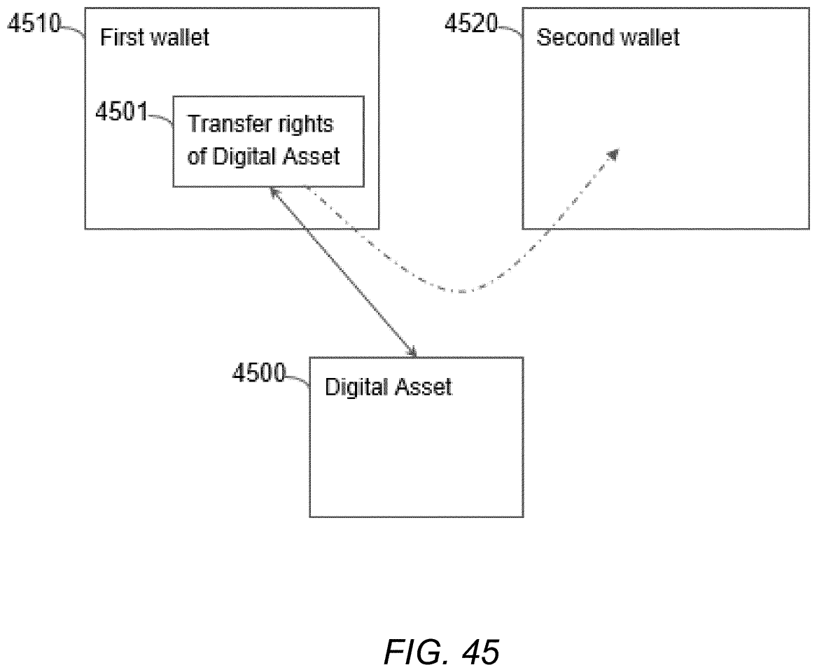

FIG. 45 is an illustrative example of a transaction in which transfer rights of a digital asset is moved from a first wallet to a second wallet. A digital asset 4500 may be “owned by” the first wallet 4510 and at a first point in time, and the ownership may be transferred to the second wallet 4520. This may be expressed as transferring the digital asset from the first wallet to the second wallet. However, it is not the digital asset 4500 per se that is transferred or moved between the first and the second wallet, but it is the ownership or transfer rights 4501 of the digital asset 4500 that is transferred from the first wallet 4510 to the second wallet 4520.

Another aspect of the disclosed technology is a collection of methods addressing the problem that blockchain suffers problems related to trust. It is possible for anonymous attackers to steal tokens, which may represent financial assets, access rights, physical property, or other valuable information. There is currently very limited recourse: it is neither possible to identify who committed abusive acts, nor is it possible to reverse or modify such transactions in a manner that undoes the damage of the attack. We disclose a collection of related mechanisms to address this important and long-felt need.

Escrow generally and for this claim defines a system in which a 3rd party is trusted to take custody of anything of value until a specified condition is completed. The escrow process for U.S. real estate alone generates more than $25 billion dollars in revenue, via largely manual, high-touch processes. The technology defines a modular, configurable virtualized escrow requiring no human contact outside the transaction participants.

Escrow is an injection of “trust” in an otherwise trust-lacking transaction. Smart contracts and/or DAOs may be an alternate form of trust injection in a transaction that may otherwise require traditional escrow, and can be used in the context of the disclosed invention to implement the described structure.

### Release of Keys

In one embodiment, a first party associates a given public key with a given time period, allowing anybody to encrypt data with that public key; doing so will render the encrypted data private until the arrival of the beginning of the time period, at which point the private key associated with the public key will be made public by a trusted time keeping authority, allowing anybody to decrypt the messages encrypted with the public key whose corresponding private key was revealed by the trusted time keeping authority. Thus, a second party may encrypt a given message with the public key of “Nov 15, 10 am PST”; when this time arrives, the corresponding private key will be made public, and anybody will be able to access the message.

In another embodiment, the timed release is combined with a further layer of encryption, enabling only selected parties (e.g., identified by their public keys) to access the plaintext message after the trusted timing authority has released the private key associated with the time period of release.

In one embodiment, the release of private keys is governed not by the arrival of a pre-specified time, but by the occurrence of an event that can be verified to have taken place, e.g., by having an oracle testify to its occurrence. This, too, can be combined with a further layer of encryption, enabling only selected parties (e.g., identified by their public keys) to access the plaintext message after the trusted timing authority has released the private key associated with the triggering event.

Data other than keys can also be released in an analogous manner, e.g., based on events taking place or given times arriving. In one embodiment, the data to be released comprises records, the records comprising one or more keys associated with different purposes and/or resources, and optionally, one or more additional data fields that identify access rights. For example, the access rights many comprise digital signatures identifying what parties have rights to perform various actions, wherein an example identification of a party comprises one or more public keys associated with the party, and wherein an example right corresponds to information stating that the party with access rights have the right to rent out a given token; to revert transactions pertaining to ownership, e.g., based on a policy being satisfied. Data may also comprise information relating to content, such as information specifying how a content item of a non-fungible token may be updated, e.g., using evolution. Examples of techniques pertaining to evolution are disclosed in co-pending application titled “Content Evolution Techniques” by Markus Jakobsson.

Another example of data other than keys being released is the deployment of a smart contract when a predetermined time arrives, or the enablement of functionality of a smart contract. Deployment or enablement may arise automatically, for example, through time-dependent functionality encapsulated in a deployment script or smart contract, or the ability to deploy the smart contract or enable the functionality within a previously deployed smart contract may be provided through a signed enablement message. In embodiments, on presenting the signed enablement message through a transaction calling a smart contract, the functionality may be enabled, as illustrated in FIG. 2, which presents a block diagram describing the present embodiment.

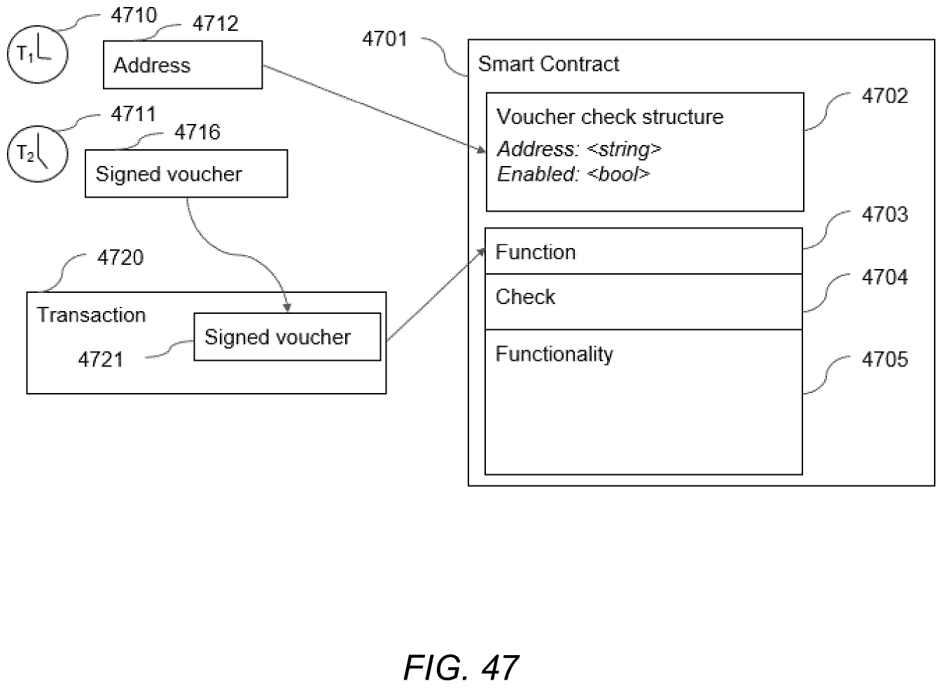

In FIG. 47, a smart contract (4701) may comprise a data structure (4702) for maintaining and checking a status of a voucher. The data structure (4702) may comprise an address and a boolean indicating whether a function (4703) is enabled. The function (4703) may comprise a check (4704) comprising instructions to verify whether functionality of the function is enabled, as indicated by the data structure (4702).

At an initial time T₁ (4701), an address (4712) may be loaded into the data structure (4702), and the boolean may be set to false, indicating that a functionality (4705) of the function (4703) is not enabled.

Subsequently at time T₂ (4711) a signed voucher (4716) may be released, with a signature generated using a private key from which the address is derived.

A transaction (4720) may then be generated, comprising a copy of the signed voucher (4721), and the transaction (4720) may be transmitted to a blockchain for executing the function (4703) of the smart contract (4701).

The check (4704) may verify that the copy of the signed voucher (4721) is valid using the address in the data structure (4702), and on verification may change the value of the boolean to true, and may execute the functionality (4705).

Subsequently, transactions may execute the functionality (4705) in the smart contract (4701) without requiring the signed voucher (4716).

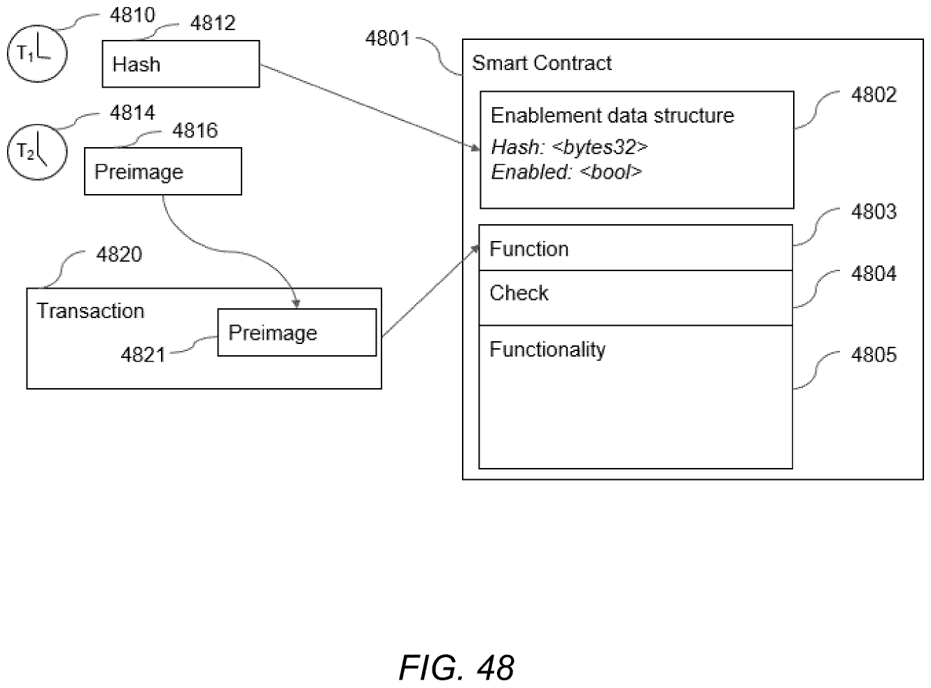

In an embodiment, functionality may be restricted through a check within a smart contract function that a presented enablement message comprises a preimage to a hash output within the functionality, as illustrated in FIG. 48.

In FIG. 48, a smart contract (4801) may comprise an enablement data structure (4802) for maintaining and checking an executability status of a function (4803). The data structure (4802) may comprise a hash and a boolean indicating whether the function (4803) is enabled. The function (4803) may comprise a check (4804) comprising instructions to verify whether functionality of the function is enabled, as indicated by the data structure (4802).

At an initial time T₁ (4801), a hash (4812) may be loaded into the data structure (4802), and the boolean may be set to false, indicating that a functionality (4805) of the function (4803) is not enabled.

Subsequently at time T₂ (4811) a preimage (4816) may be released.

A transaction (4820) may then be generated, comprising a copy of the preimage (4821), and the transaction (4820) may be transmitted to a blockchain for executing the function (4803) of the smart contract (4801).

The check (4804) may verify that the copy of the preimage (4821) when hashed with an appropriate cryptographic hash function, generates an output equal to the hash stored in the data structure (4802), and on verification may change the value of the boolean to true, and may execute the functionality (4805).

Subsequently, transactions may execute the functionality (4805) in the smart contract (4801) without requiring the preimage (4816).

Thus, a trusted timing service can be set up to release private keys, corresponding to known public keys, or other data, triggered by the arrival of a given time (i.e., time-based release) or triggered by the occurrence of a given event (i.e., event-based release). A traditional key pair corresponds to one private key and one public key. A triggered key pair corresponds to a key pair and a description of one or more conditions that causes the release of the private key of the key pair. The condition may be implicit, e.g., possible to determine from the context of the associated key pair, or it may be explicit, e.g., expressed as one or more rules that may be stored along with the public key, potentially with a digital signature on the condition and the public key, where the digital signature is generated by an authority, such as the entity or entities in charge of performing the release of the private key when the associated condition is satisfied. A set of triggered key pairs may be arranged in a directed acyclic graph (DAG). One such DAG is simply a series, which may correspond to time, and where each progression of the series corresponds to the progression of time, e.g., the progression of one minute. The DAG may also be a more complex graph wherein the forks of the graph correspond to situations in which there are multiple events that can trigger different releases, and each such release corresponds to a new path.

### A Timing-Based Release can be Implemented in a Variety of Ways

In a first approach, each time period is represented by a value, which may be a counter indicating the number of the time period, numbered from a starting time that corresponds to a value 0, each increment representing one time interval. A time interval may be a day, a second, or any other duration. A time period may also be represented by a descriptive string, such as “Nov. 1, 2022, 8-9 am PST”. The time period representation is used as a public key, or parts thereof, in an Identity-Based Encryption (IBE) scheme. One example IBE scheme was described by Dan Boneh and Matthew Franklin in their 2003 publication titled “Identity-based encryption from the Weil pairing”, in SIAM Journal on Computing. 32 (3): 586-615. Using a master private key, an authority computes one private key from each time-interval public key. The authority may be a distributed entity, and the generated public key may be stored in a distributed manner or computed in real-time when needed to be released. Anybody would be able to encrypt a message using a public key whose value can be determined by the selection of the time period for which the release of the associated private key is desired. The authority or a party designated by the authority would release the private keys at the appropriate time, i.e., corresponding to the time interval to which the associated public key corresponds. The authority and/or the designated party may be distributed and represented by a quorum; it may also be operating using a consensus mechanism, To manage private key shares distributed among participants of an entity whose membership can change over time, e.g., by members leaving or joining, key redistribution methods such as those disclosed in the 1997 publication “Proactive public key and signature systems” by A Herzberg, M Jakobsson, S Jarecki, H Krawczyk, M Yung, in Proceedings of the 4th ACM Conference on Computer and Communications.

In a second approach, a traditional encryption scheme, such as ElGamal, can be used to create public keys from a series of private keys. These private keys may be generated using a one-way hash chain, where-in the private key for time interval t can be generated as one or more hash values of the private key for time interval t+1. This way, as a new private key is released, it can be verified using a previously released private key. The maintenance of hash chain values is disclosed, for example, in the 2002 publication titled “Fractal hash sequence representation and traversal” by Markus Jakobsson, published in the Proceedings IEEE International Symposium on Information Theory. A multiplicative one-way function such as a modular exponentiation function can be used in place of a hash function, enabling simple distribution of the task of maintaining and generating private keys. One or more public keys can be published, e.g., by the party or parties releasing the private keys, or another authority. These public keys can be certified using traditional digital signature approaches. The certification may indicate the alignment between public keys and associated time intervals, e.g., by indicating the time of the first public key, the time interval size, and the order of the public keys being certified. Generation and distribution may use similar building blocks as described above, e.g., the 1997 publication “Proactive public key and signature systems” by A Herzberg, M Jakobsson, S Jarecki, H Krawczyk, M Yung, in Proceedings of the 4th ACM Conference on Computer and Communications. This can also be done for other release schemes described below, as can other building blocks described herein.

The private keys associated with time intervals may also be computationally unrelated to each other, e.g., their associated private keys may be generated independently of each other using a pseudo-random function generator or a true random generator. The associated public keys may then be individually or collectively certified by an authority, which may be the same entity that generates the private keys, and which may be a distributed entity using threshold cryptography to generate and maintain private keys.

The techniques described above are illustrative examples, and can be combined and modified as will be appreciated by a person of skill in the art; the same applies to the techniques described next.

An event-based release scheme can, analogously, be created as follows: An IBE-based scheme such as the one described above can be modified to let the public keys describe or correspond to references to conditions indicating the events causing the triggering of associated private keys. For example, one public key may be or contain a string that is a hash of one or more rules, e.g., described as executable code or values corresponding to conditions. Alternatively, the public key may comprise a reference to a a value stored on the IPFS, where the storage comprises one or more rules. Alternatively, the public key may indicate a portion or classification of a condition, such as an indication that the condition is imported using a specified oracle, and the public key associated with one or more detailed rules or conditions, e.g., by means of a certificate binding the public key to the rules or conditions.

A collection of conditions may be related by being associated with a state diagram. The state diagram corresponds to nodes and edges, where the edges relate to conditions and the nodes to public keys with associated private keys, such private keys held by an authority that may be distributed. The transition between nodes in the state diagram results in the release of the private keys of the nodes. The graph can be represented by descriptors of the conditions and values representing the public keys of the nodes, allowing anybody to encrypt a message using a public key that corresponds to a selected node in the state diagram. The private keys can be generated independently or based on other private keys, as described for the hash chain example above, wherein the one-dimensional aspect of a hash chain can be replaced by a multi-dimensional representation in which some private keys are generated from a multiplicity of other “upstream” private keys, e.g., using a one-way function of such upstream private keys.

Private keys can also be generated independently of each other, their associated public keys being associated with one or more conditions related to events, the combination of a list of public keys and associated descriptors of the conditions being certified by a trusted party, which may be but does not have to be the entity in charge of releasing private keys when the associated triggers cause conditions relating to public keys to be satisfied, at which point the associated private keys or fragments thereof are released. The release can be made by a broadcast or a unicast, where the latter may be directed to a specified party and encrypted for this party alone to be able to access.

Proving that a plaintext is a valid private key corresponding to a given public key.

In one embodiment, a first user wishes to encrypt a private key x corresponding to a public key y, e.g., using ElGamal encryption, and then prove that the resulting ciphertext C is an encryption of x, but without having to disclose x. Here, we assume that y=g\hat{ }x mod p for a prime number p, where g is a generator of the group. ElGamal encryption of a message Mi can be expressed as (Ai,Bi)=(G\hat{ }ri*Mi, Y\hat{ }ri). Here \hat{ } represents exponentiation modulo p and * represents multiplication modulo p. The value ri is a nonce that is selected randomly or pseudo-randomly. The private key x can be expressed as a series of bits x1 . . . xn where x is n bits long. It can also be expressed as a series of messages Mi=g\hat{ }(2\hat{ }(i−1)*xi), for 1<=i<=n. The private key can therefore be expressed, in encrypted format, as a series of ciphertexts Ci, where Ci is of the format (Ai,Bi)=(G\hat{ }ri*Mi, Y\hat{ }ri)=(G\hat{ }ri*g\hat{ }xi, Y\hat{ }ri). It can be seen that the pairwise product (A,B)=(G\hat{ }R*y, Y\hat{ }R), where R is the sum, for 1<=i<=n, of ri. This is because Mi is a representation of one bit of x, namely xi, weighted with the position i. A user gaining access to Mi will be able to determine whether xi is 0 or 1 by determining whether Mi is G\hat{ }0=1 or G\hat{ }1=1. Thus, if the series of ciphertexts Ci for 1<=i<=n is revealed to the user, the user can determine x by determining the individual bits of x. A party can prove that a series of values Ci is of the right format by proving, for each one of them, that Ci is either an encryption of G\hat{ }0=1 or of G\hat{ }1=1. Methods to do this are well-known, and include the disjunctive proofs disclosed in Jakobsson, M., Sako, K., Impagliazzo, R., “Designated Verifier Proofs and their Applications”, published in Eurocrypt 1996, and the more recent publication “gOTzilla: Efficient Disjunctive Zero-Knowledge Proofs from MPC in the Head, with Application to Proofs of Assets in Cryptocurrencies” by Foteini Baldimtsi, Panagiotis Chatzigiannis, S. Dov Gordon, Phi Hung Le, and Daniel McVicker. Using such proofs would be done to prove that each message Mi represents a plaintext value representing either a zero or a one, as opposed to a random and unknown large number, for example. In addition, the party would prove that the pairwise product (A, B) described above has the property that the discrete log of A/y with respect to G equals the discrete log of B with respect to Y, where the discrete logs are relative to the prime p. Thus, a verifier of these proofs would be able to determine that each component (e.g., ciphertext Ci) represents a bit xi, and that the ciphertexts together represent the public key y. Therefore, since a user with access to the plaintexts can determine, for each message Mi, whether this represents a private key bit of 0 or of 1, such a user can reconstruct x from the plaintexts; a party verifying the proofs described above would know that this is true, and that the set of ciphertexts, collectively, represent the private key x associated with the public key y. An example of discrete log equality proof, along with code for it, is provided in a blog post titled “Non-interactive Zero-Knowledge Proof of Discrete Log Equality”, by Bill Buchanan on Mar. 27, 2021. A batch version is described in the 2004 publication titled Batch Verification for Equality of Discrete Logarithms and Threshold Decryptions” by Aditya Rita, Edward Lee, Byoungcheon, and Peng, in the International Conference on Applied Cryptography and Network Security. Many other versions for generating proofs of equality of discrete logs are available, as will be appreciated by a person of skill in the art. Whereas this description has used traditional modular arithmetic as a way of explaining the techniques, other implementations are also useful, such as elliptic curve implementations, as is also understood by a person of skill in the art. This description is illustrative of the methods for proving that a series of ciphertexts correspond to a private key associated with a corresponding public key, but without disclosing the private key until the ciphertexts are decrypted. This decryption can be performed in the manners described in this disclosure, e.g., by a trusted authority, such as an escrow authority.

The example above describes how to break down a private key into bits, each of which is separately encrypted and verified. Analogously, a series of bits, such as a byte of a private key, can be encrypted, proved correct and verified. In this example, the verifier would compute or keep a database of the values G\hat{ }0, G\hat{ }1, . . . G\hat{ }255, and the proof of correct encryption would prove that a ciphertext corresponds to one of these values. As will be appreciated by a person of skill in the art, this can be done with any length, e.g., 1 bit chunks, 4 bit chunks, or (as described in this paragraph) 8 bit chunks. Larger chunks are also possible, as will be appreciated by a person of skill in the art. Also, the techniques are not only usable to prove the correctness of ciphertexts in terms of these containing plaintexts representing private keys; the very same techniques can be used to prove correctness of a nonce, such as a random value z, wherein a public representation of this nonce, such as g\hat{ }z modulo p, may have been published or provided in encrypted form in another ciphertext.

Once it has been established that a set of ciphertexts represents a private key, e.g., as described above, then a party knowing this private key can provide ciphertexts of computation involving the private keys, and prove these to be correct. This amounts to a computation on encrypted data, wherein one or more verifiers can determine that ciphertexts are correct. For example, an entity that holds a private key x can generate a nonce value z, and using the private key x and the nonce value z, generate a digital signature, such as a DSS signature, on a message such as the string “hello”, wherein this digital signature is provided in an encrypted format, represented by one or more ciphertexts, and wherein the holder of the private key x can prove to a third party that the ciphertexts represent a valid digital signature on the message “hello”, using the private key corresponding to a specified public key y, which corresponds to the private key x. This can be done without revealing x, z, or the digital signature resulting from these, but enabling the verifier to know that the ciphertexts correspond to the claimed digital signature. This can also be done with any other type of computation, as will be appreciated by a person of skill in the art, and is not limited to digital signatures.

### Gradual or Partial Release of Private Keys

There are applications in which two or more parties wish to exchange information by disclosing it to each other in a way that no party has a significant advantage over the other, should one or more of the parties be disconnected from the others or decide to not complete the transaction. This is a general problem that is commonly referred to using the term “fair exchange”. The disclosed technology facilitates a fair exchange, as two or more parties can represent two or more private keys as disclosed above, using a series of ciphertexts, proving that this series of ciphertext corresponds to the public key to which the private key being represented corresponds. The disclosed structure lends itself naturally to a gradual exchange, in which one party can reveal one bit of her private key by providing data useful to verify the correct generation of a ciphertext to which the private key bit corresponds. Using the ciphertext Ci from above as an example, where Ci is of the format (Ai,Bi)=(G\hat{ }ri*Mi, Y\hat{ }ri)=(G\hat{ }ri*g\hat{ }xi, Y\hat{ }ri), the value Mi corresponds to the bit to be released. This release can be performed in a verifiable manner by disclosing ri, enabling the verifier to determine Mi and verify that (Ai,Bi) is a valid encryption of Mi using the nonce ri. A person of skill in the art will recognize that if Mi represents multiple bits, this same approach can still be used to disclose, in a verifiable manner, the multiple bits corresponding to Mi. To release only one bit corresponding to a value Mi representing multiple bits, the prover can perform a zero-knowledge proof similar to the proofs described in the original example above, after having revealed only one bit corresponding to Mi, by proving that the already committed value Ci is of a correct format provided this one bit and a remaining plaintext value Mi′ that is not disclosed but proved knowledge of as above.

### Example Applications of Gradual Release

One application of a gradual release is for two users to exchange items to be bartered without a trusted intermediary or a marketplace. This, however, leads to potential problems regarding enforcement, as marketplaces today enforce (or have the capability of enforcing) policies such as payment of royalties to content creators. Thus, the existence of an affordable and practical method for a gradual exchange, when applied to a mutual exchange of two elements to be exchanged for each other, requires new solutions for enforcement of policies. One approach to ascertain the enforcement of policies is to use a watchful mechanism, e.g., in a bridge or in the consensus mechanism. Watchfulness was disclosed in co-pending application Ser. No. 63/368,218 titled “Watchful Consensus Mechanism”, by Markus Jakobsson and filed on Jul. 12, 2022 and Ser. No. 63/368,218 titled “Using Watchful Bridging for Blockchain Fraud Prevention” by Markus Jakobsson and filed on Jun. 6, 2022. Another approach uses a whitelist or blacklist approach in which tokens that have been transferred only in a proper manner are recorded on a whitelist, or where tokens that have at least once been transferred in an improper manner are placed on a blacklist, and where the resale value and functionality related to the token is affected by the presence on one of these two sorts of lists. For example, third party services may collect bounties for blocking the use of tokens on their properties unless recorded deficiencies are remedied (e.g., past-due royalties paid, with additional penalties). Here, “proper” may refer to in compliance with all policies, such as a policy regarding royalty payment, a policy regarding proper generation of tracking data such as escrowed tracking data, or any other policy for which a third party can verify compliance using public or non-public means. In one embodiment, a policy is expressed or enforced at least in part by a smart contract associated with a token, and wherein the smart contract enforces the policy (or policies) associated with the token. Such smart contracts may also be used to enforce policies associated with other tokens, e.g., tokens owned by the same wallet, tokens owned by the token with the enforcing smart contract, etc. Enforcement in this context may comprise the reporting of non-compliance, for example, where the reporting may be performed to a trusted party, to a bounty hunter, to a blacklist or whitelist operator, etc. Enforcement may also comprise performance or non-performance of actions associated with access, audits, etc.

### Hybrid Encryption Embodiments

In some embodiments, the gradual release of plaintexts may be less efficient than is desirable for a given application; likewise, in some embodiments, the proof of correct encryption of a private key may be less efficient than is desirable. For example, consider an embodiment in which an identity Based Encryption (IBE) scheme is used, and where this has application-desirable functionality but where its proof of correct encryption is either requiring an undesirable amount of communication (i.e., high bandwidth requirements) or an undesirable amount of computation in the context of the entities involved in the protocol. In such a situation, the IBE may be used to encrypt a key for a second crypto system, where the second cryptosystem offers better performance. The prover would then prove that the IBE-encrypted key is consistent with the key used for the desired functionality (such as the gradual release), where the latter uses the more efficient cryptosystem. This may lead to important efficiency improvements. One approach to perform the first proof, i.e., the proof of consistency, may utilize the breaking down of keys, both private keys and public keys, into shares, where said shares may operate within different computational environments (i.e., using different operations and moduli). Consistency can be proven using a cut-and-choose scheme in which multiple private key shares and multiple private key shares are committed to, a verifier or a computational oracle such as a hash function is used to select a challenge, and the challenged elements are decommitted. This only has to be verified once by a given verifier. Then, additional computation, including general multi-party protocols can be performed using the more efficient crypto system. This provides the functional benefits of the first crypto system (e.g., IBE) and the efficiency benefits of the second crypto system (e.g., ElGamal encryption) wherein any number of proofs can be performed using this second crypto system. This enables an enjoyment of the benefits from each of the two or more cryptosystems used in combination, where the example here illustrates the use of two crypto systems but larger numbers of crypto systems can be used, as will be appreciated by a person of skill in the art.

The contents of a vault, e.g., one or more ciphertexts comprising escrowed keys and data, can be released by a trusted party (such as an escrow authority), which may be a distributed party. One example of an escrow authority is a collection of entities that have staked resources to each gain access to a portion of a private key, and wherein a threshold number of such portions can be used to decrypt ciphertexts, or to make other computations on them. One example of such a computation is to take as input a first ciphertext, which was generated from a first plaintext relative to a first public key, and using a (potentially distributed) copy of the private key associated with the first public key, generate a second ciphertext on the first plaintext using a second public key without ever exposing the first plaintext to any of the entities associated in the computation. One computational technique that can be used for this is described in “On Quorum Controlled Asymmetric Proxy Re-encryption” by Markus Jakobsson, published in October 1999 in Lecture Notes in Computer Science 1560:632-632.

A vault may comprise or be associated with one or more ciphertexts associated with escrowing of data incl keys. A vault may also contain or reference one or more policies governing the processing of the vault contents. The processing of vaults can include the release of selected plaintexts to the public; the selected release of plaintexts to selected entities, e.g., by generating one or more new ciphertexts from a ciphertext in the vault wherein the one or more new ciphertexts are associated with public keys of the selected entities; a gradual or partial release of contents, e.g., release of one bit of a private key; the designation of a new escrow authority to manage the processing of a vault or parts thereof, e.g., by re-encryption of ciphertexts to associate them with the new escrow authority; the determination of whether a given ciphertext corresponds to a particular plaintext but without disclosing the plaintext if there is no match; the comparison of two ciphertexts in terms of their corresponding plaintexts without the disclosure of said plaintexts; and other general multi-party computation on the ciphertexts. One policy may specify the conditions governing one or more actions to be applied to one or more ciphertexts, whereas another policy may specify another set of conditions governing another set of actions to one or more ciphertexts associated with the vault. Some policies may be generated by context creators and associated with tokens; others may be required by law enforcement in one jurisdiction but not another; whereas some may be added by content owners, wallets, gateways, marketplaces, advertisers or other blockchain or off-chain entities and their representatives. A policy may be implicit, i.e., if there is abuse, then the identity of the identified criminal is determined. A policy may also be explicit, identifying when data can/should be accessed—for example, “this document to be given to my heirs when it is determined that I am dead”. In some cases, the policy is yet to be determined—for example, “the data is protected until the AI, whose rules can be modified over time, says it is time to reveal the data”.

One application of escrow is in the context of a transaction that changes ownership or access rights of a token, such as a non-fungible token or a crypto coin. Some such transactions may be caused by phishing, malware or other abuse, and it may be desirable to reverse or modify such transactions or to cause a reassignment of ownership or access rights different from the instructions in the transfer request. If resources, the assignment of resources to public keys, are escrowed as part of the transaction request, then the escrow authority may evaluate whether to complete the indicated transaction or modify it. A policy may indicate a duration of time or an event such as the verification of a payment or other ownership transfer that may have to take place before the transaction completes. A policy may include a verification mechanism that resources are who/what they claim to be—related to authenticity, functionality, or other value-driving characteristics. Beyond verification of the actual resources, a policy may include a verification mechanism to ensure parties actually have the authority to control resources they claim authority to control. If within this time or before this event a complaint is filed or an abuse verification is initiated, then the escrow authority may conditionally take an action governed by a policy. In some instances, the resulting action may be a return of assets (such as a token or some access credentials); the modification of assets (e.g., burning of a token, evolution of a token, or modification of access credentials to cause a lock-out); or the reassignment of assets (e.g., to law enforcement, to the content creator, to a party to whom royalty fees are due, or to a tax authority to whom sales tax is due, to charity) can be performed. In some instances the action may be taken automatically based on the policy alone and in others the policy may indicate other parties must agree to or confirm approval of any change to the transfer request. Agreement may be one or more of:
Actually or nearly simultaneous, in that other parties may agree to or confirm approval within a predetermined time period, or before a predetermined date and time is reached,
Sequential, in that there may be an expected ordering of agreement or confirmation among the parties,
Collaborative, in that some or all of the other parties may know and/or trust each other beforehand and agreement by a party may be contingent and automatic on agreement by one or more other parties,
Non-collaborative, in that some or all of the parties may not know and/or trust each other beforehand, and an agreement process by a party may be deterministically defined,
Promotional or incentivized, in that a party may offer incentives to a second party to influence the agreement of the second party,
Continuous, in that any party may agree at any time,
Repeated, in that any party may repeatedly agree over time,
Some other form of agreement.

Other types of actions that can be governed by a policy is the initiation of a tracking of ownership, current or historical, the generation of logs, the verification of changes of ownership patterns e.g. to identify attempts to launder money or provide terrorist funding, etc.

For broad, generalized use, in one instance, each verification step above (e.g., verifying parties, verifying ownership, verifying resource authenticity, etc.) would be open to a range of mechanisms, from fully automated based on policy to human-intervention by an agreed, trusted third-party. That is, the generalized escrow system would not dictate a single verification method, but rather support different verification systems based on the characteristics of the transaction and resources to be transferred.

Traditional escrow mechanisms are used to safeguard property. These mechanisms are not suitable to web3, due in part to the lack of trust, or different trust structures, associated with the distributed environment. Moreover, we disclose other types of escrow, expanding from simply escrow of property. For example, tracking data may be escrowed, as may data that facilitates tracking. More generally, escrow is used in the context of this application to mean the control and management of information until a triggering event takes place, where the triggering event may be associated with one or more policies, and with an on-chain or off-chain event. The information may, for example, be associated with access rights, ownership rights, an ability to perform an action. It may also govern descriptors related to an entity, such as identity information, demographic information, purchase information, location information, reputation data, and more. Escrow data may comprise information defining or classifying an asset. The escrow data may also comprise data identifying the conditions for an action. For example, a content creator may set a policy that describes the actions allowed on a token, without disclosing what these conditions are. Instead, the conditions may be protected using encryption, e.g., using an escrow mechanism, wherein one or more escrow authorities identified by the content creator may be able to determine whether a condition has been met by comparing one or more events to the escrowed content description, and only enabling an action if the conditions are satisfied. The escrow authorities may do this without accessing the plaintext description of the conditions, e.g., by comparing an event, described as a potential plaintext, with the escrowed plaintext, still in escrow. One way to do this can be seen in the context of Elgamal encryption, wherein the escrow authorities may divide the plaintext-bearing ciphertext component of the ciphertext pair with the potential plaintext and then determine whether the resulting modified ElGamal ciphertext is an encryption of 1. This can be done by blinding both components using the same shared blinding value, which is a random value, and then decrypting the resulting ElGamal ciphertext and comparing the result to 1. If the result is 1, then the condition was met by the event, otherwise not.

In some contexts, at least some transactions may require that the buyer of a token registers his or her identity as part of the transaction. An entity does not have to be a human, or could correspond to multiple humans, and we use the words “his or her” to refer to any type of entity. An entity's identity may be represented using a token that is anchored to the entity, such as a token that references biometrics of one or more associated users would be anchored. Anchored tokens have also been referred to as “soul-bound tokens”. In some instances, it is desirable to escrow any token or other information that references or contains personally identifiable information (PII), or which contain an anchor. By escrowing this information, and proving that the escrowing was performed in a proper manner, it is possible to verify (e.g., by a third party, such as one or more entities that are part of the consensus mechanism, or by a bridge, or by a security auditor) that one or more ciphertexts—corresponding to the escrow data—comprise identifying information, such as an anchor. If there is a need to determine the identity of the buyer, the escrow authority, which may be distributed and operate as is described in this disclosure, may perform an operation to access the identifying information. The escrow authority can also determine whether a given escrow data corresponds to a particular identifier or not. This type of escrowing of identity information may also be performed in other contexts, such as in a situation where an entity requests to access content, rent a token, license a token, or otherwise gain some rights related to the token. This may require, e.g., by a jurisdictional rule associated with the jurisdiction of this entity, or as a result of a policy associated with the token, that the entity with access interests registers its identity, which may be performed using an escrowing of information related to its identity.

In one embodiment, metadata is escrowed, e.g., as disclosed in co-pending application titled “Provisional: Improved Blockchain based on Content Tagging” by Markus Jakobsson, Kenneth Rosen, Stephen C. Gerber and Guy Stewart. At least some metadata, or more generally tags and/or profile data as disclosed in the above-mentioned application, may contain sensitive data that it is desirable not to expose to the public unless a triggering action takes place. Such a triggering action may correspond to the conditions associated with one or more policies governing the actions of an escrow authority with respect to a token and an associated escrowed data element, such data element comprising tag data and/or profile data.

In one embodiment, an escrow method is used to indicate that two wallets belong to the same entity. This is done by a first party creating a proof, verifiable by a third party, that a second party is able to decrypt a ciphertext, and that this ciphertext comprises a private key associated with the first party. This can be performed in a bi-directional manner, for one or more private keys of each party, to prove to the third party that the two wallets, or other entities, are controlled by parties that are either the same or which are equivalent in terms of control. In one example implementation of this, PrKA is a private key associated with a public key PuKA that is associated with an ownership of some assets of party A. PrKA is encoded as an array of private key components, which we refer to as PrKA1 . . . PrKAn, each one of which is encrypted using the public key PuKB of party B. The ith ciphertext of this type is Ci. Party B can, upon receiving the set C1 . . . Cn, decrypt these ciphertexts and determine the representations of PrKA1 . . . PrKAn and generate PrKA. A third party does not have the capability of decrypting the ciphertexts C1 . . . Cn, but wishes to determine that B has this capability. Pi is a proof that Ci is an encryption of an unknown but legitimate value PrKAi for each of 1<=i<=n. Here, a value is said to be legitimate if it is a representation of a portion of PrKA, e.g., one particular bit of PrKA such as the ith bit. Methods for creating such proofs are disclosed herein. Thus, this is an application of an escrow method where party A places some valuable information in an escrow that is accessible by party B, and proves that this is done correctly, in order to prove having a close relationship with party B, and where this proof can be verified by a third party. This is useful, for example, in the context of a situation where sales tax and/or royalties are charged as tokens are transferred from one party to another, but not where one and the same party transfers such an asset between two wallets he or she controls. For example, if the asset is worth $10 and the private key that is escrowed controls a much greater value, such as $1000, then it may be assumed that party A and party B are the same party, or members of the same family, or party A would not be comfortable disclosing the private key to party B. The private keys that are proven the capability of may be transferred bi-directionally. They may also be transferred in just one direction, such as from a hot wallet to a cold wallet, to protect assets against malware. The encrypted private keys that are received may be immediately erased, as the purpose is to prove the transfer to a third party, as opposed to providing actual access to the recipient. The private keys may relate to assets (such as fungible or non-fungible tokens) or to access control (related to capabilities of the sending wallet, for example). Analogous techniques can be used to prove that a first entity and a second entity are controlled by the same party or by two parties that can be considered as one, e.g., for tax or royalty payment purposes. The first entity may be a wallet, a token such as a crypto fund token or a non-fungible token, or an organization or other entity that can be addressed using a public key. The second entity may be a wallet, a token such as a crypto fund token or a non-fungible token, or an organization or other entity that can be addressed using a public key, but the two entities do not have to be of the same type, e.g., the first entity may be a non-fungible token (NFT) and the second entity may be a wallet. When applied to such a scenario, the technique provides evidence and support for the first and the second entity having common control, common trust, or a combination thereof. The technique can also be applied to more than two entities simply by replicating the steps of the technique to link multiple entities in a graph that connects them all. Another use of this type of proof technology is to associate a first token with a second token, where the first token may be an NFT corresponding to a university diploma, for example, and the second token corresponds to a biometric token that is physically tied to a particular user. This can be done in a bi-directional manner to make it not possible to transfer either the first token or the second token to a third party without automatically transferring both the first and second token to the third party. Therefore, the use of escrow in this context ties assets together in a manner that prevents the assets from being individually resold or otherwise transferred.

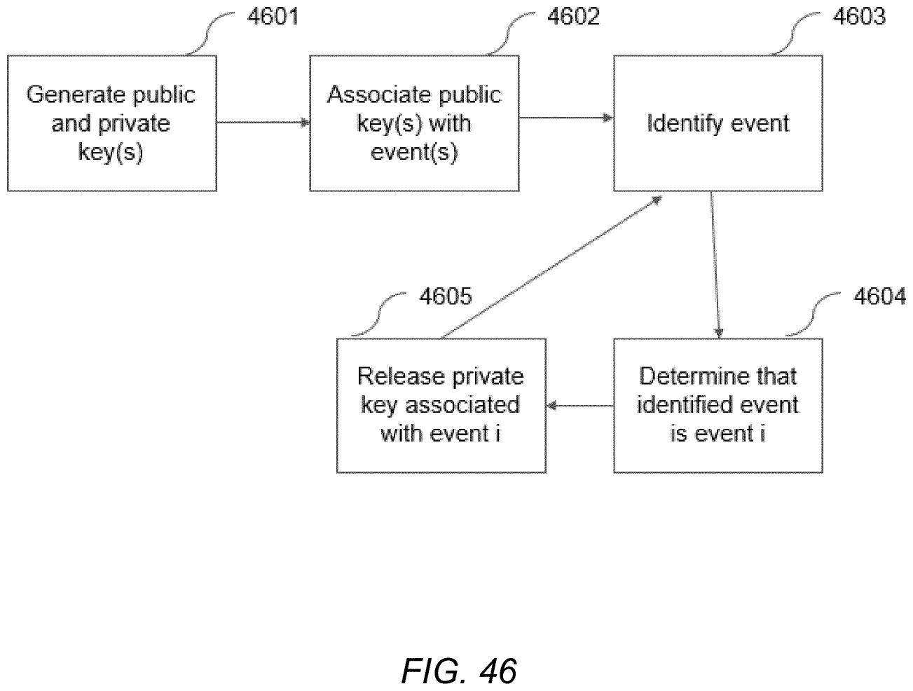

FIG. 46 illustrates an event-driven release of private keys. In step 4601, one or more keypairs are generated, a keypair comprising a public key and a private key. In step 4602, one or more public keys are associated with one or more events, e.g., by publishing a certified copy of the public keys along with a description of their use, where the description may comprise a policy, a reference to a time, a reference to an entity performing a release of associated private keys, etc. In step 4603, the existence of an event is identified, and in response to that, the system transitions to the state associated with step 4604, where the event is identified, e.g., that the event corresponds to event number i, as shown in step 4604. In response to determining that the event is event number i, the system transitions to the state associated with step 4605, where the private key associated with the public key associated with event number i is released. For example, a release may be the broadcast of the private key. In addition, a reference to the associated public key may be broadcast. An example event i may be the arrival of a given time. Another example event i may be the first time the stock market reaches a specified state, e.g., one with the Dow having reached a given value. Any event that can be determined can be associated with a public key. Events may be incorporated using oracles. Events may also be specific to a specified blockchain and its contents.

FIG. 47 is a block diagram illustrating components and processes for enabling a function within a smart contract after a predetermined time on presentation of a signed voucher.

FIG. 48 is a block diagram illustrating components and processes for enabling a function within a smart contract after a predetermined time on presentation of a preimage to a previously released hash output.

The disclosed technology comprises a system for release of data, comprising:
generating a first keypair and a second keypair, the first keypair comprising a first public key and a first private key, the second keypair comprising a second public key and a second private key;
publish the first public key and the second public key;
associating the first keypair with a first event and the second keypair with a second event; wherein the first public key is used to encrypt a first data, resulting in a first ciphertext, and wherein the second public key is used to encrypt a second data, resulting in a second ciphertext;
in response to determining that the first event has taken place, publish the first private key, enabling the computation of the first data from the first ciphertext and the first private key;
in response to determining that the second event has taken place, publish the second private key, enabling the computation of the second data from the second ciphertext and the second private key.

While the above description contains many specific embodiments of the invention, these should not be construed as limitations on the scope of the invention, but rather as an example of one embodiment thereof. Accordingly, the scope of the invention should be determined not by the embodiments illustrated, but by the appended claims and their equivalents.

What is claimed is:

1. A process for handling transaction permissions in a partitioned wallet, the process comprising:
receiving a transaction, the transaction comprising a sending address and a receiving address, wherein the sending address is associated with a partitioned wallet, the partitioned wallet comprising:
a first wallet partition comprising a first address, the first address derived based on a master key and a first index variable; and
a second wallet partition comprising a second address, the second address derived based on the master key and a second index variable;
conditionally restricting the transaction based on the sending address and the receiving address;
obtaining a ledger entry comprising the transaction when the transaction is approved; and
broadcasting a ledger entry comprising the transaction when the transaction is approved, wherein the ledger entry is configured to be securely added to a distributed ledger.

2. The process of claim 1, wherein restricting the transaction comprises blocking the transaction when the sending address is the second address.

3. The process of claim 1, wherein restricting the transaction comprises blocking the transaction when the sending address is the second address and the receiving address is external to the partitioned wallet.

4. The process of claim 1, wherein restricting the transaction comprises requiring authentication by the first address when the sending address is the second address and the receiving address is external to the partitioned wallet.

5. The process of claim 1, wherein restricting the transaction comprises delaying the transaction by a predetermined amount of time.

6. The process of claim 1, wherein restricting the transaction comprises blocking the transaction when the sending address has been previously used in a predetermined number of transactions.

7. The process of claim 1, wherein restricting the transaction comprises blocking the transaction when the sending address has been previously used in a predetermined number of transactions during a predefined time period.

8. The process of claim 1, further comprising restricting the transaction when the sending address corresponds to a third wallet partition, such that the transaction is approved when the receiving address corresponds to at least one of the first wallet partition and the second wallet partition, and wherein for each address corresponding to the third wallet partition, the corresponding address is derived based on the master key and on an index variable corresponding to the third wallet partition.

9. A user interface for handling transactions including digital assets in a partitioned wallet, the user interface comprising:
displaying a first wallet partition comprising a first address and displaying a second wallet partition comprising a second address;
displaying a first set of transaction options when a user selects the first address for inclusion in a transaction as a sending address; and
displaying a second set of transaction options when the user selects the second address for inclusion in the transaction as the sending address,
wherein the first address can be identified as belonging to the first wallet partition based on a first index variable, the first index variable and a master key used in deriving the first address and the first index variable corresponding to the first wallet partition, and
wherein the second address can be identified as belonging to the second wallet partition based on a second index variable, the second index variable and a master key used in deriving the second address and the second index variable corresponding to the second wallet partition.

10. The user interface of claim 9, wherein the user interface further comprises displaying a third set of transaction options when the user selects a third address for inclusion in the transaction as a sending address.

11. The user interface of claim 9, wherein the user interface further comprises displaying a third wallet partition comprising a third address.

12. The user interface of claim 9, wherein the first set of transaction options allow a recipient address to be an external address.

13. The user interface of claim 9, wherein the second set of transaction options limit a recipient address to being an external address selected from a predefined list of external addresses.

14. The user interface of claim 9, wherein the second set of transaction options limit a recipient address to being an address corresponding to the first wallet partition.

15. The user interface of claim 9, wherein the first set of transaction options are identified for display based on determining that the first address was derived based on the master key and the first index variable.

16. The user interface of claim 9, wherein the first set of transaction options allows external and internal recipient wallets addresses.

17. The user interface of claim 9, wherein the second set of transaction options can render the second address unavailable when the second address has previously been used as a sending address.

18. A process for handling transaction permissions in a partitioned wallet, the process comprising:
receiving a transaction, the transaction comprising a sending address and a receiving address, wherein the sending address corresponds to a first wallet partition of a wallet, and wherein the receiving address does not correspond with the wallet;
receiving an indication of transaction approval from a user, the user associated with a second address corresponding to a second wallet partition of the wallet;
approving the transaction based on the indication of transaction approval;
obtaining a ledger entry comprising the transaction when the transaction is approved;
broadcasting a ledger entry comprising the transaction when the transaction is approved, wherein the ledger entry is configured to be securely added to a distributed ledger, and
wherein the sending address is derived based on a master key and a first index variable, the first index variable corresponding to the first wallet partition and the second address is derived based on the master key and a second index variable, the second index variable corresponding to the second wallet partition.

19. The process of claim 18, wherein the user enters a private key corresponding to the second address.

20. The process of claim 18, wherein the receiving address is included on a predefined list.
